(19) United States
(12) Patent Application Publication
(10) Pub. No.: US 2005/0055221 A1
(43) Pub. Date: Mar. 10, 2005

(54) Branding-energy amplifier

(76) Inventor: Jon Henderson, Minneapolis, MN (US)

Correspondence Address: Jon Henderson;c/o Selma Chambers, 4606 Blaisdell Av. S., Minneapolis, MN, 55409, US

(21) Appl. No.: 10/637,229

(22) Filed: Aug. 7, 2003

(51) Int. Cl. G06F 17/60

(52) U.S. Cl. 705/1

(57) ABSTRACT

A branding-energy amplifier for amplifying the branding-energy of the Volkswagen beetle. Branding-Energy Amplifier established upon the principle of Node Plurality.

### PART ZERO: CONTENTS

### SECTION ONE BUSINESS

1. Application Data Sheet

2. Prior Art

3. Field of Invention

4. Notice to the Examiner—The Volkswagen Corporation

5. Notice to the Examiner—Duplicate Set of claims

6. Notice to the Examiner—Copyright

7. Notice to the Examiner—Scope of claims

### SECTION TWO: TOPICS

Topic 0: This is not a Design Patent

Topic 1: The Beetle as Icon

Topic 2: The Limousine as Standard Bearer of Brand

Topic 3: The Limousine as Money Machine

Topic 4: Flat-Roof Syndrome

Topic 5: Attracting Attention Attractively

Topic 6: DNA & Natural Law

Topic 7: Proposal & Discovery of New Automotive Species

Topic 8: Genesis: Biological Cell Division

Topic 9: The Rolling Automotive Billboard & Times Square;

Plurality & Branding Energy;

The Role of The Attraction of Attention

Topic 10: Money Multiplication & Branding Energy:

The Role of Echoed Shape and Evoked Memory

Topic 11: The Sunroof & Solar Energy Multiplication

Topic 12: Acoustics

Topic 13: Spatial Volume Multiplication

Topic 14: Privacy & Tranquility Multiplication

Topic 15: Parameter Multiplication

Topic 16: Mathematical Determinability Of Overall Length

Topic 17: The Sports Utility Vehicle As Money Machine

Topic 18: The Brand as Anchor: Acceptable Deviation from a Branded Shape

Topic 19: General Shapes for Potential Use in Rooftop Nodes

Topic 20: The Pervasive Principle of Plurality

Topic 21: Plurality as Mood-Maker

Topic 22: Node Latin

Topic 23: Connecting the Dots

Topic 24: Saving Money

Topic 25: Beauty & Truth

Topic 26: The Node as Mobile Home

Topic 27: The Cooper Mini Limousine: Coopernicus Infinitus

Topic 28: The Node as Beach Chair

Topic 29: Rooftop Storage

Topic 30: BRANDING ENERGYAMPLIFICATION DOCTRINE

Topic 31: Branding Energy Element 1: Node Protuberance

Topic 32: Branding Energy Element 2: Node Independence

Topic 33: Branding Energy Element 3: Node Plurification

Topic 34: Branding Energy Element 4: Human Conveyance

Topic 35: Branding Energy Element 5: Human Accommodation

Topic 36: Branding Energy Element 6: Branding Energy Amplification

### SECTION THREE: DRAWING DESCRIPTIONS

### Drawing Figures printed on the same line are drawn on the same page

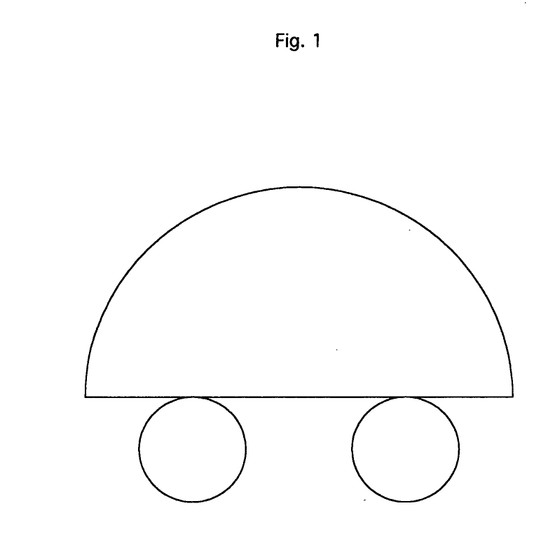

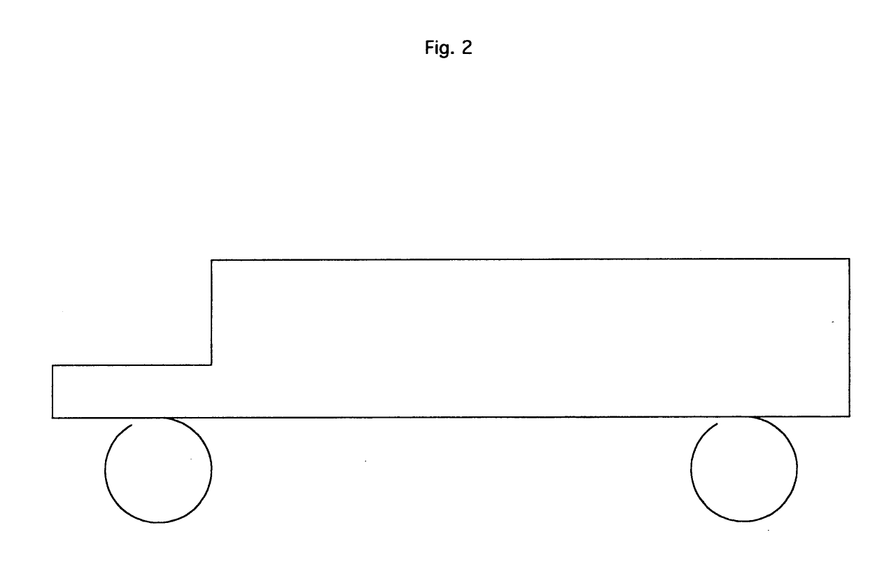

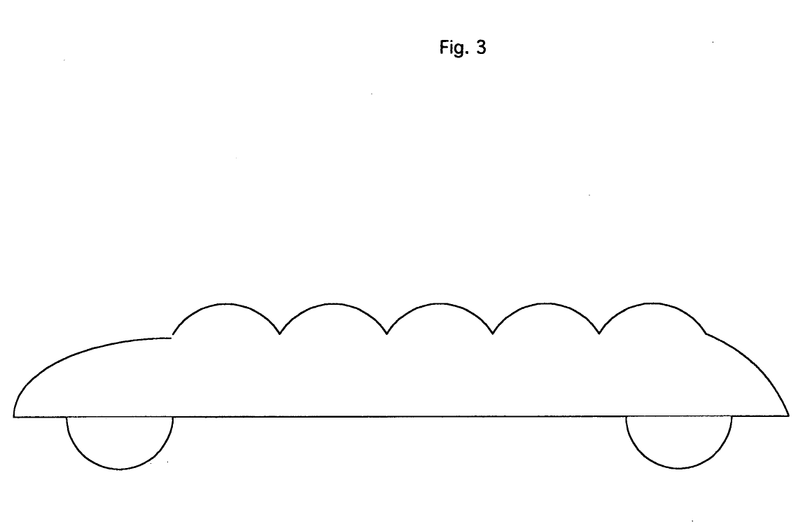

FIG. 1

FIG. 2

FIG. 3

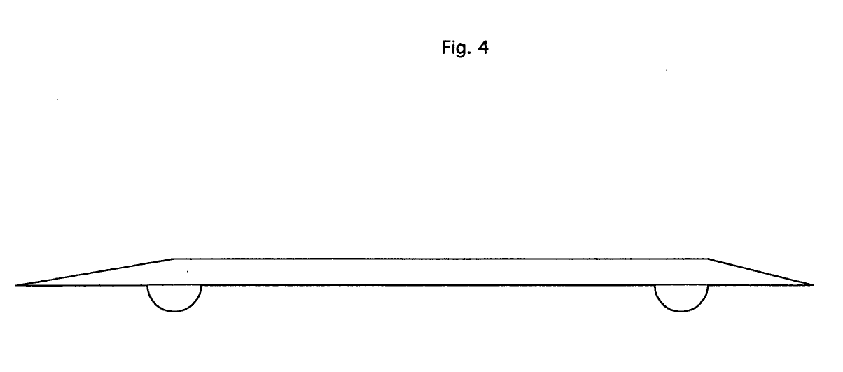

FIG. 4

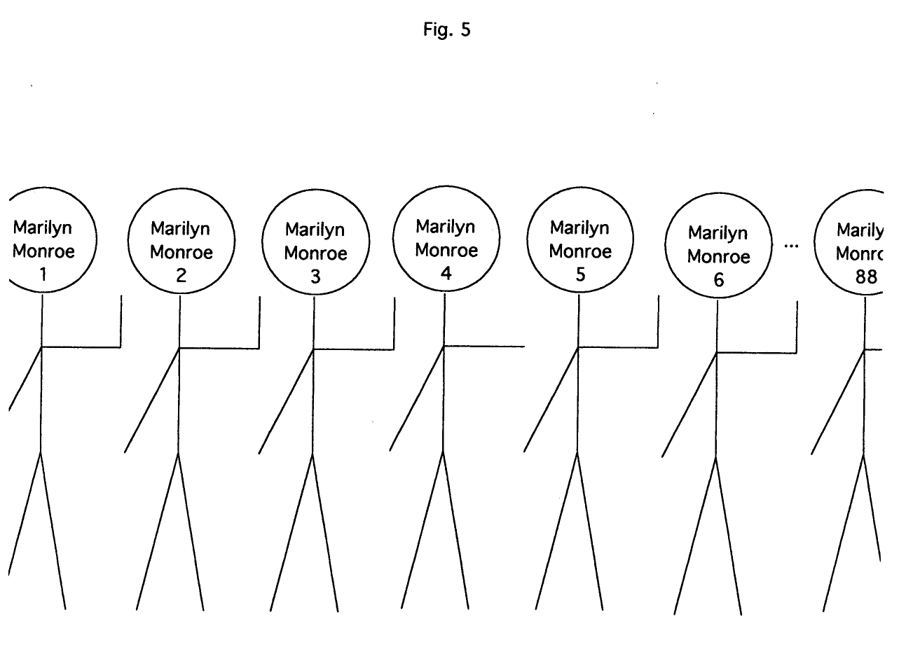

FIG. 5

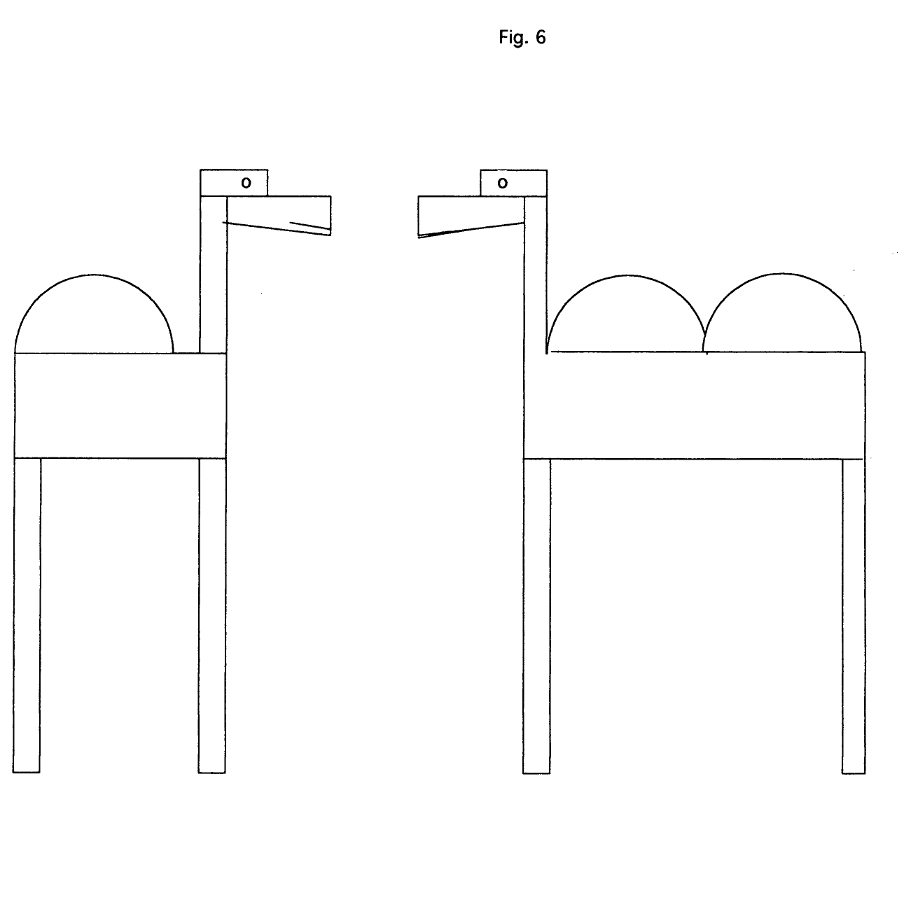

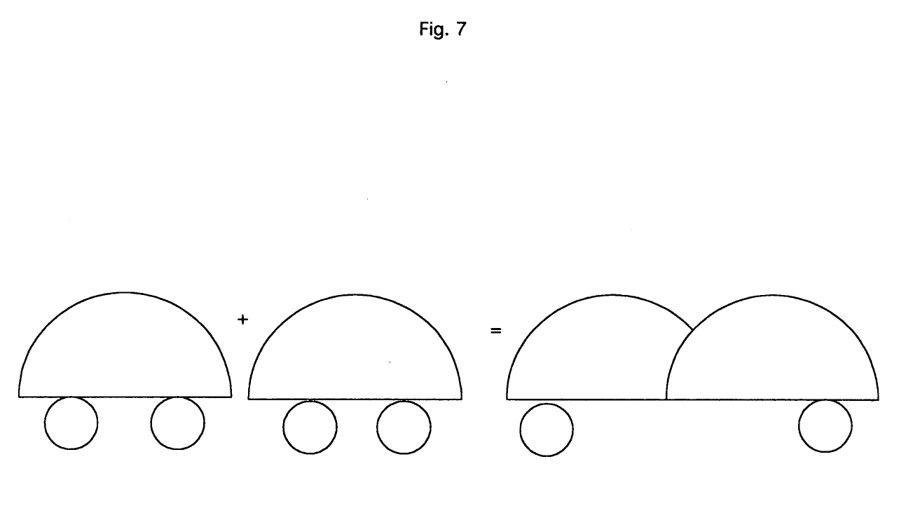

FIG. 6

FIG. 7

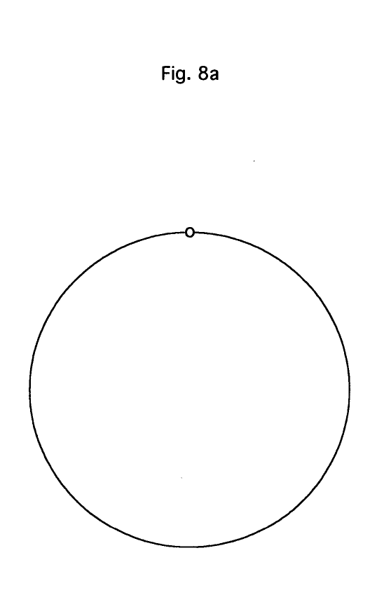

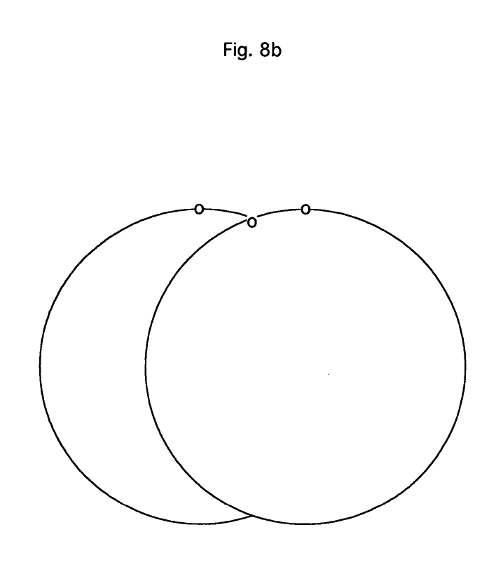

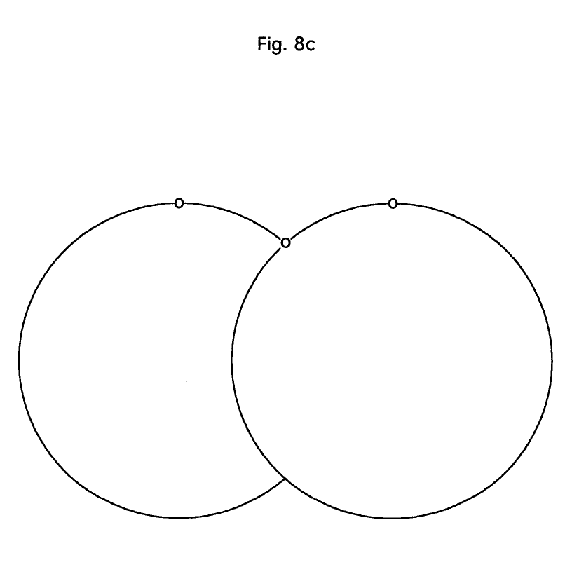

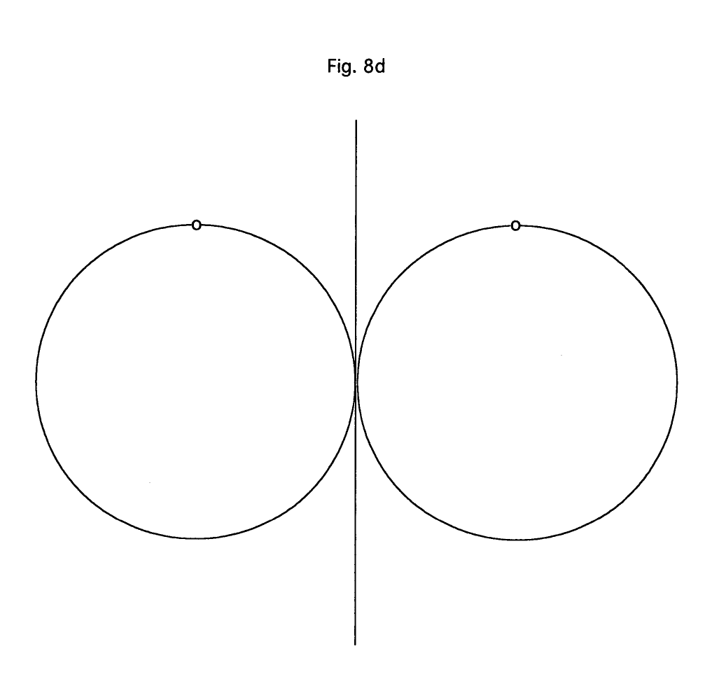

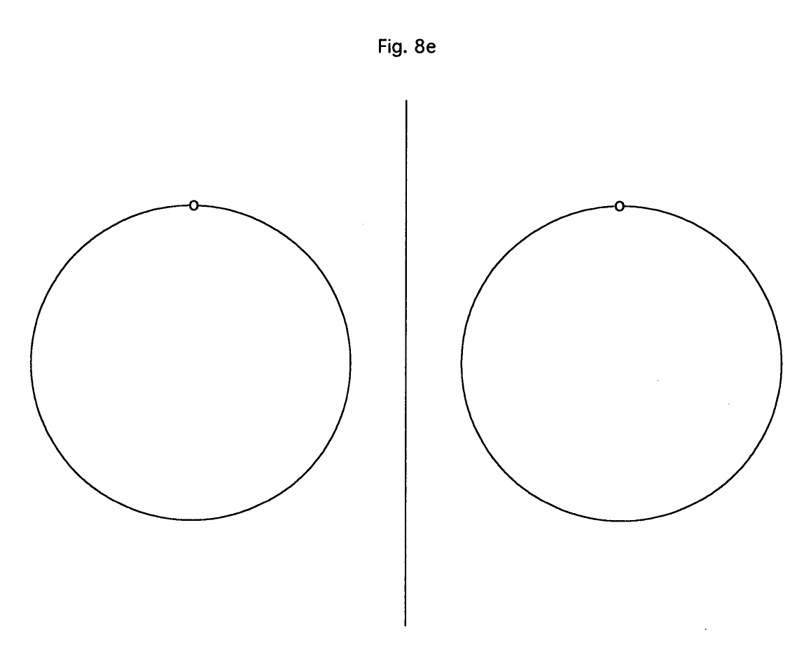

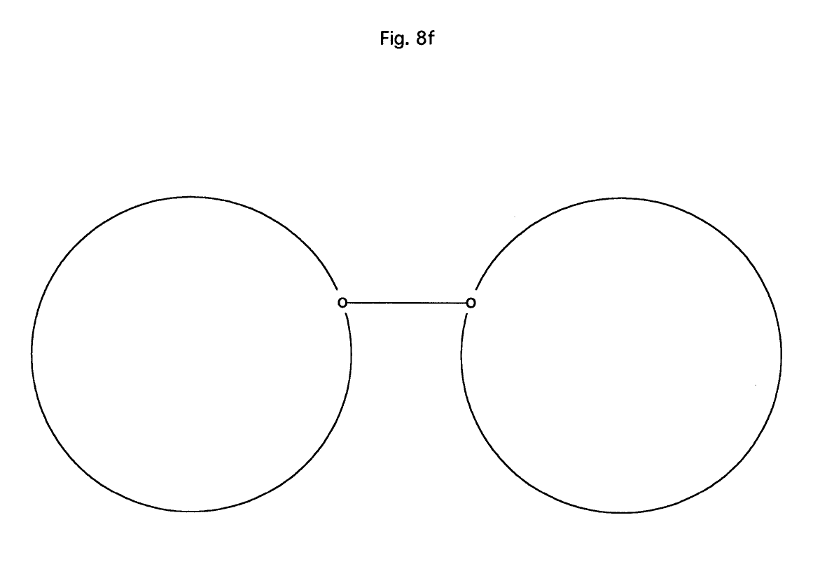

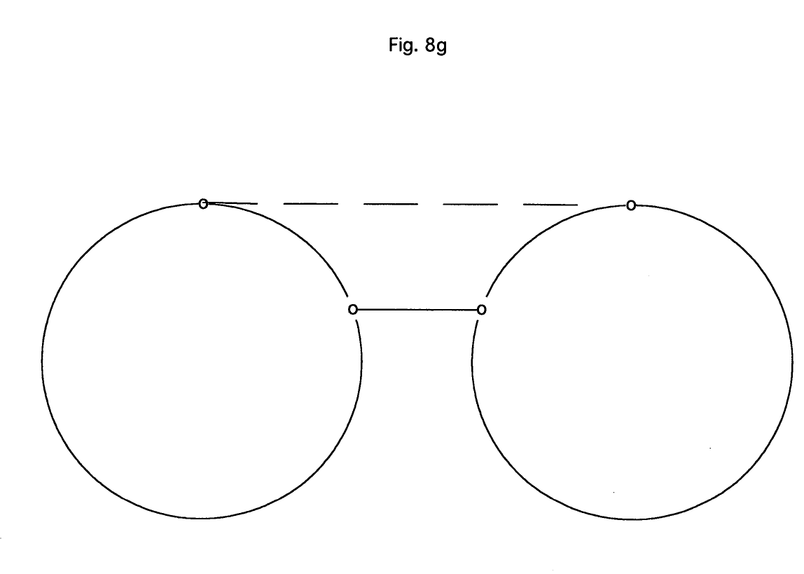

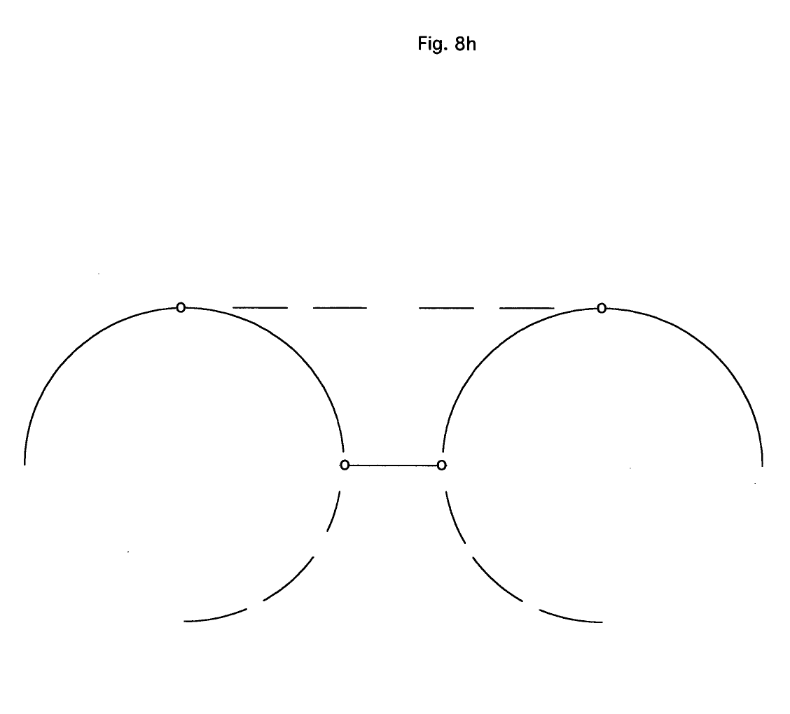

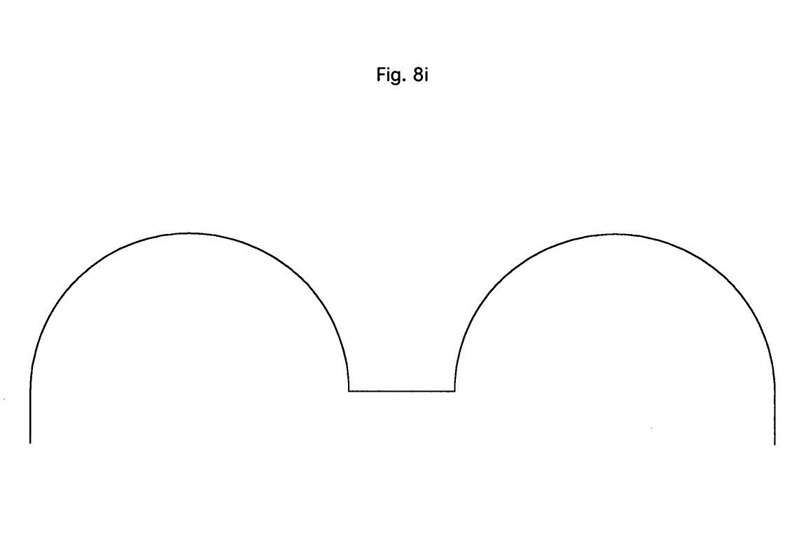

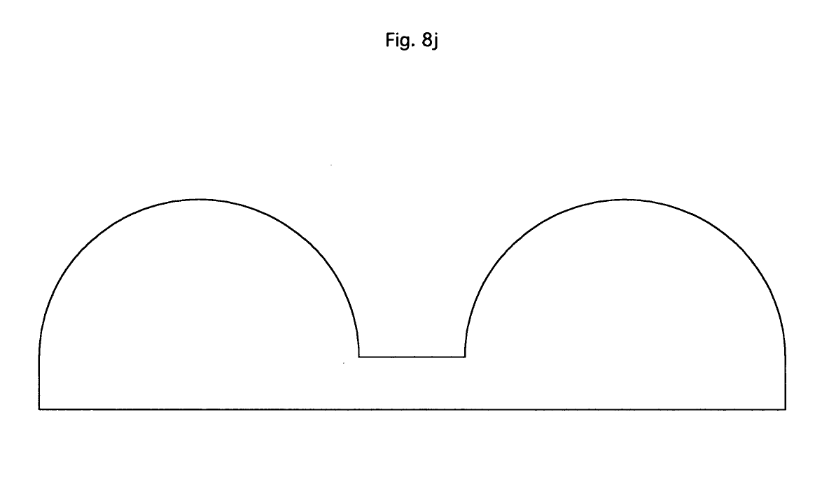

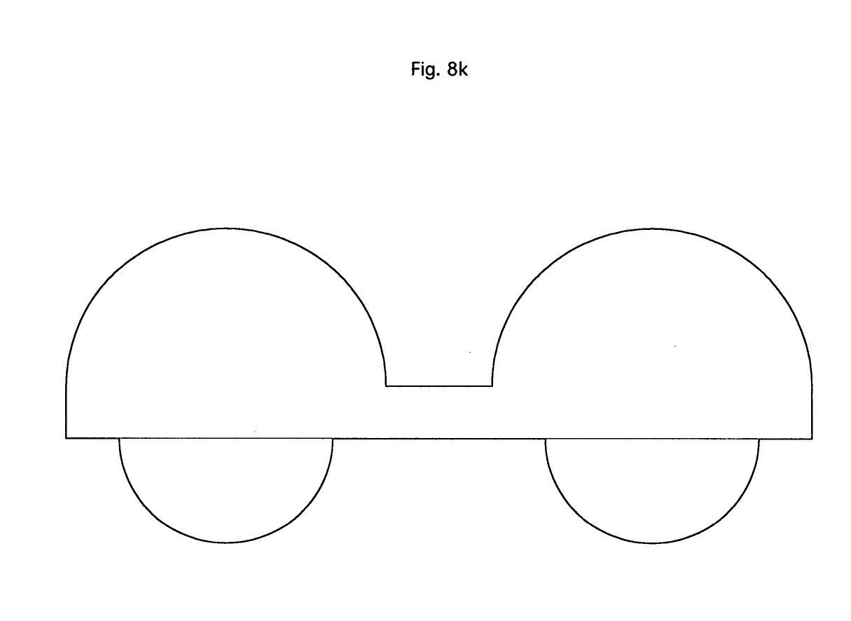

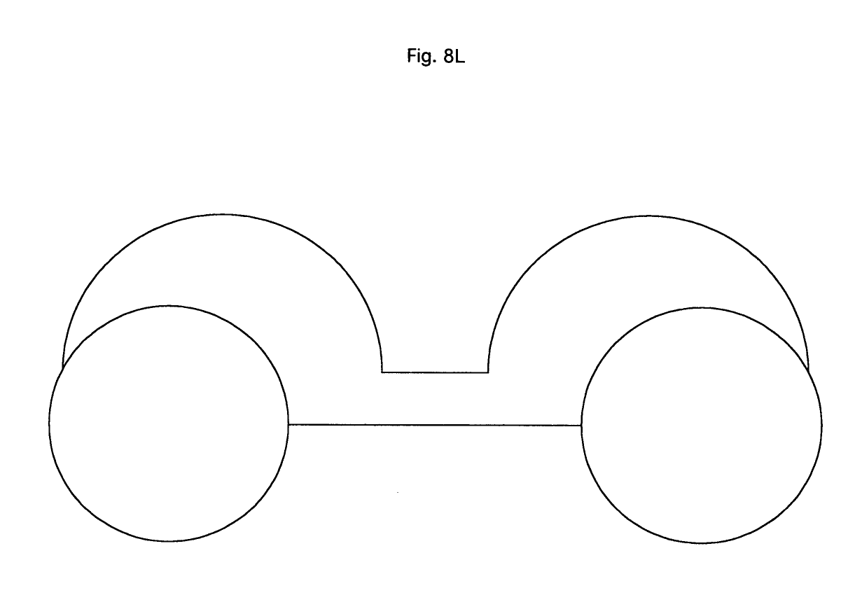

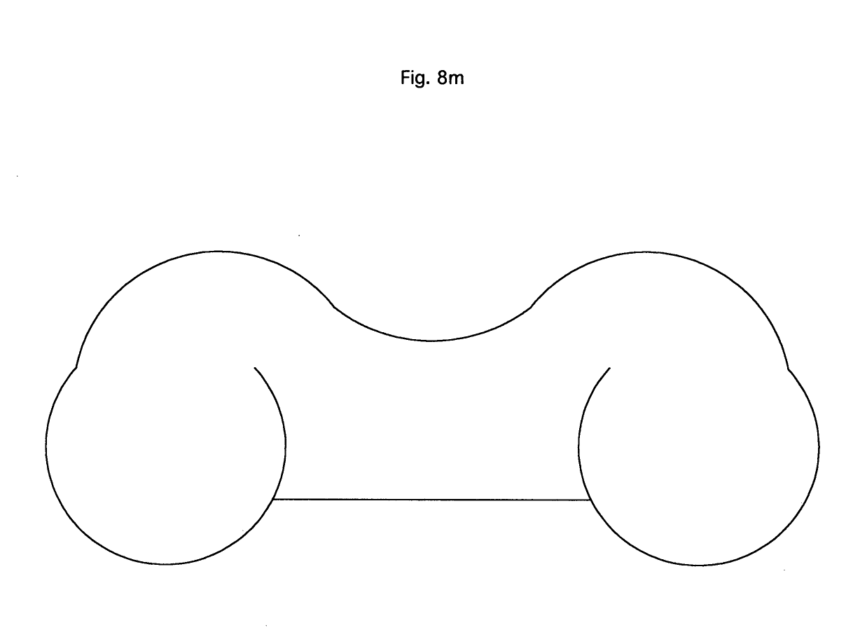

FIG. 8a

FIG. 8b

FIG. 8c

FIG. 8d

FIG. 8e

FIG. 8f

FIG. 8g

FIG. 8h

FIG. 8i

FIG. 8j

FIG. 8k

FIG. 8L

FIG. 8m

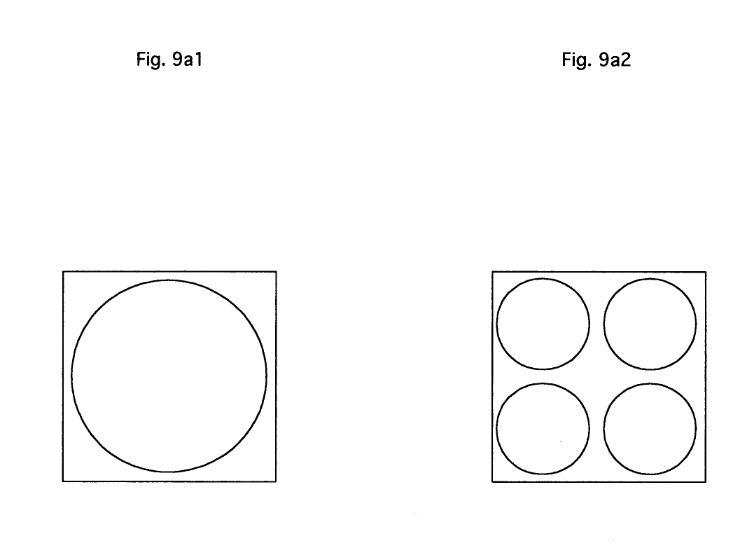

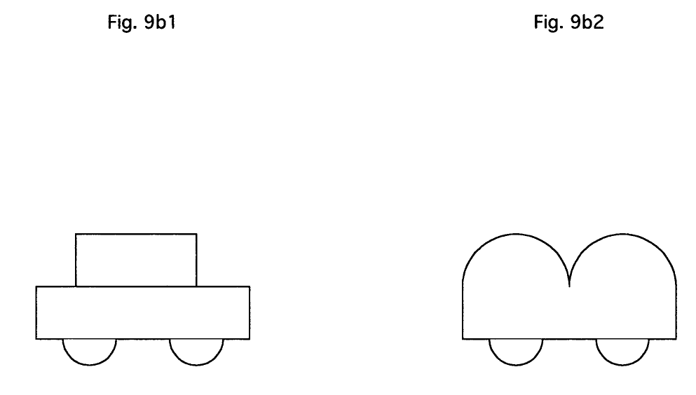

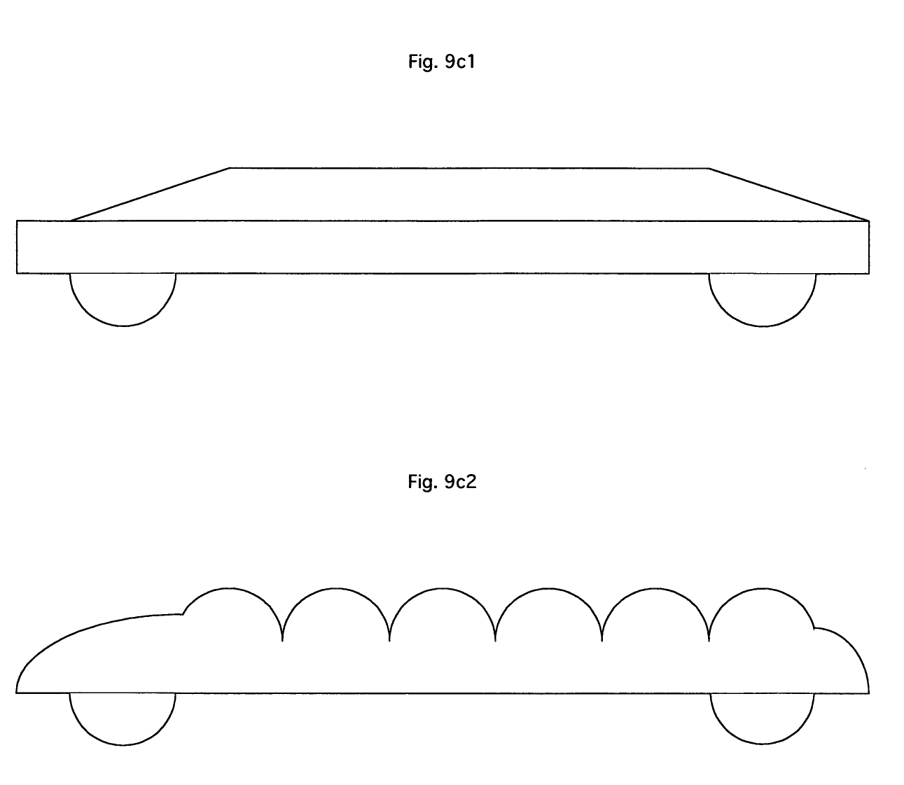

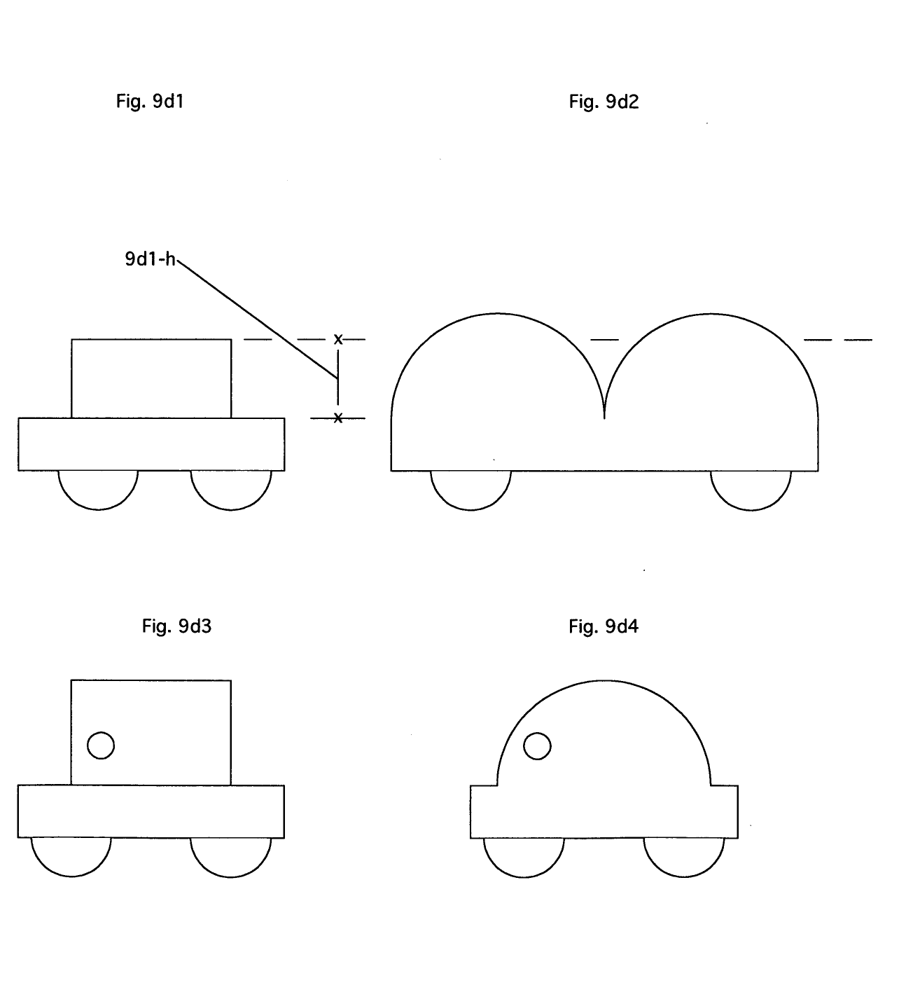

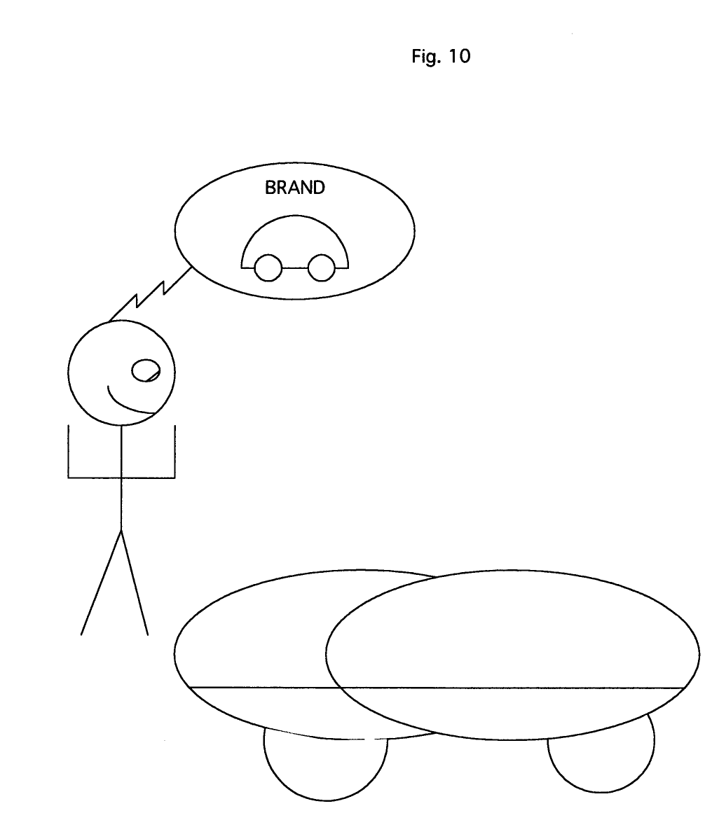

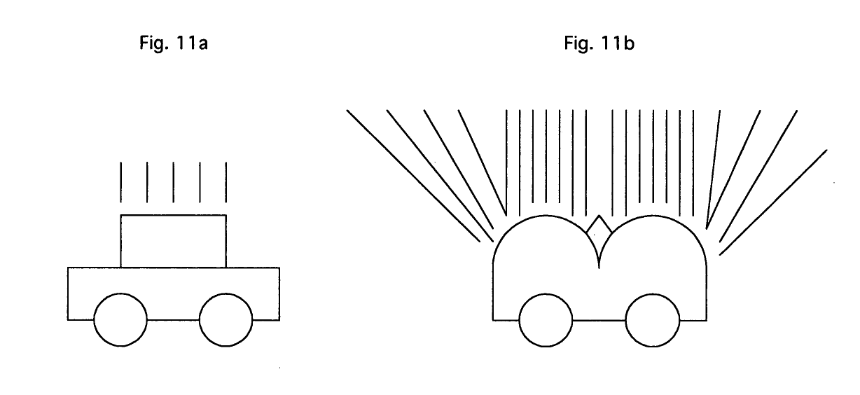

FIG. 9a1, 9a2

FIG. 9b1, 9b2

FIG. 9c1, 9c2

FIG. 9d1, 9d2, 9d3, 9d4

FIG. 10

FIG. 11a, 11b

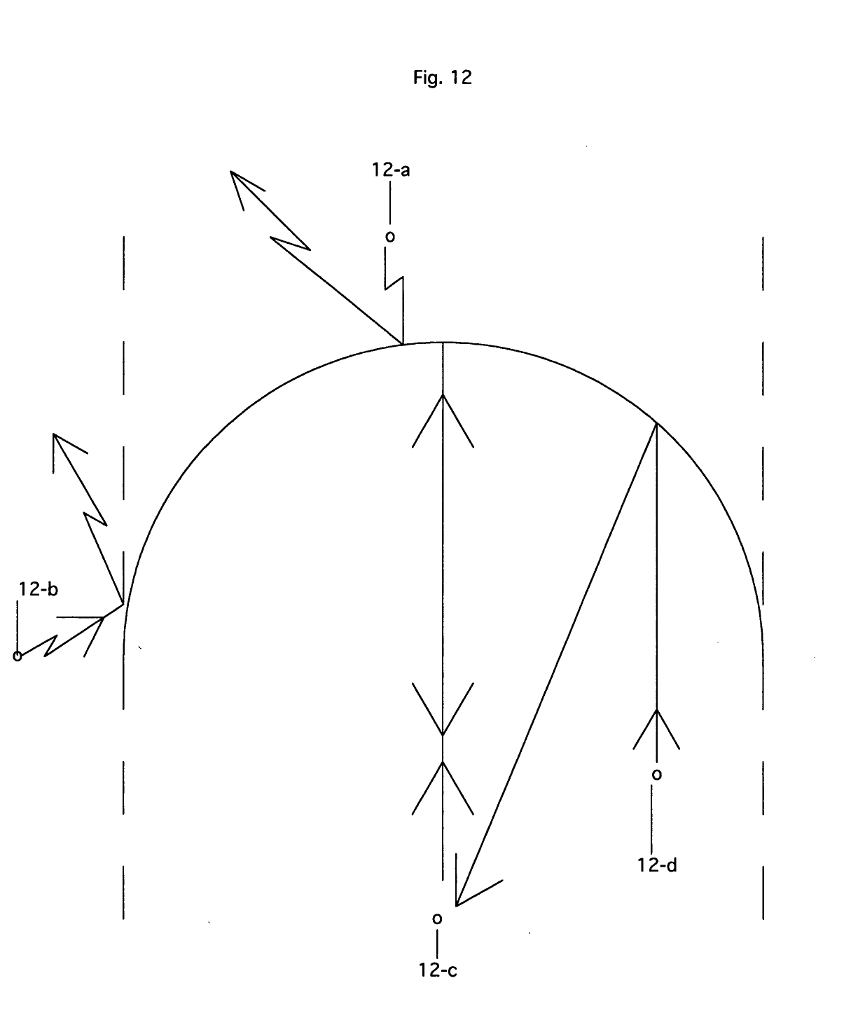

FIG. 12

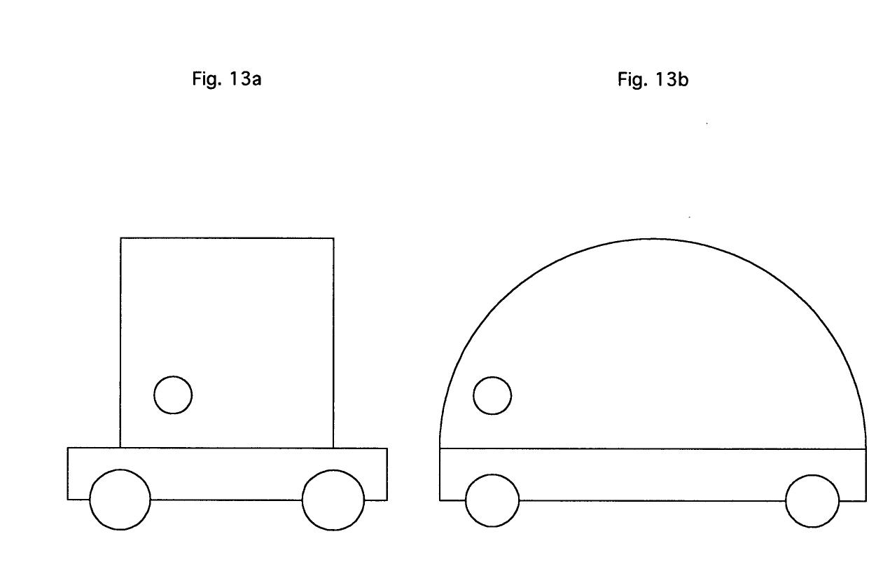

FIG. 13a, 13b

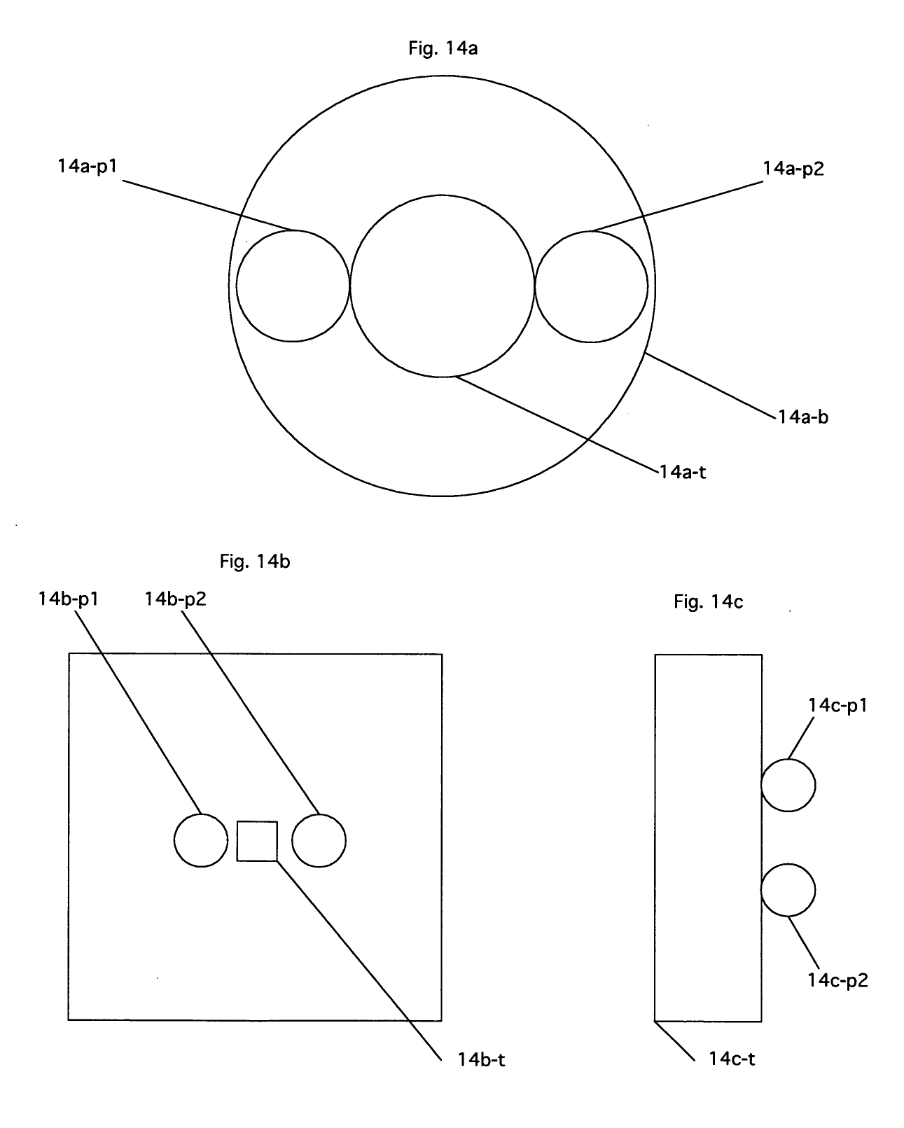

FIG. 14a, 14b, 14c

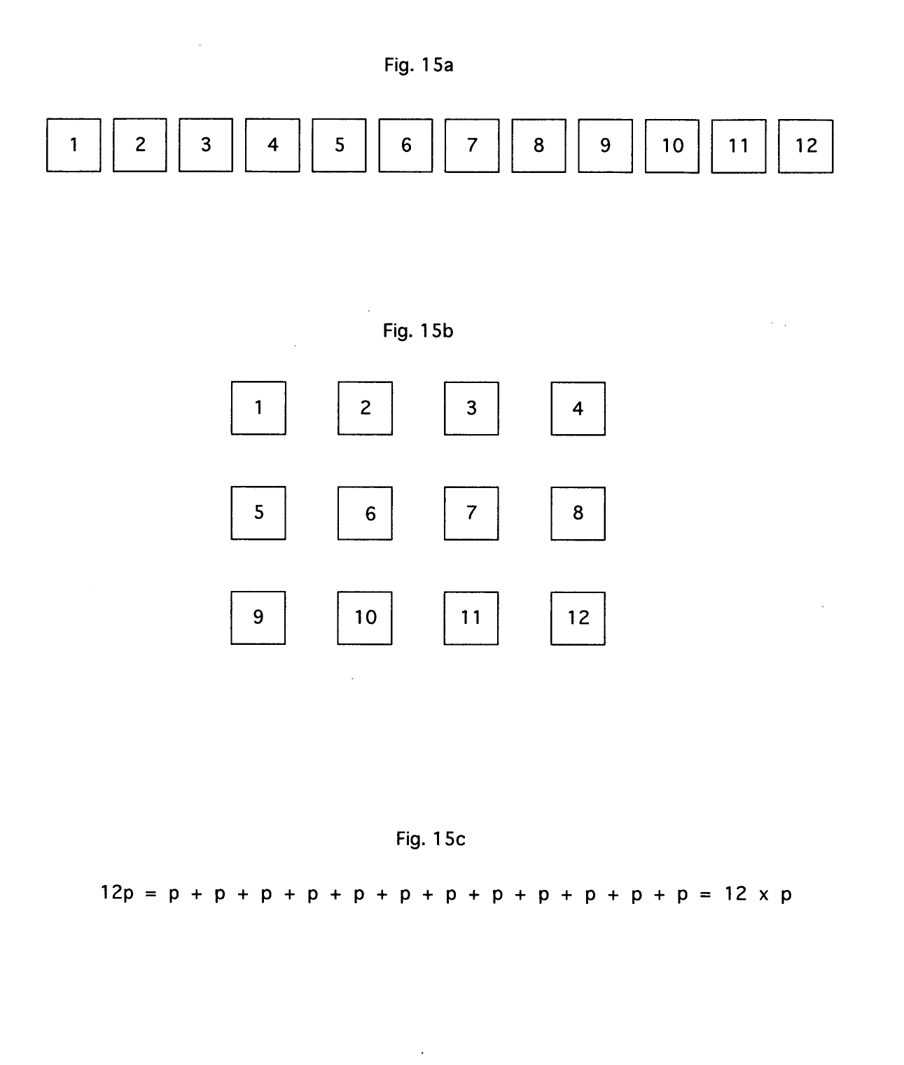

FIG. 15a, 15b, 15c

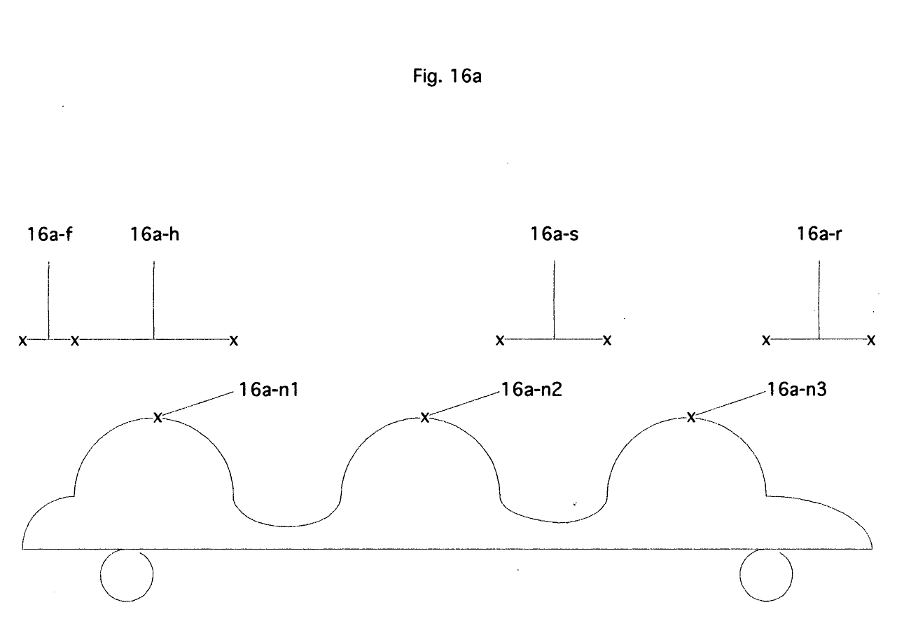

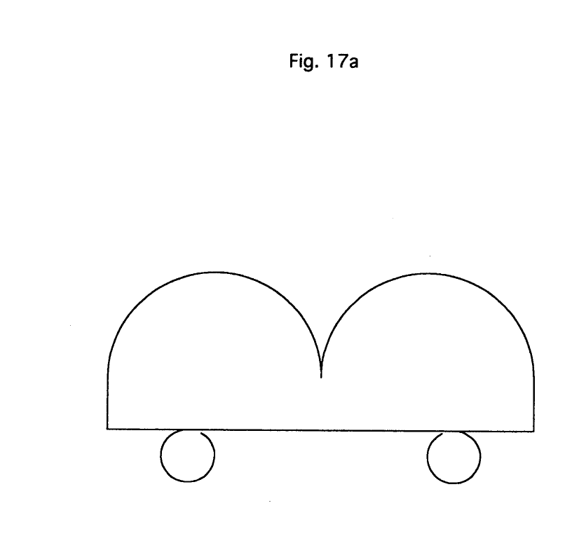

FIG. 16a

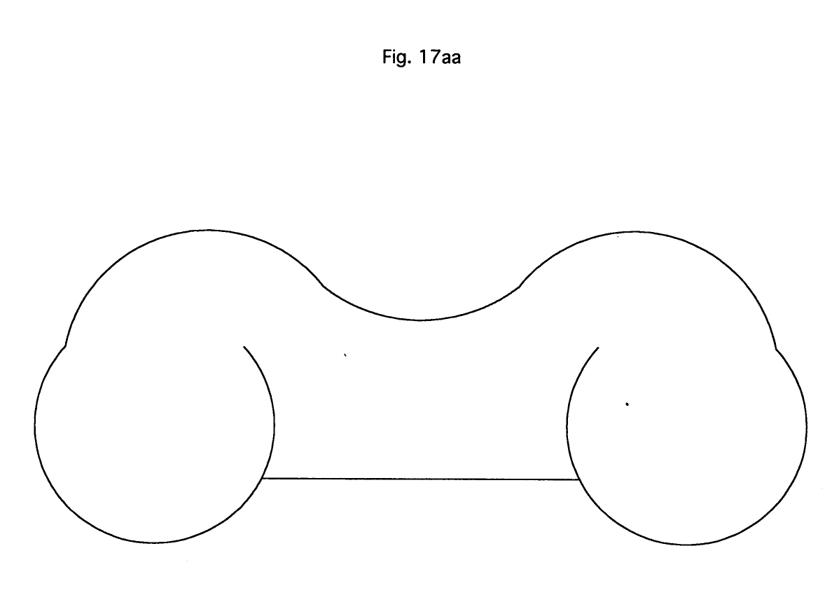

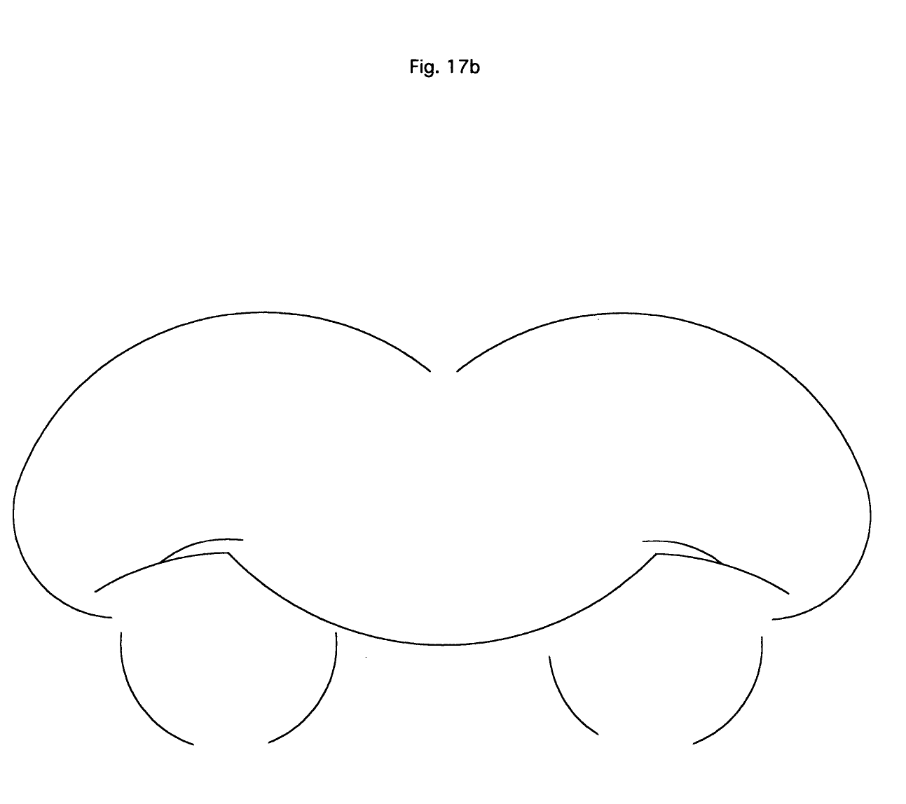

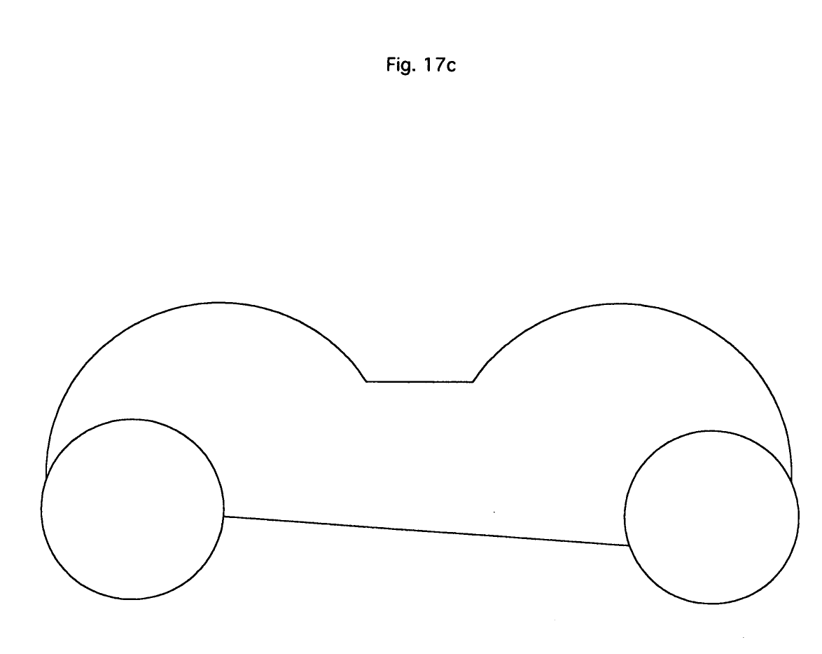

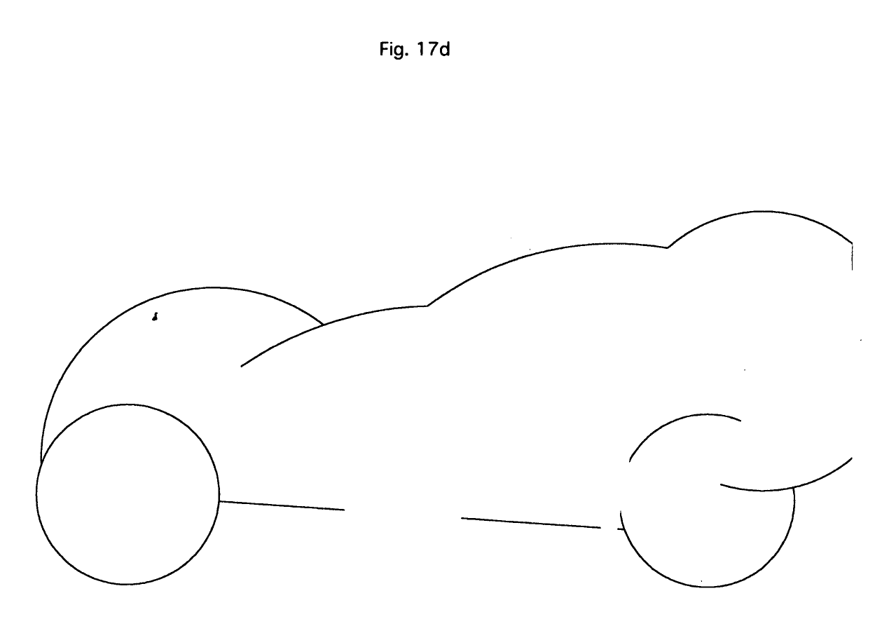

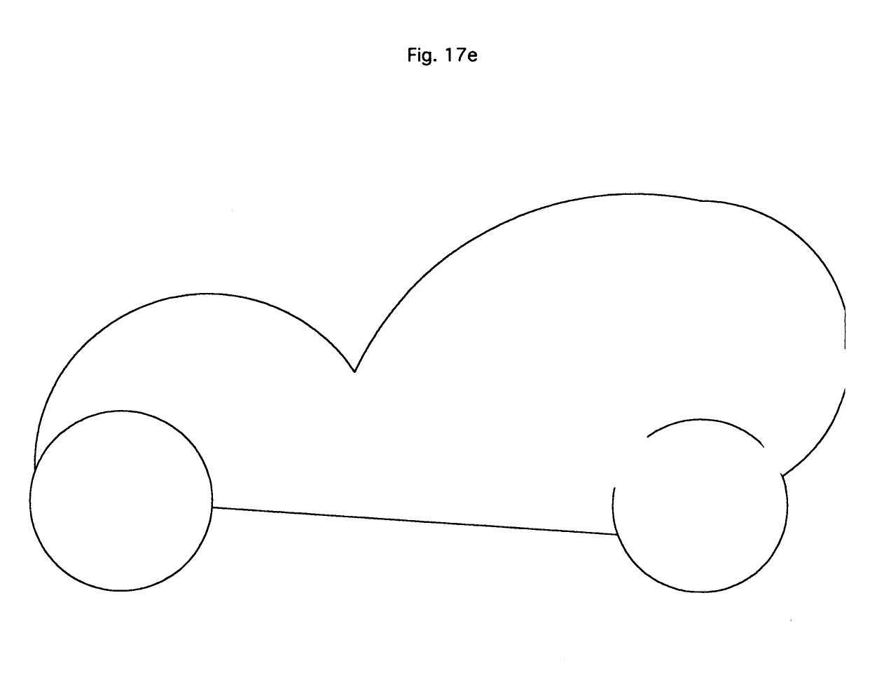

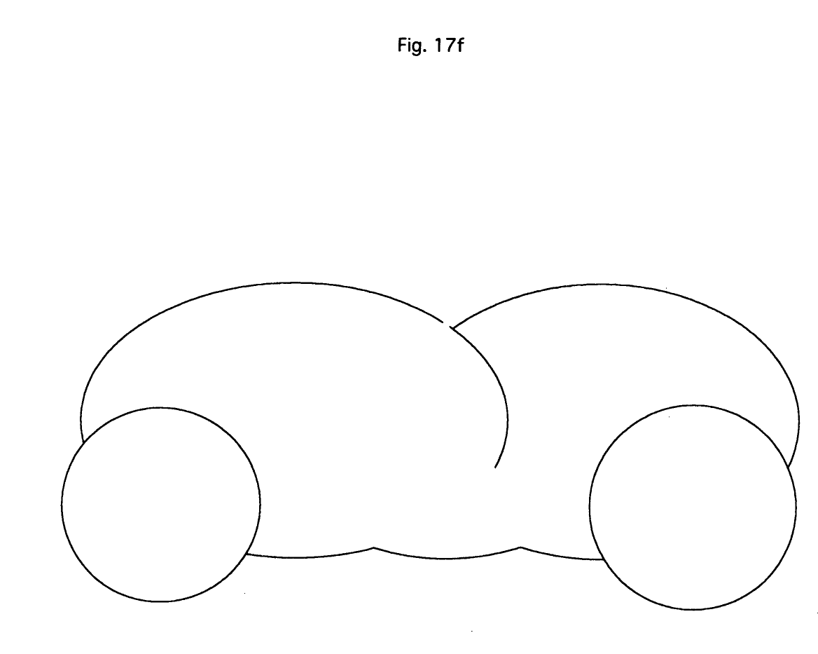

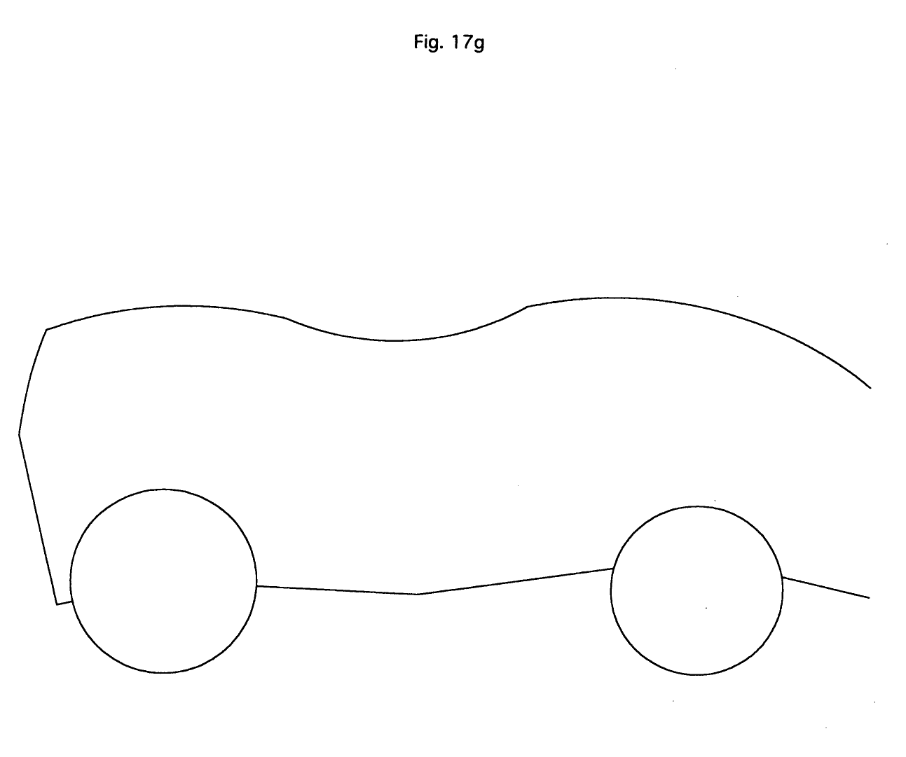

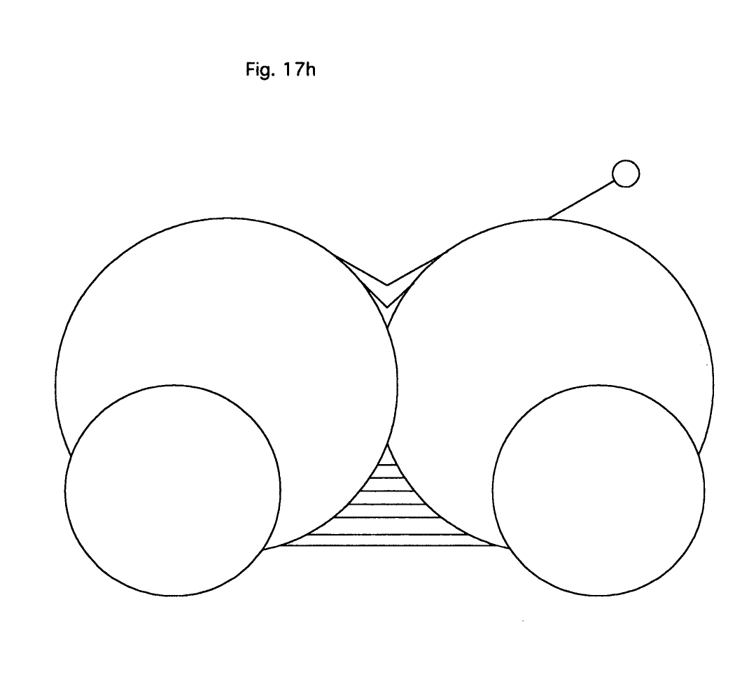

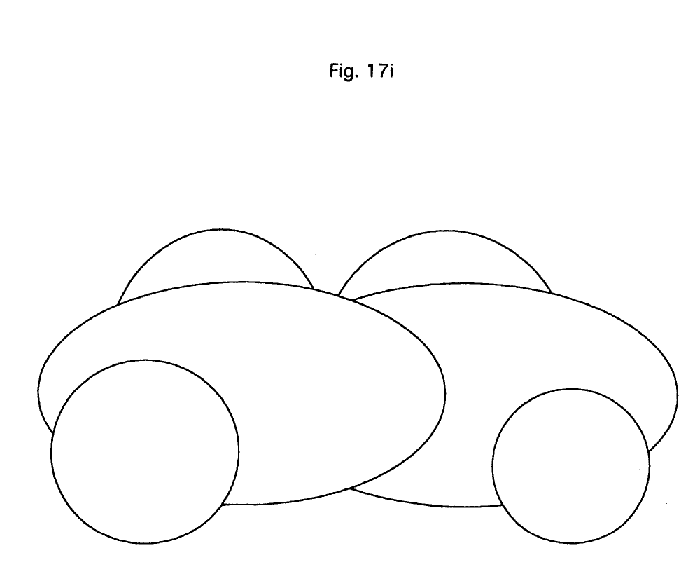

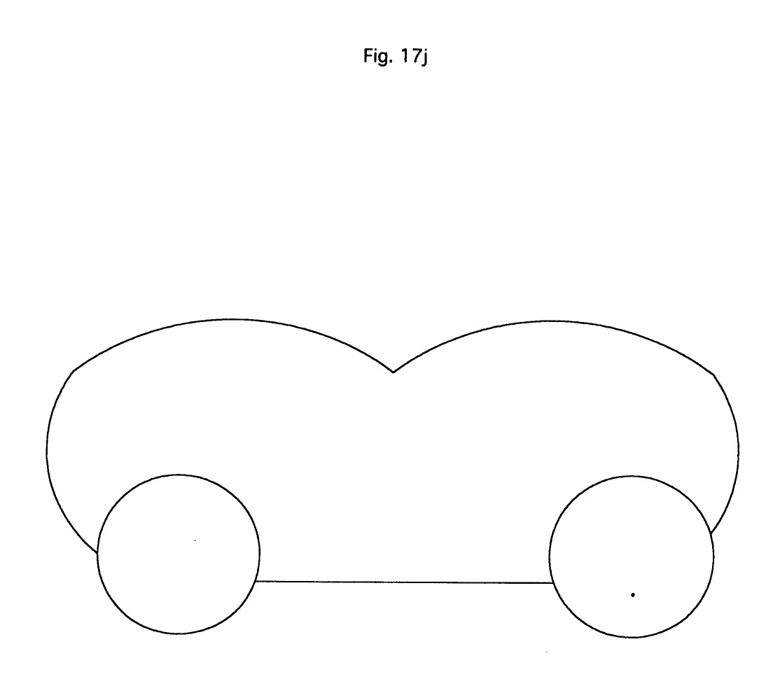

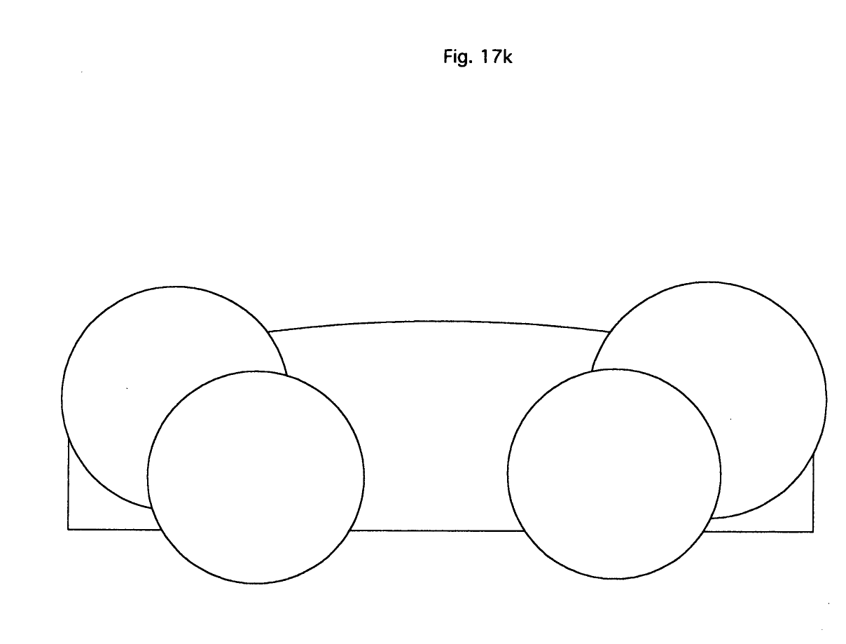

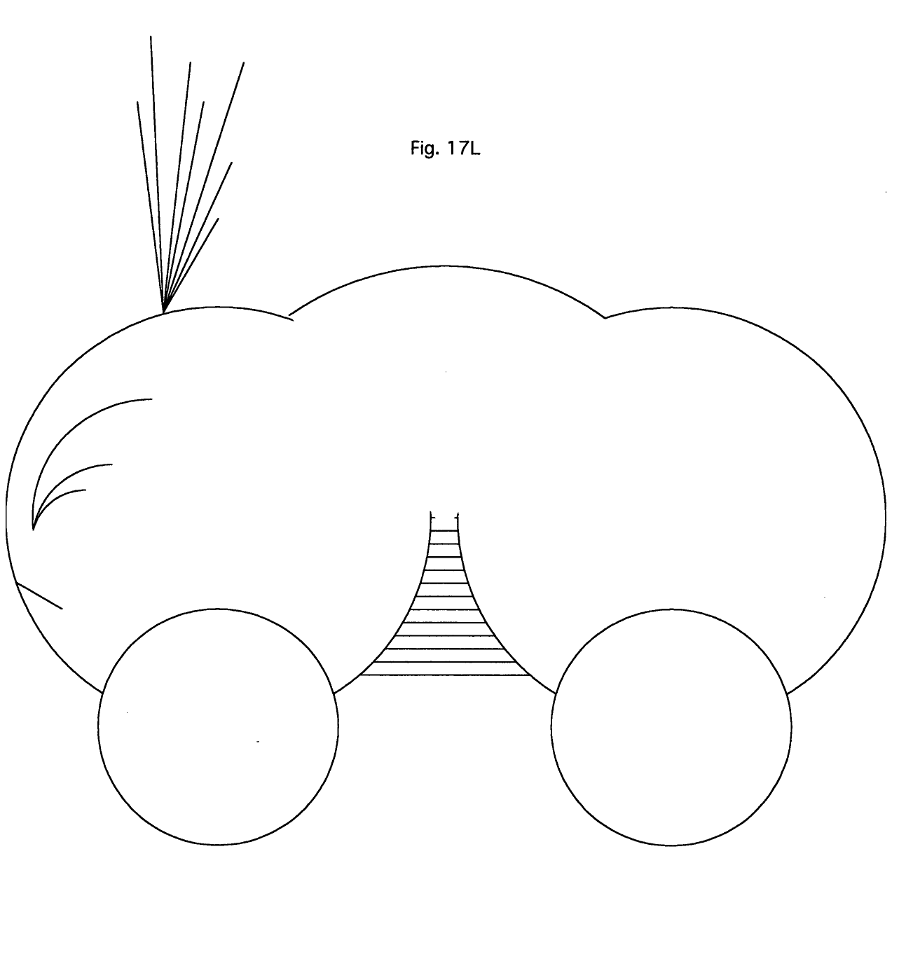

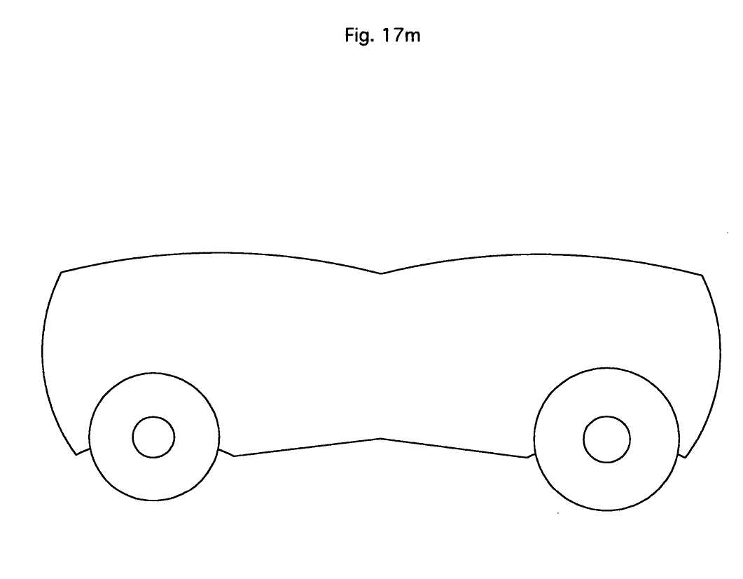

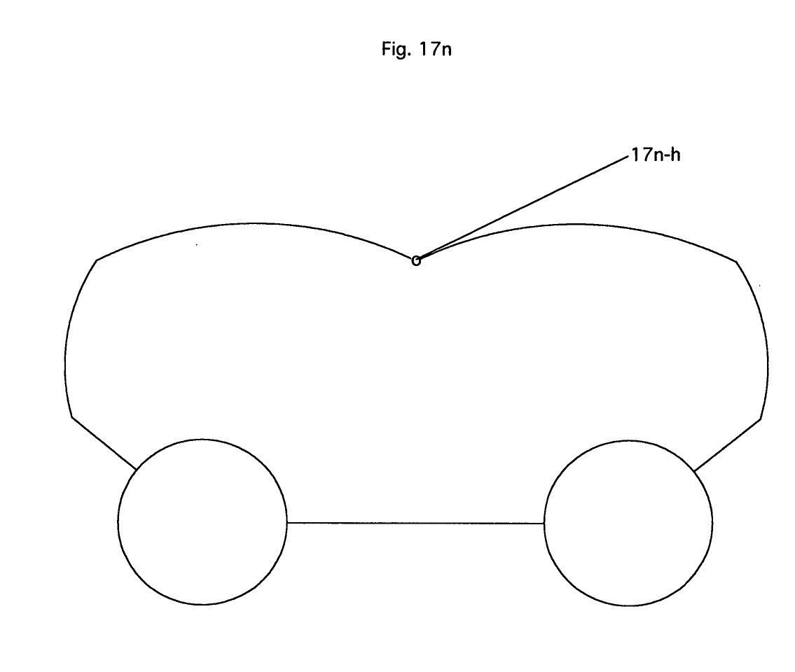

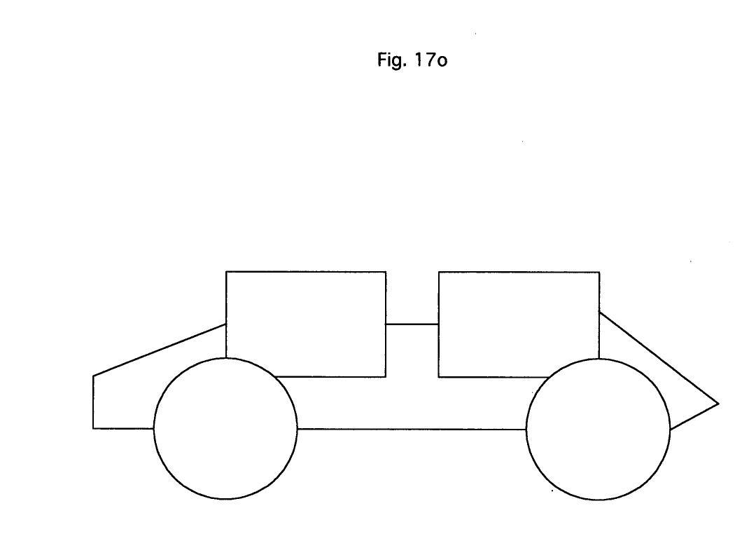

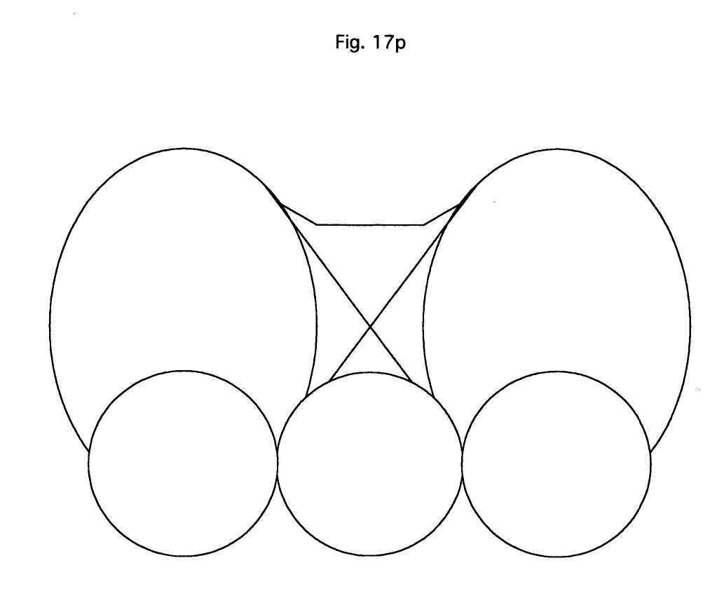

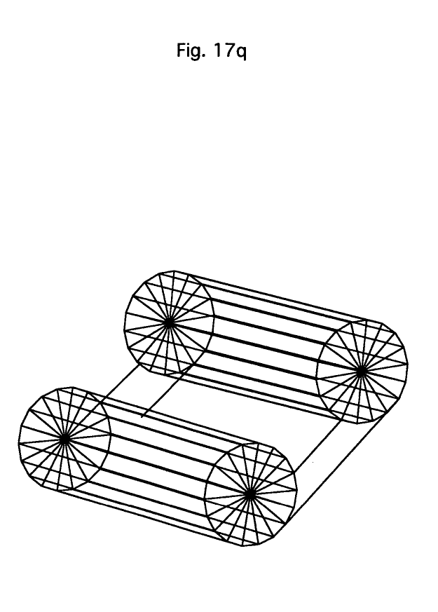

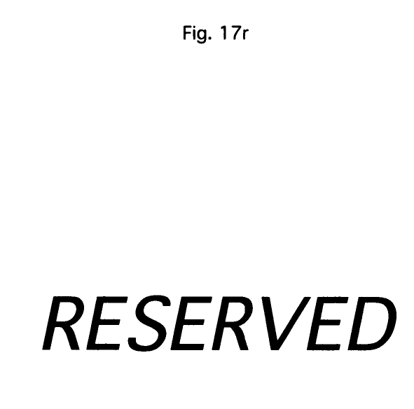

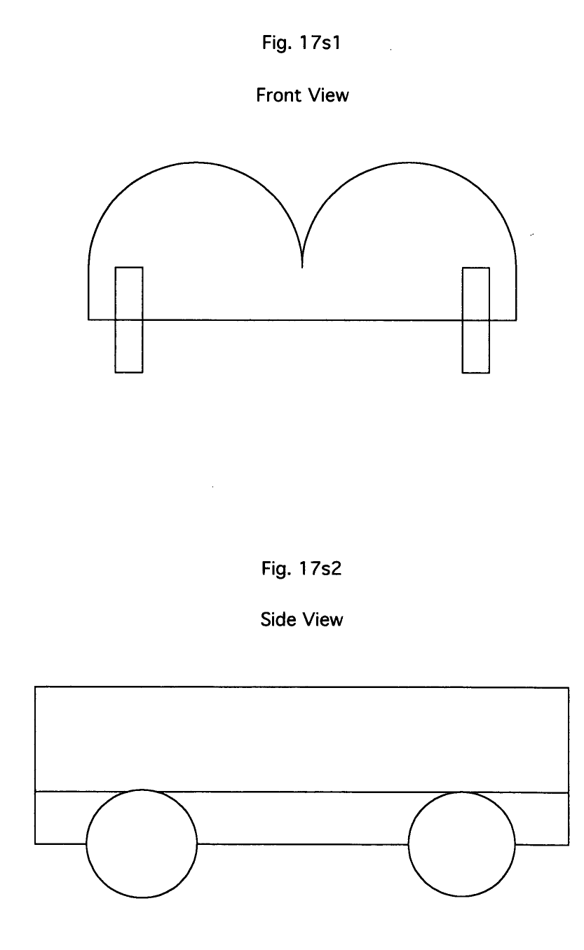

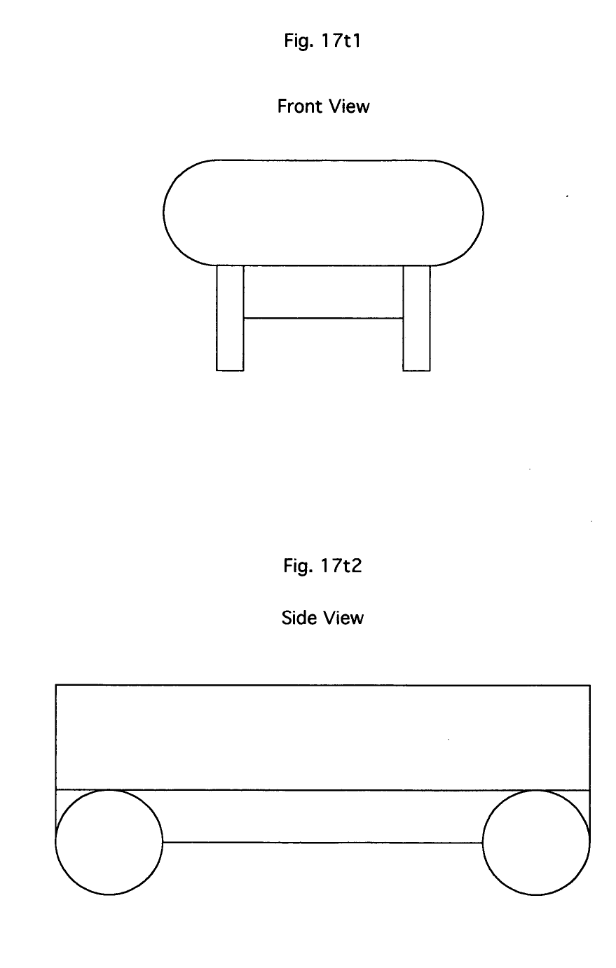

FIG. 17a

FIG. 17aa

FIG. 17b

FIG. 17c

FIG. 17d

FIG. 17e

FIG. 17f

FIG. 17g

FIG. 17h

FIG. 171

FIG. 17j

FIG. 17k

FIG. 17L

FIG. 17m

FIG. 17n

FIG. 170

FIG. 17p

FIG. 17q

FIG. 17r

FIG. 17s1, 17s2

FIG. 17t1, 17t2

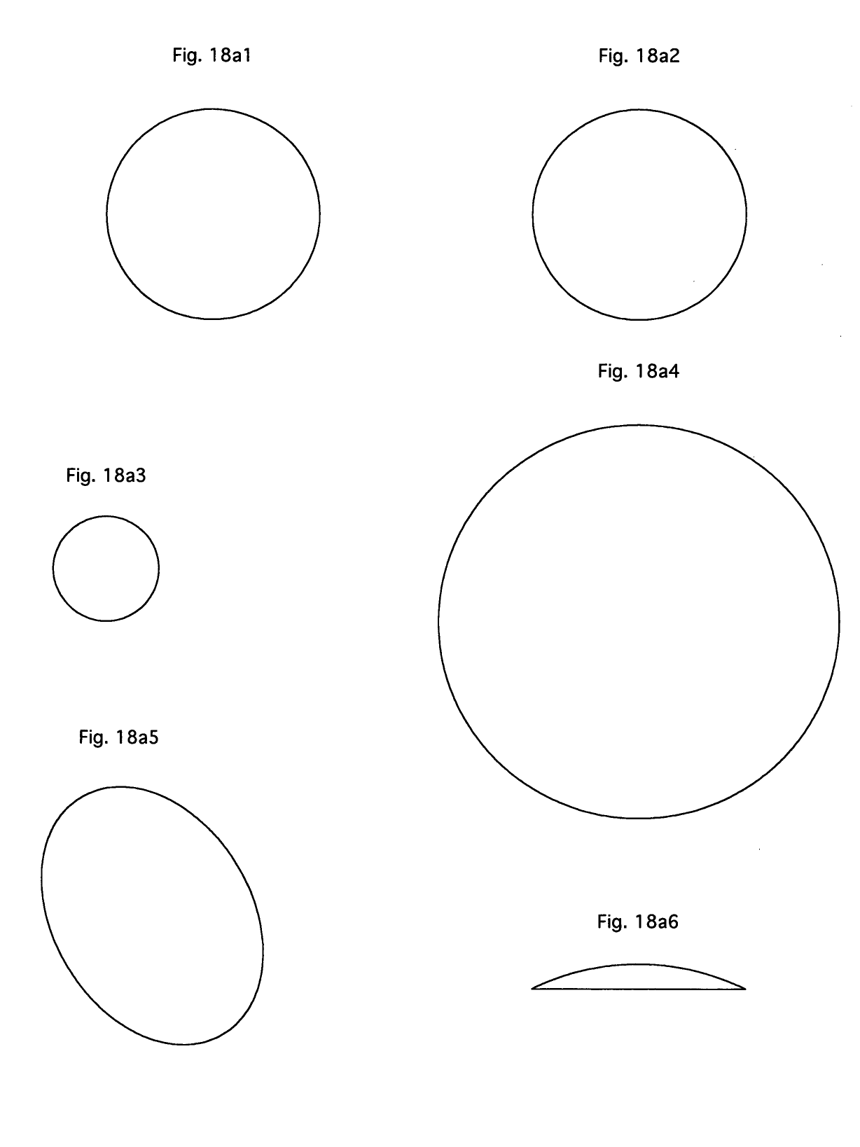

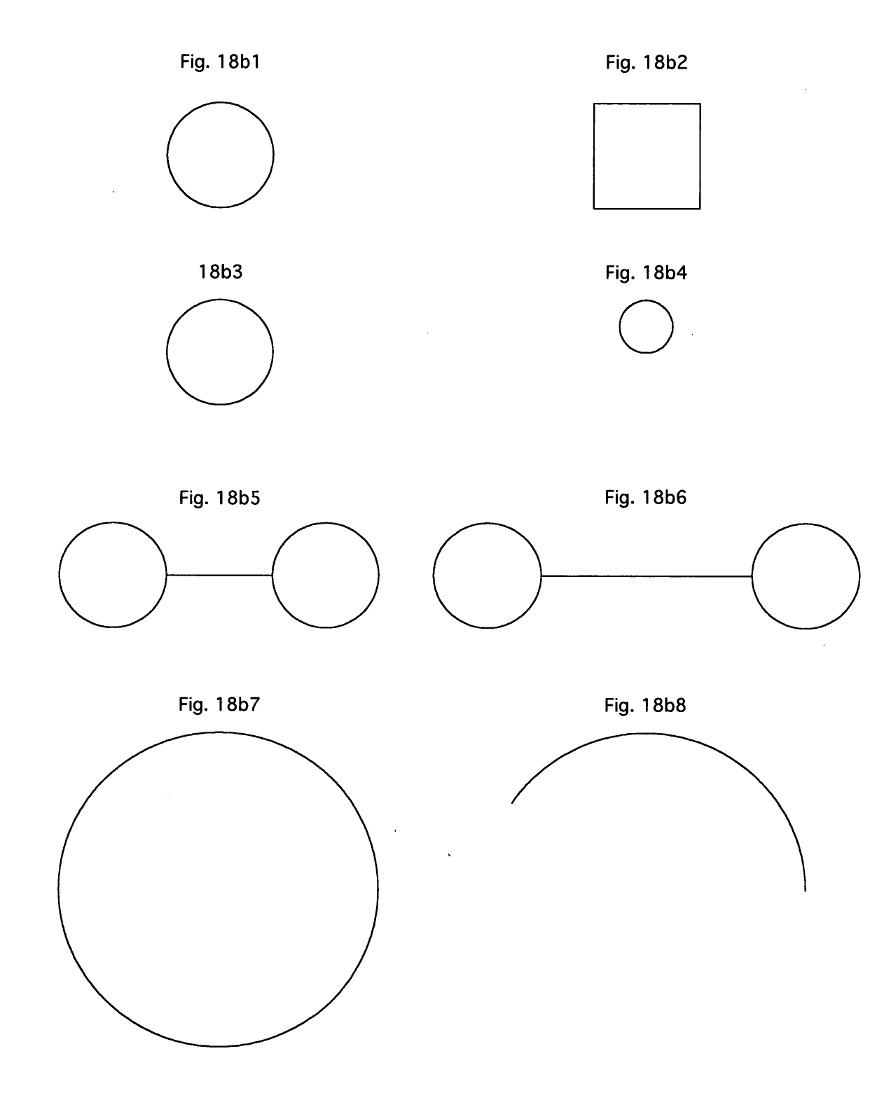

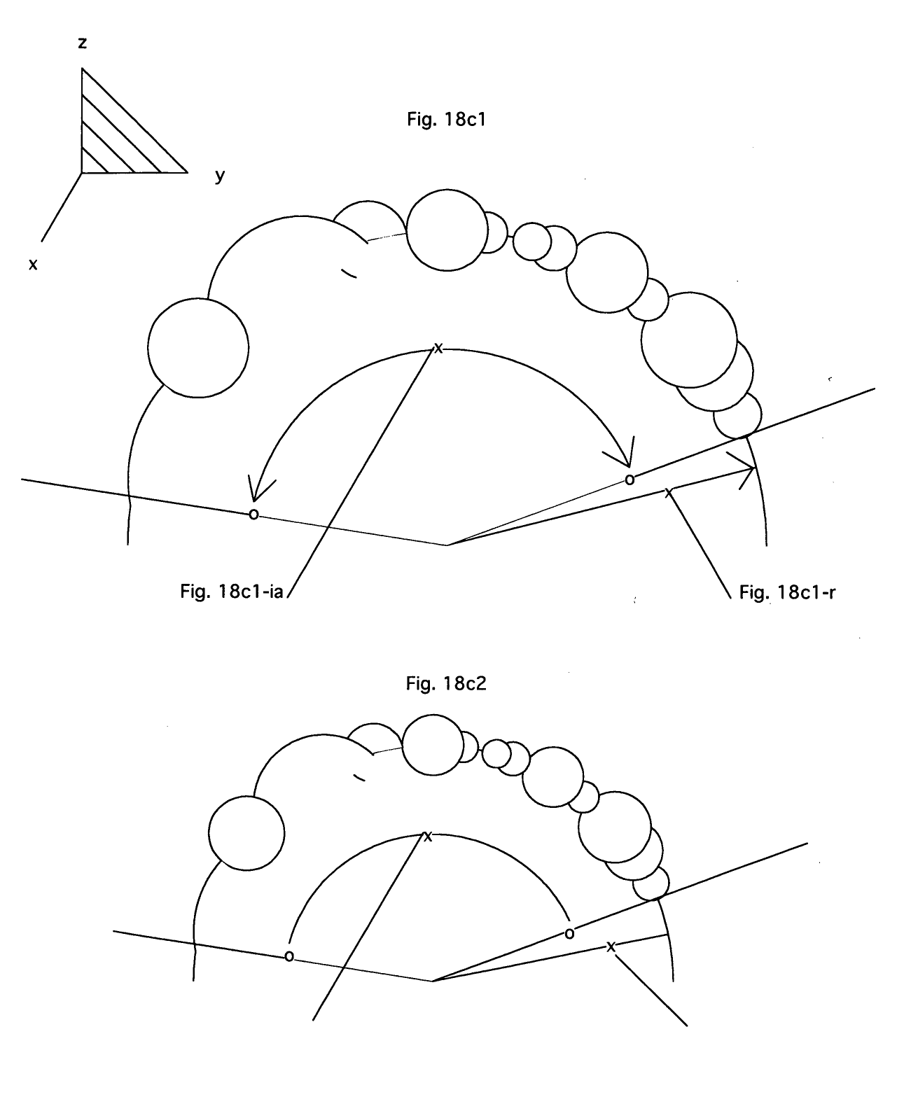

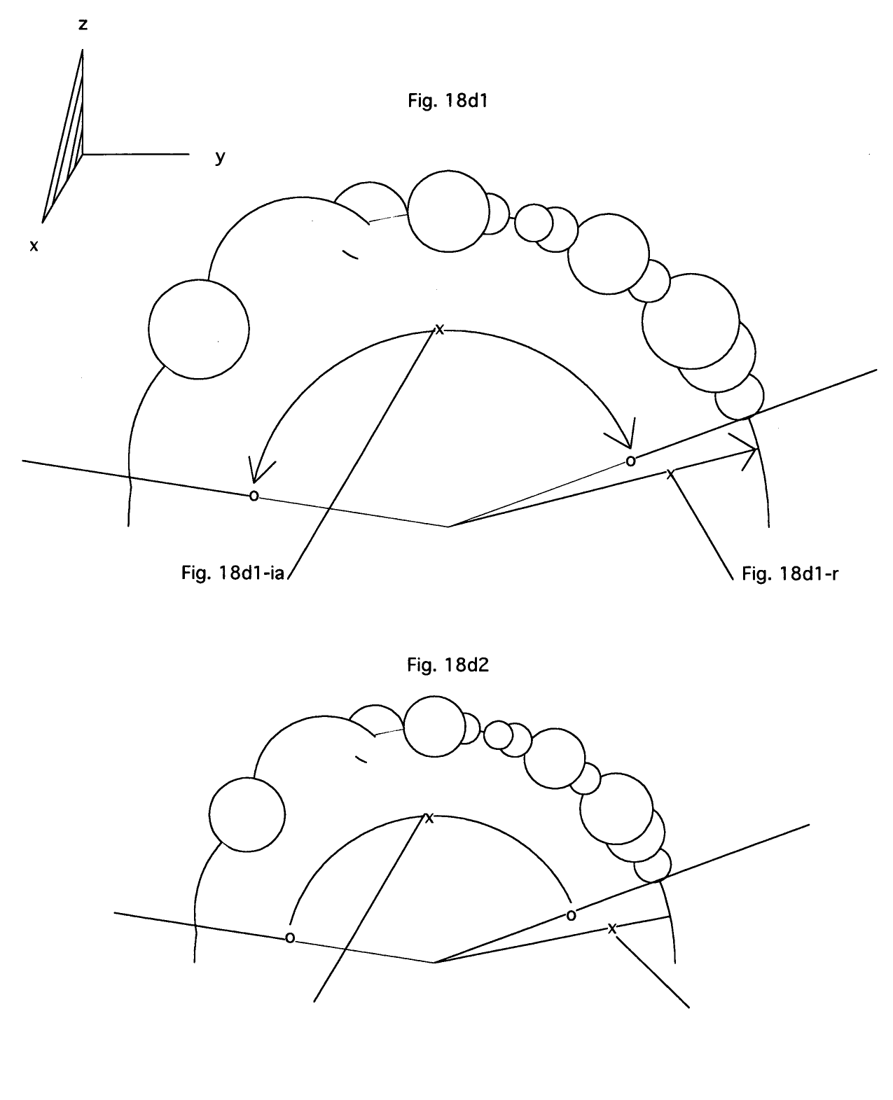

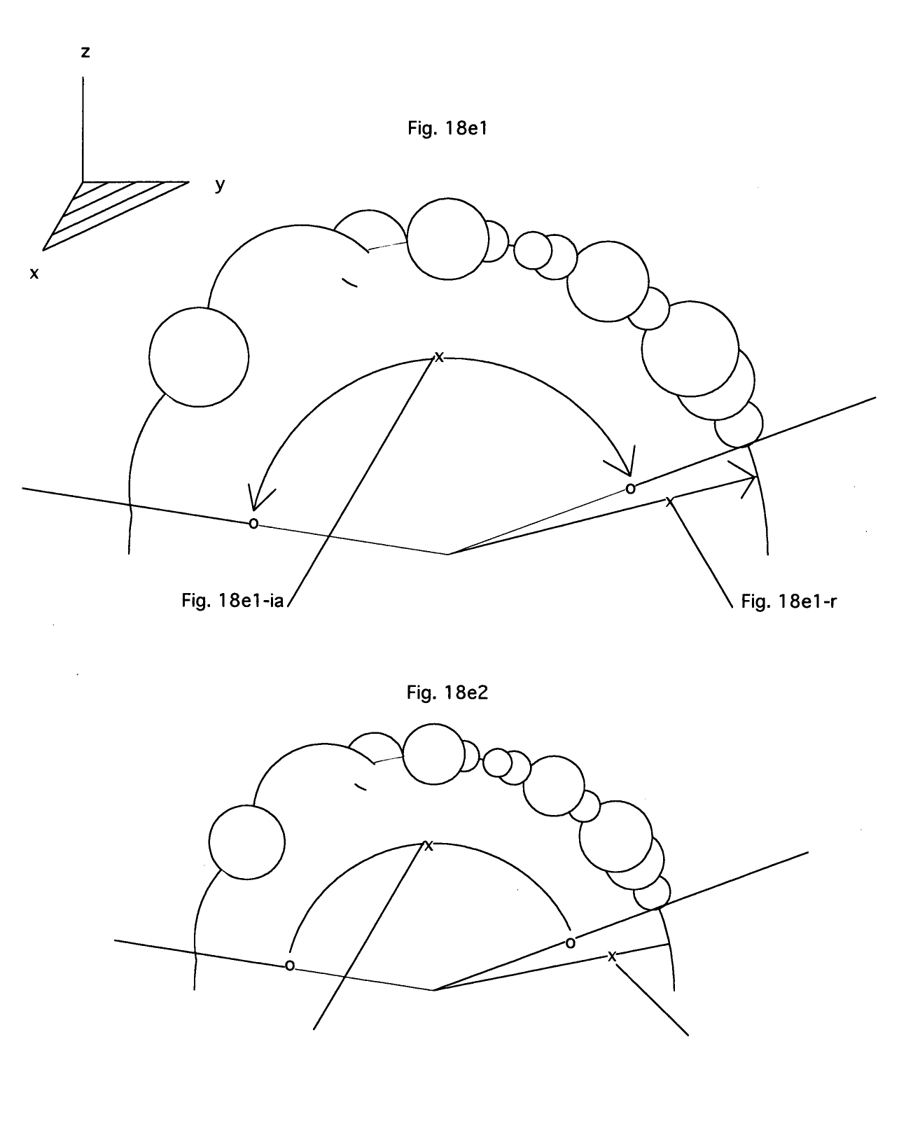

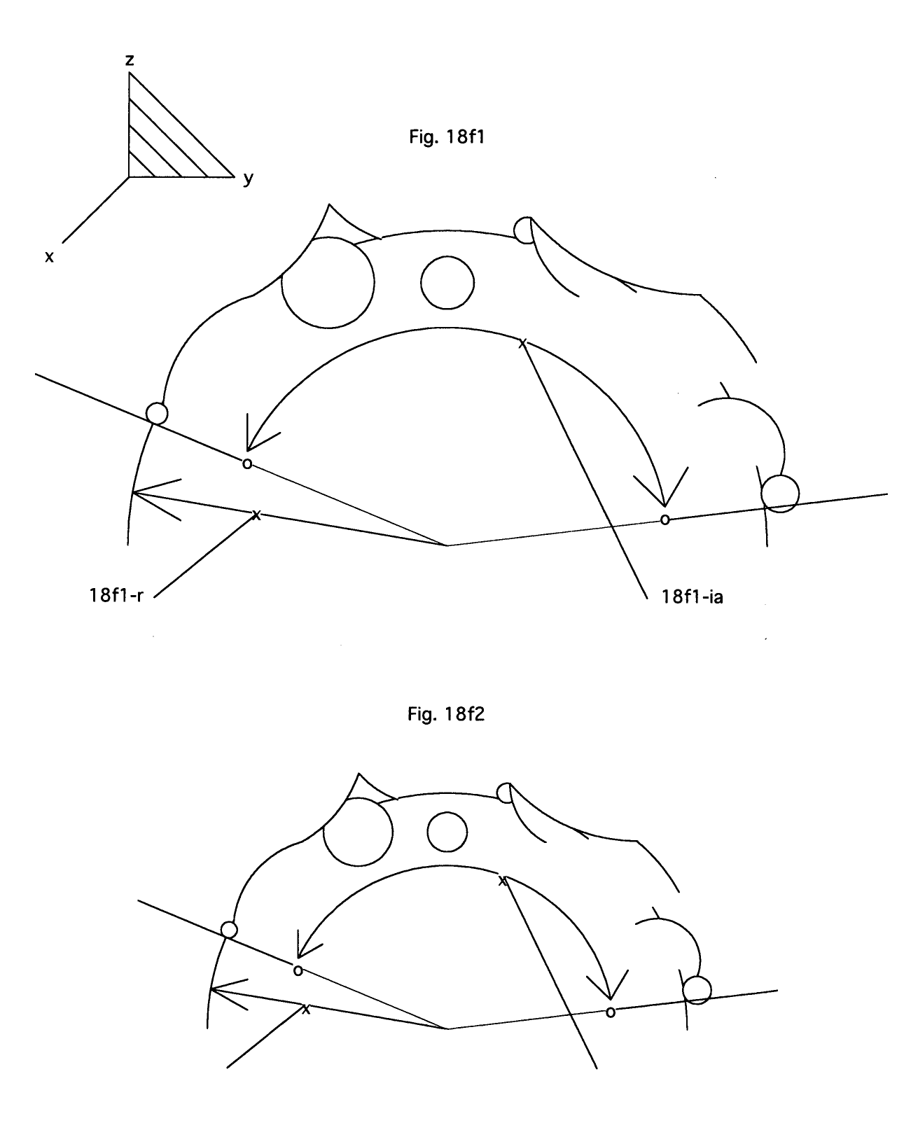

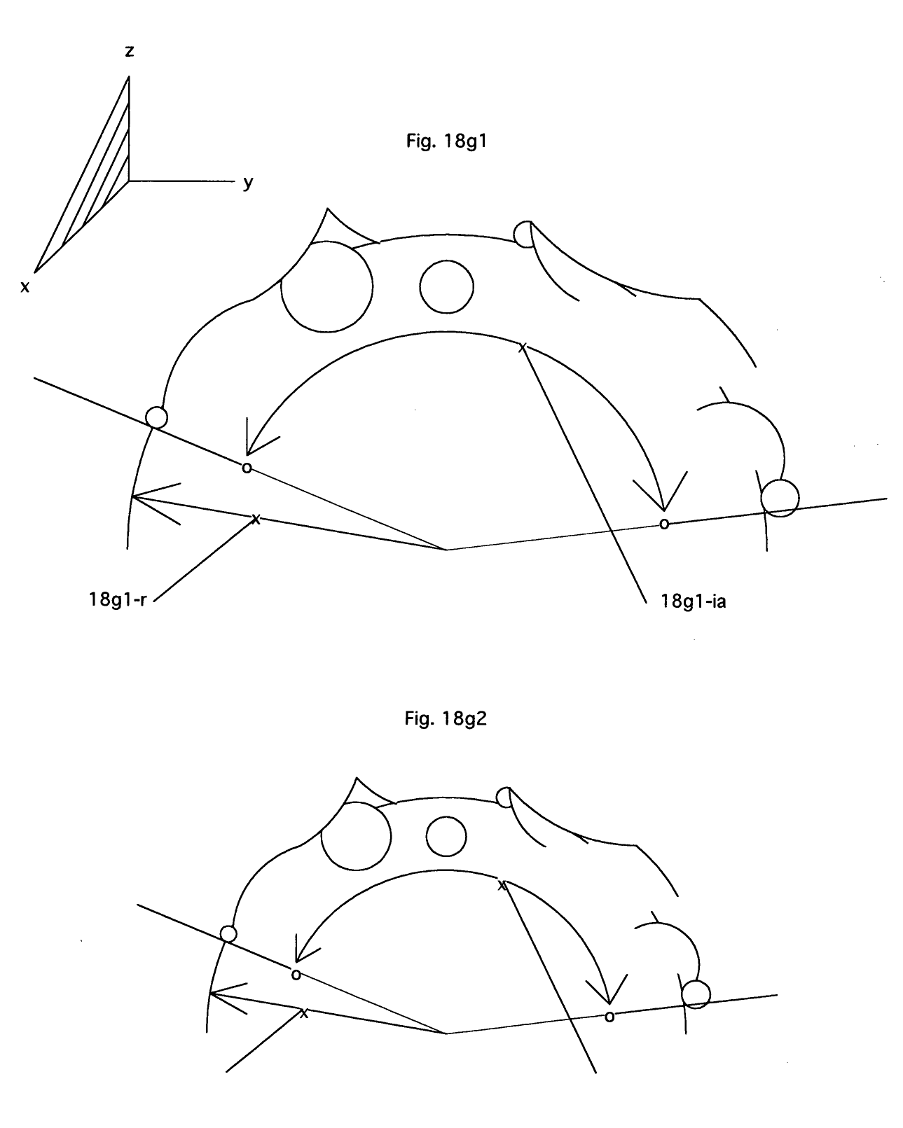

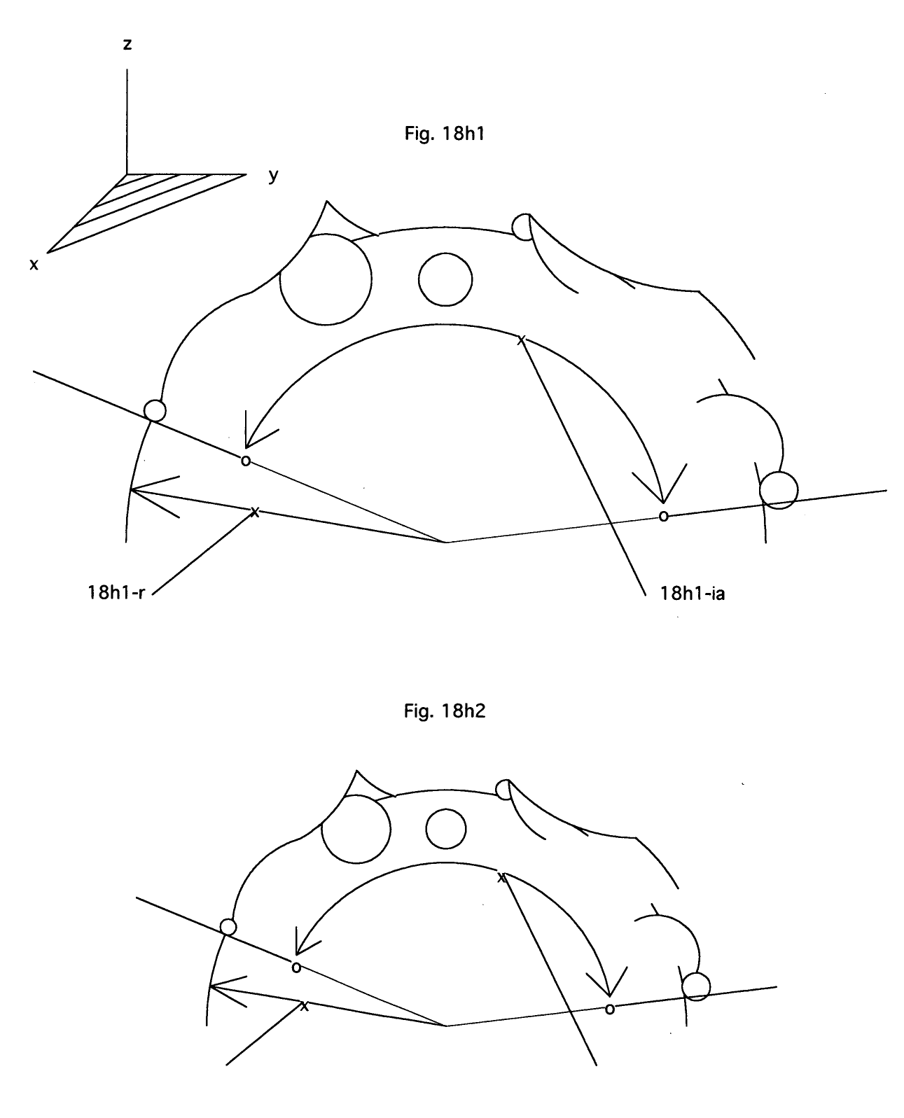

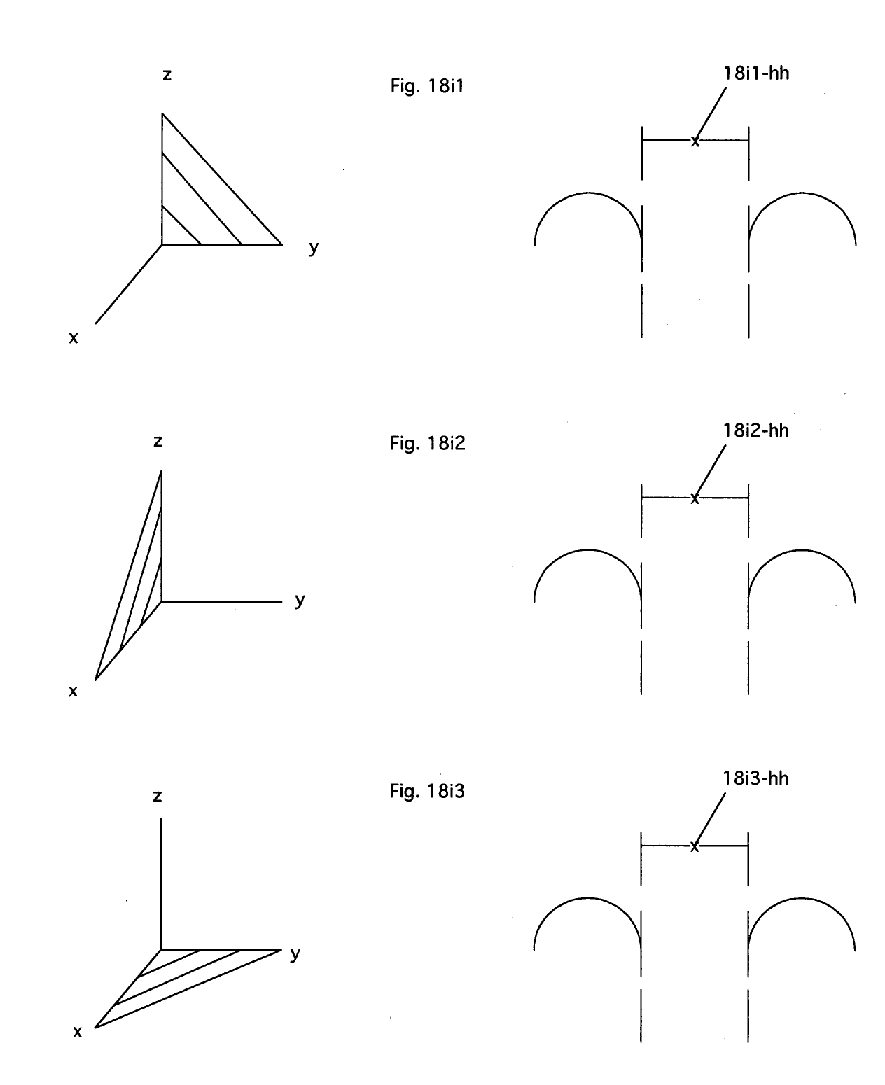

FIG. 18a1, 18a2, 18a3, 18a4, 18a5, 18a6

FIG. 18b1, 18b2, 18b3, 18b4, 18b5, 18b6, 18b7, 18b8

FIG. 18c1, 18c2

FIG. 18d1, 18d2

FIG. 18e1, 18e2

FIG. 18f1, 18f2

FIG. 18g1, 18g2

FIG. 18h1, 18h2

FIG. 18l1, 18l2, 18l3

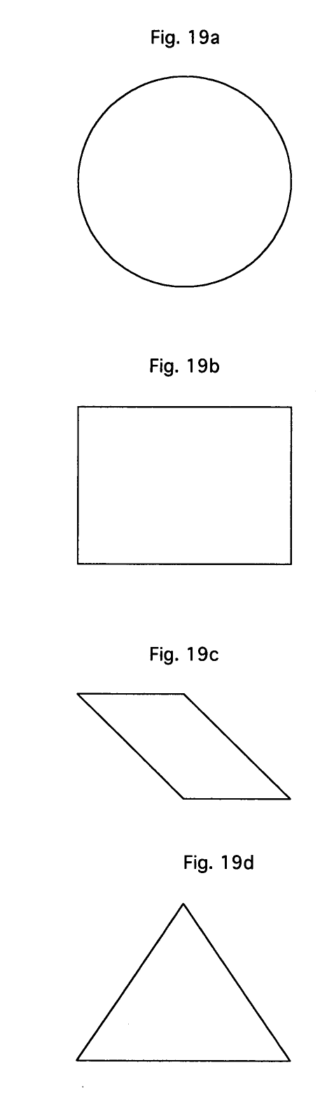

FIG. 19a, 19b, 19c, 19d

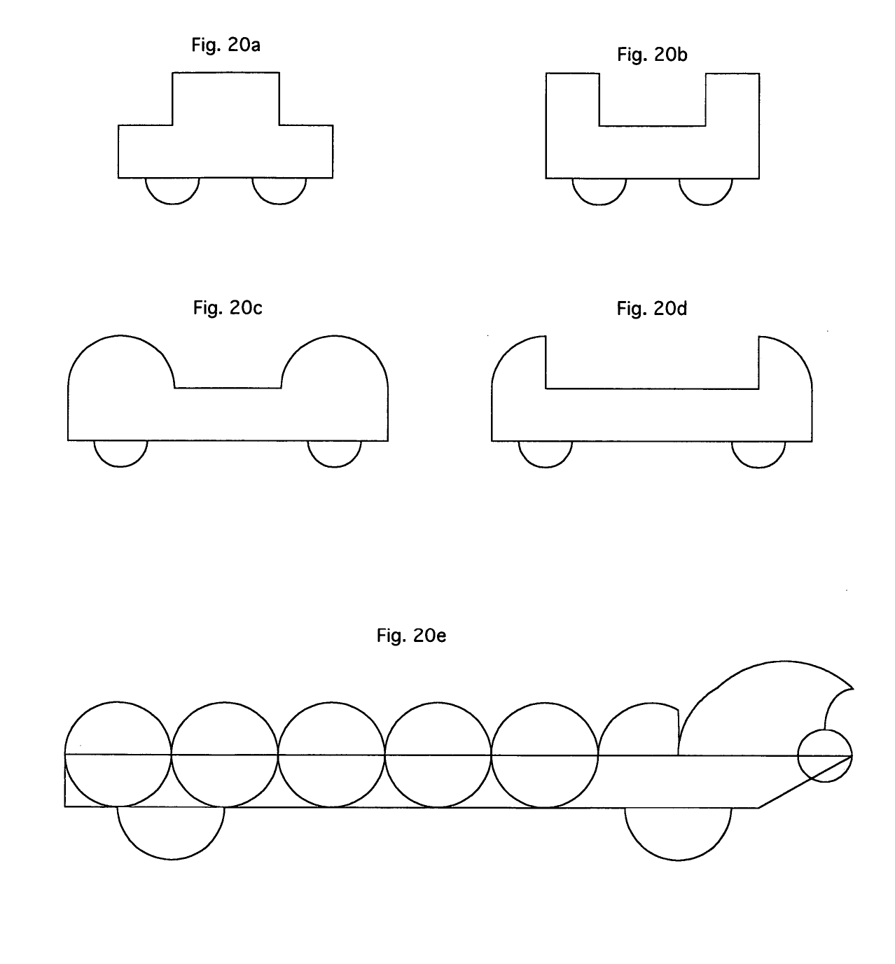

FIG. 20a, 20b, 20c, 20d, 20e

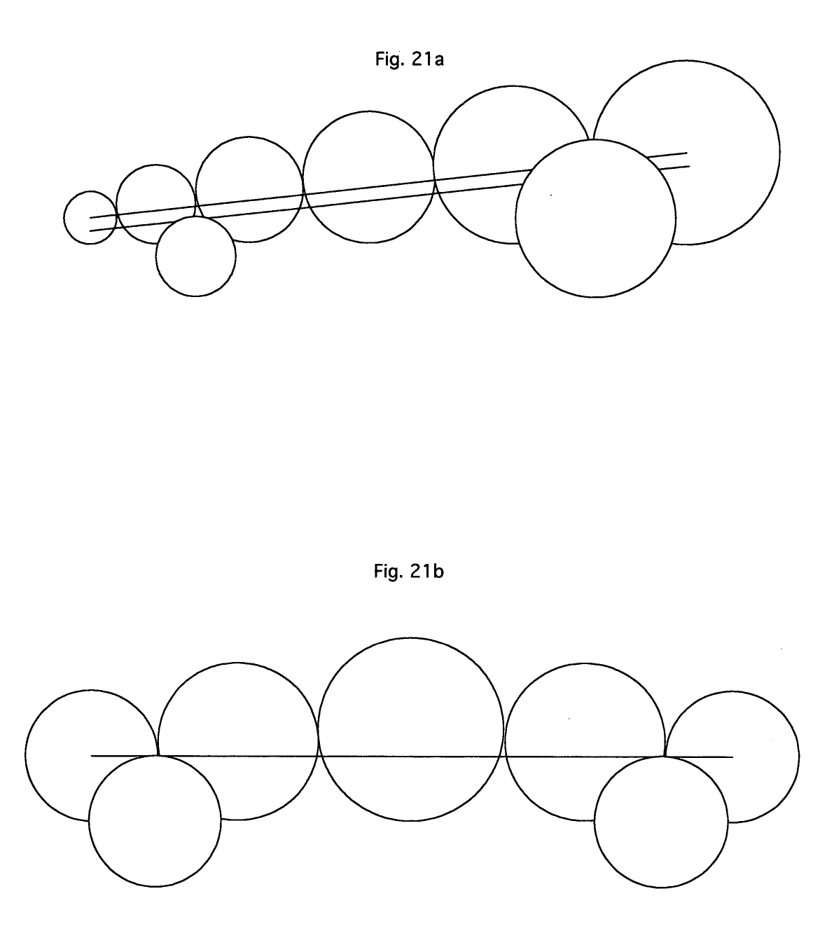

FIG. 21a, 21b

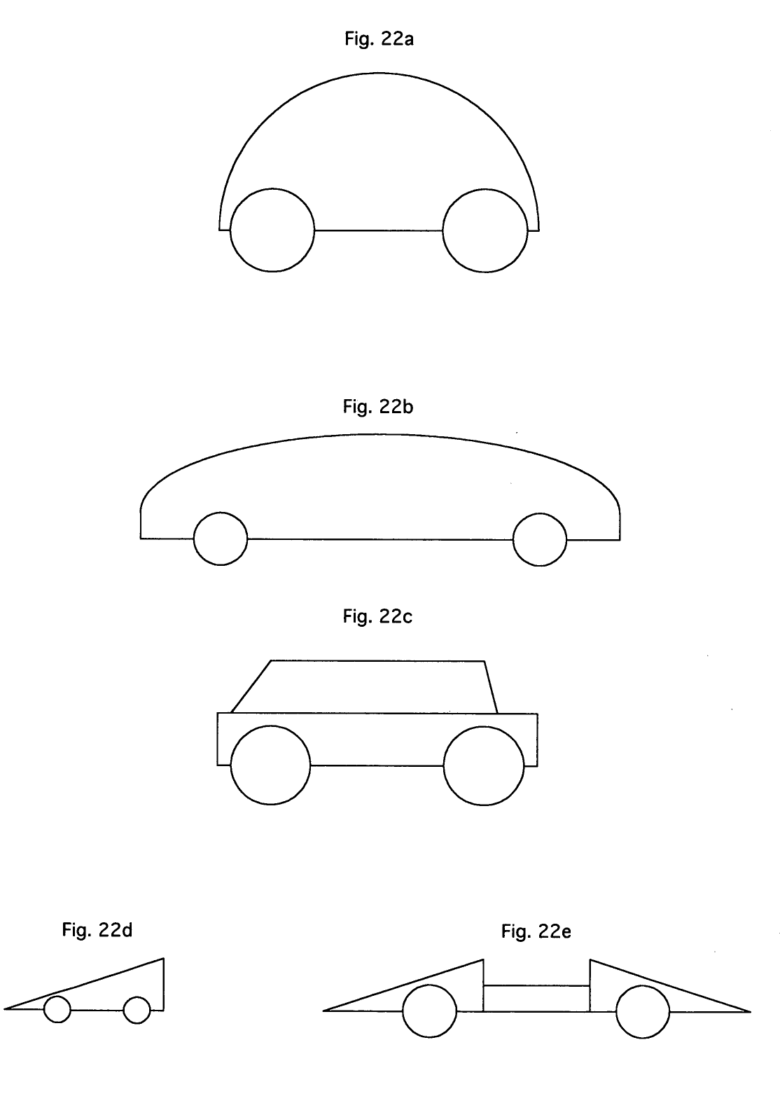

FIG. 22a, 22b, 22c, 22d, 22e

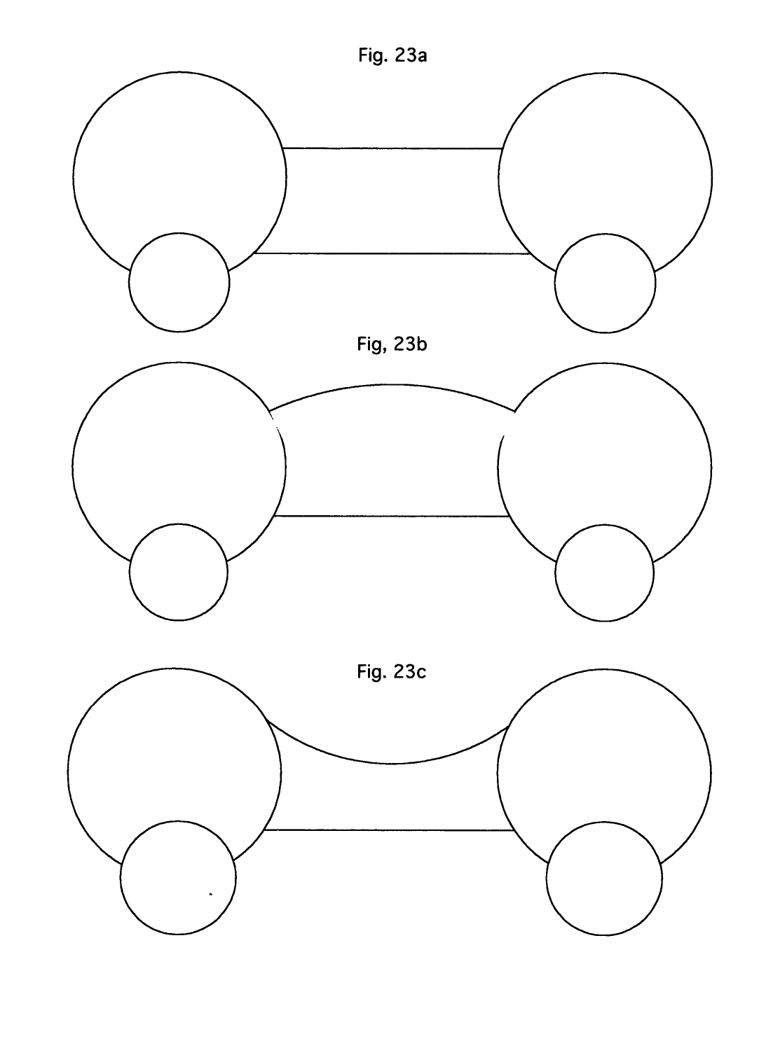

FIG. 23a, 23b, 23c

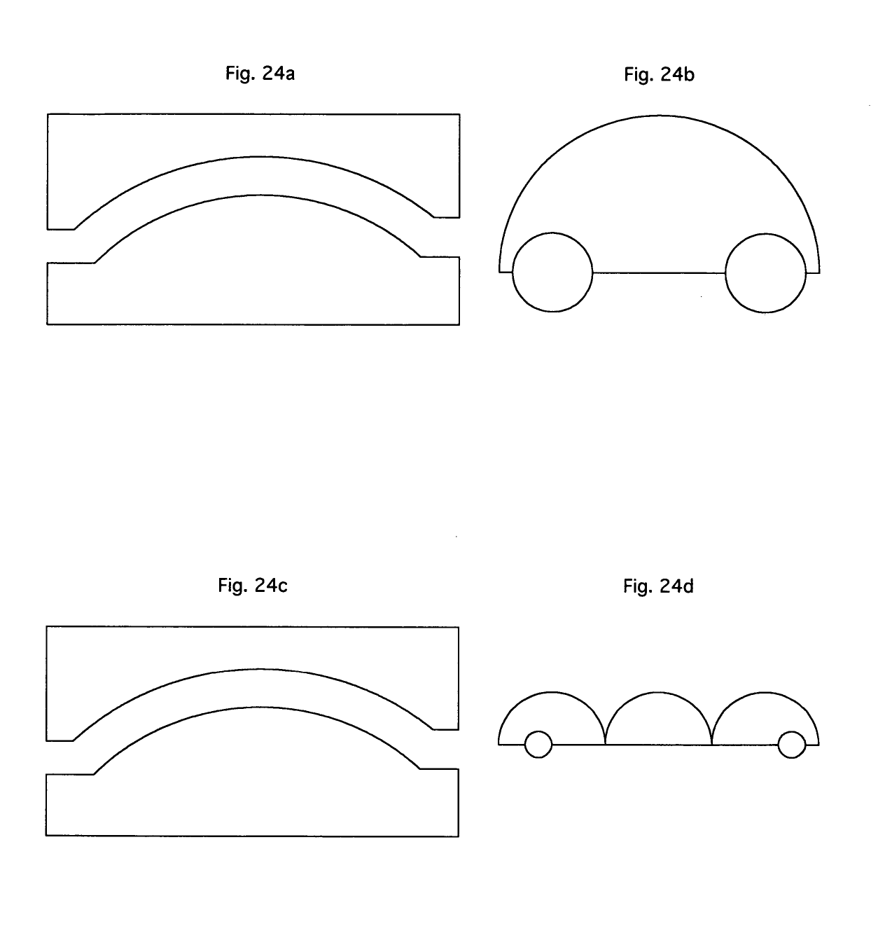

FIG. 24a, 24b, 24c, 24d

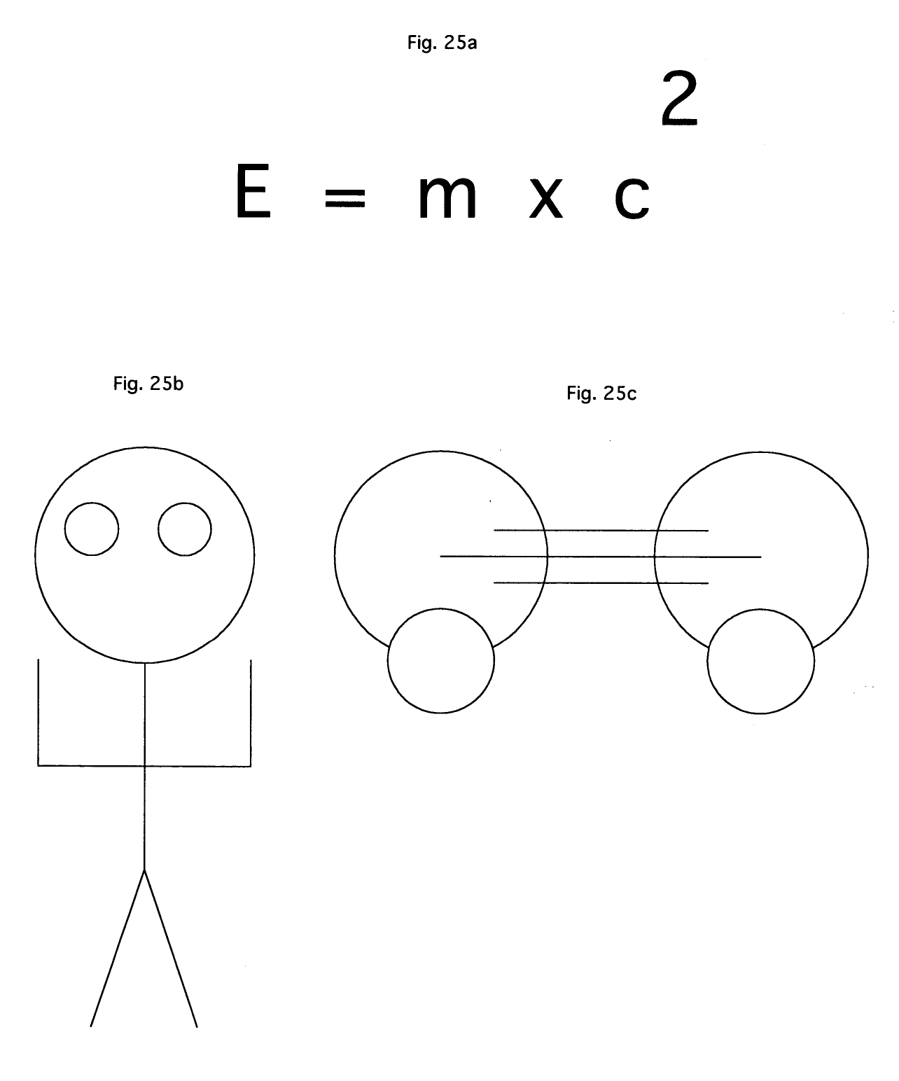

FIG. 25a, 25b, 25c

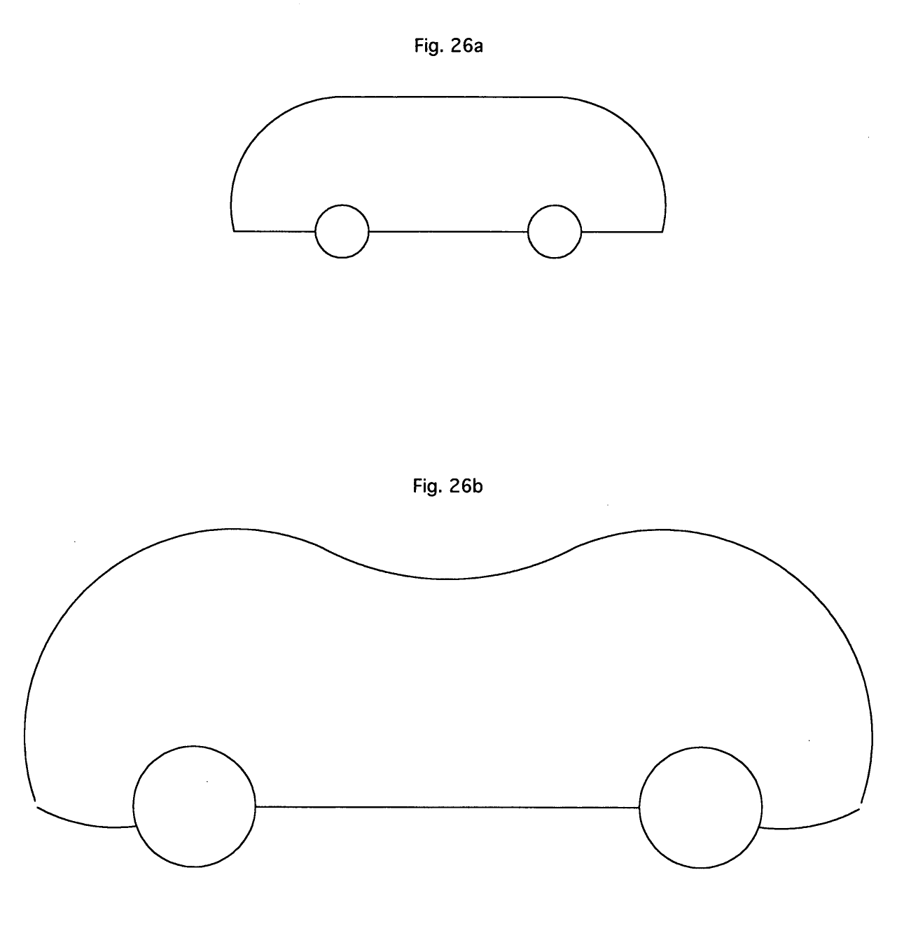

FIG. 26a, 26b

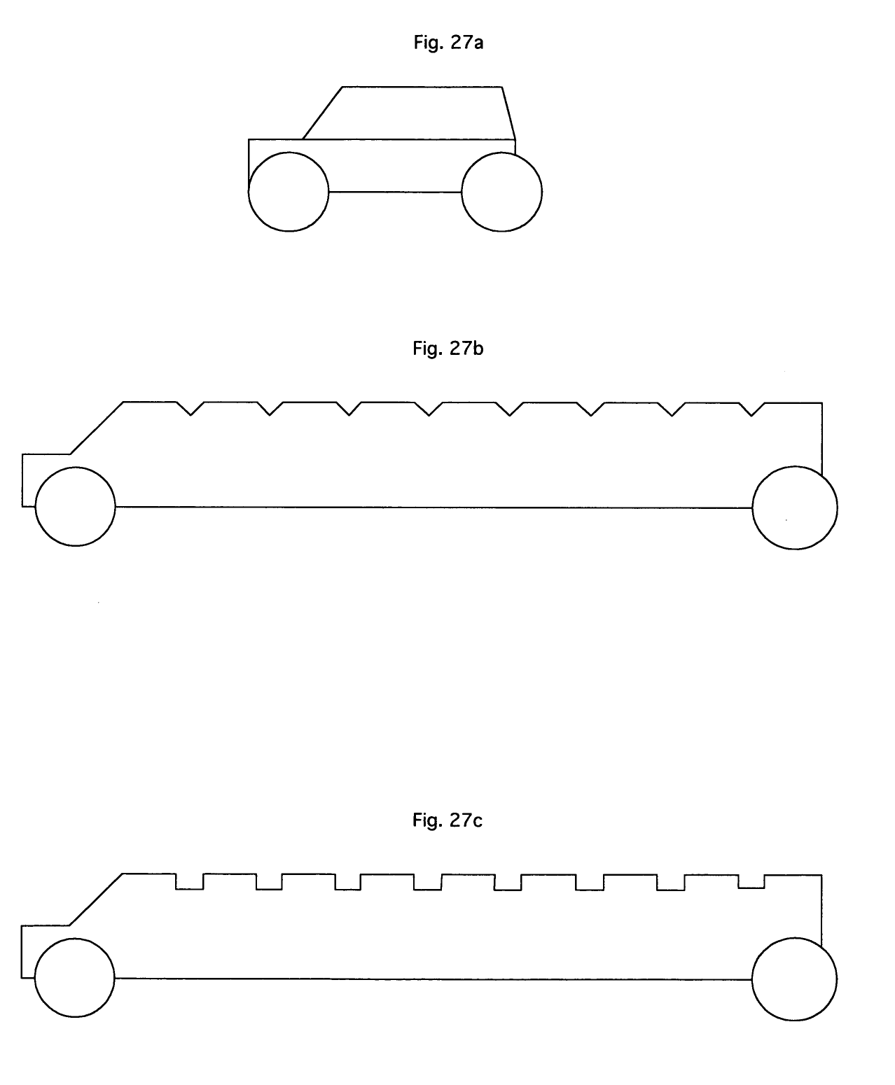

FIG. 27a, 27b, 27c

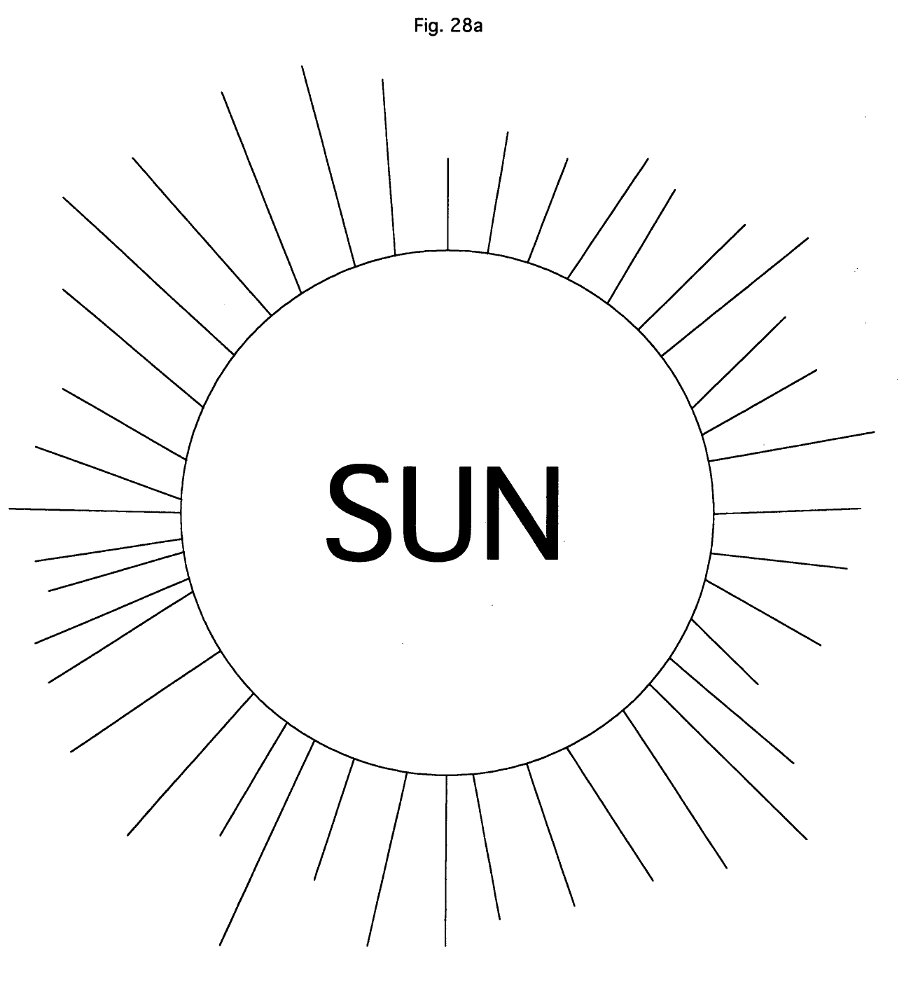

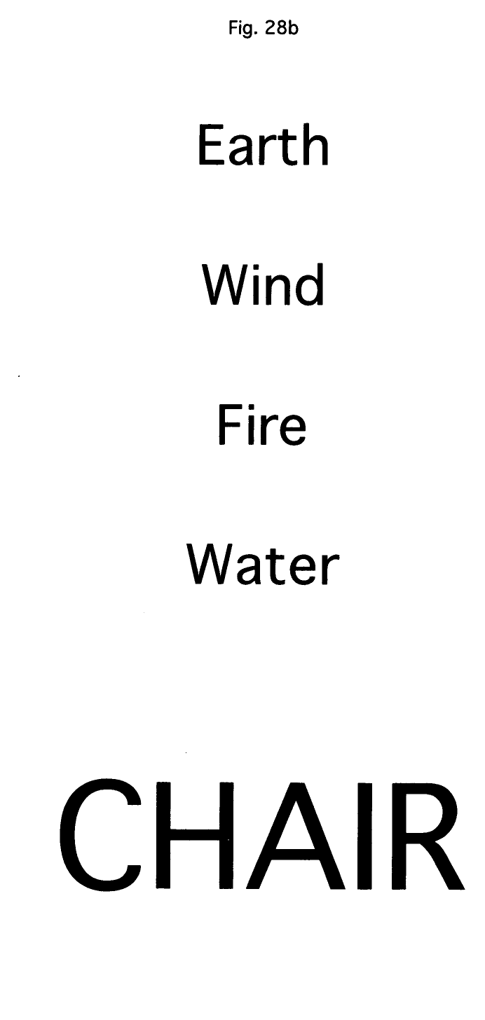

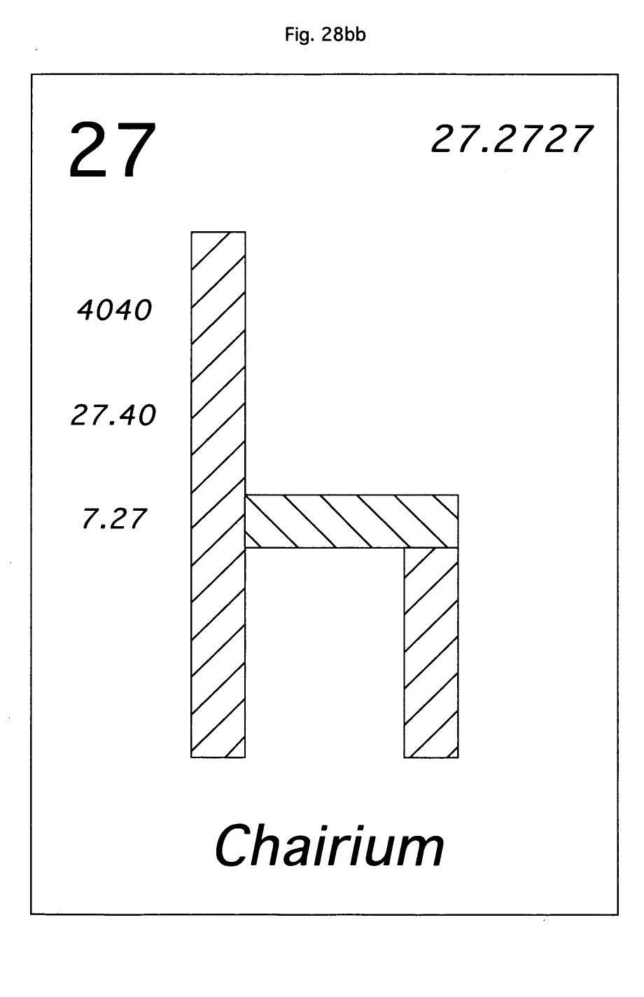

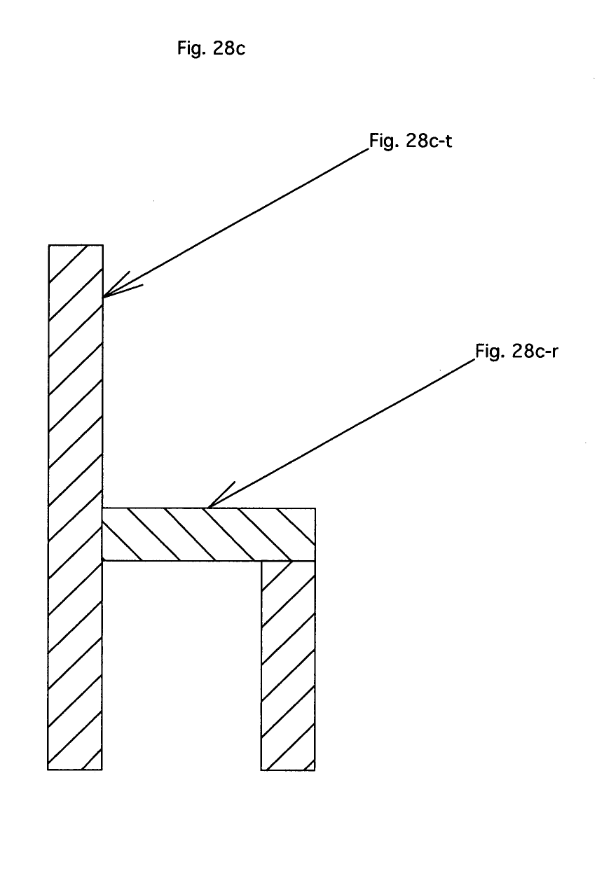

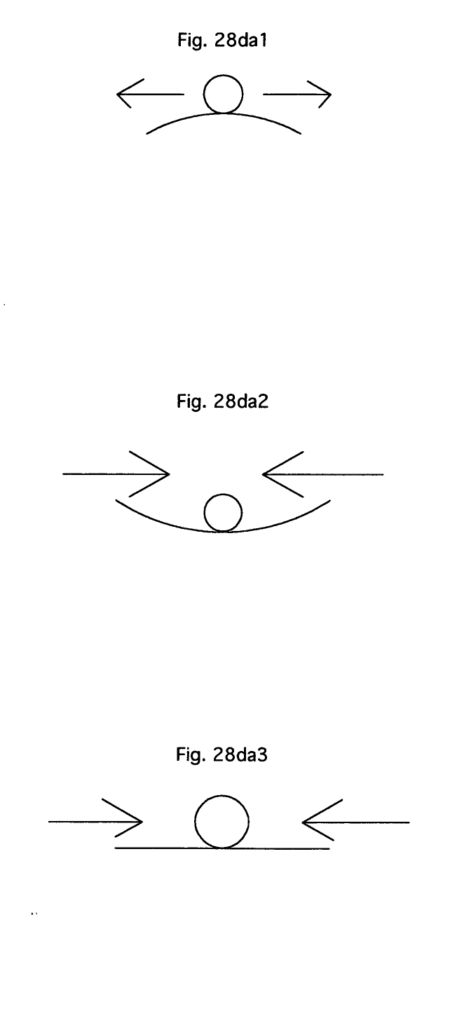

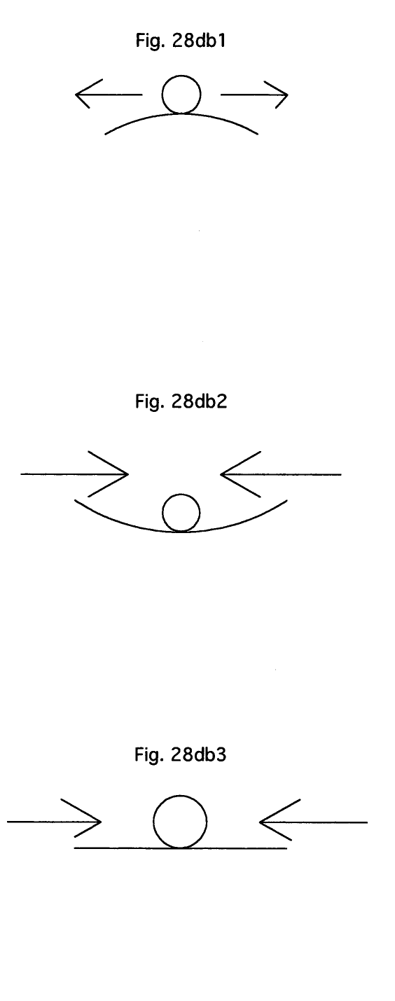

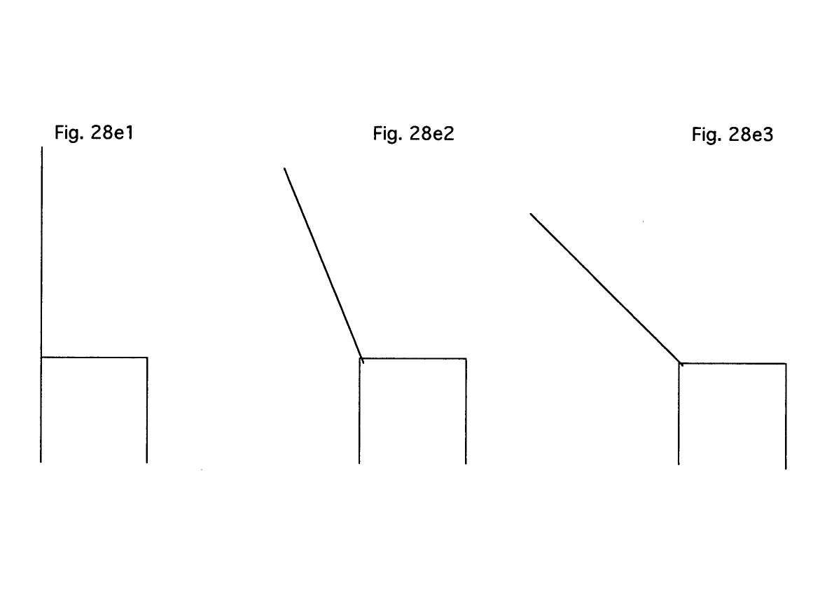

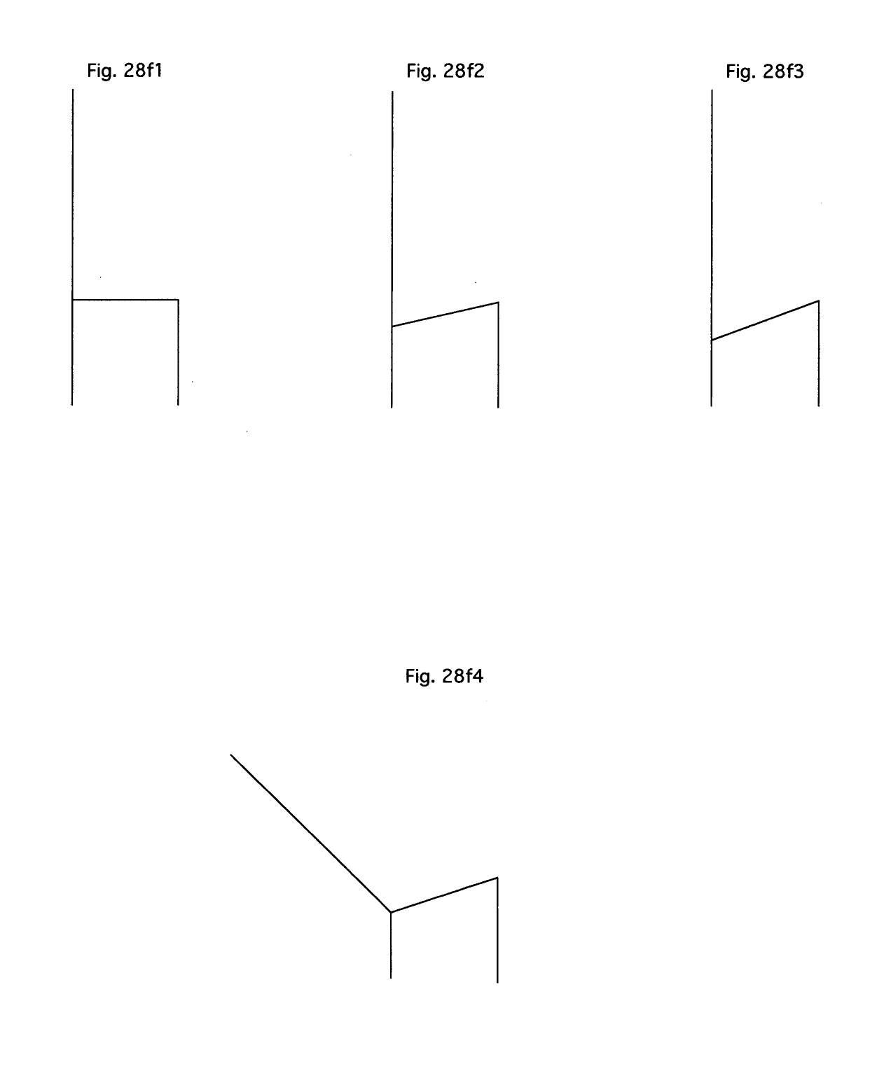

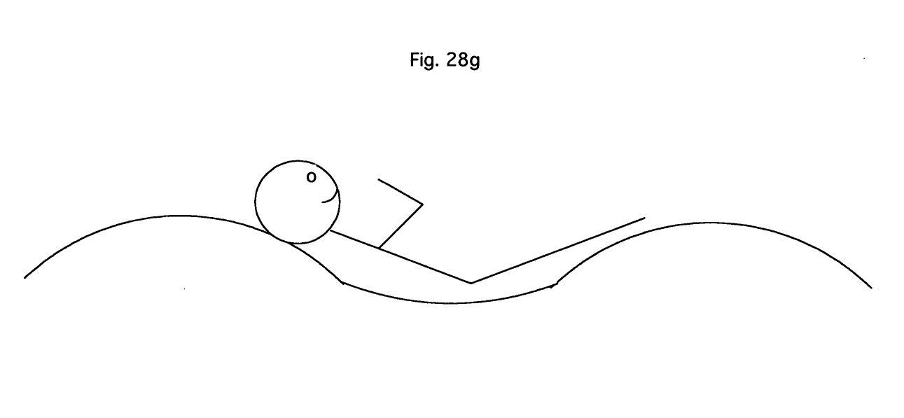

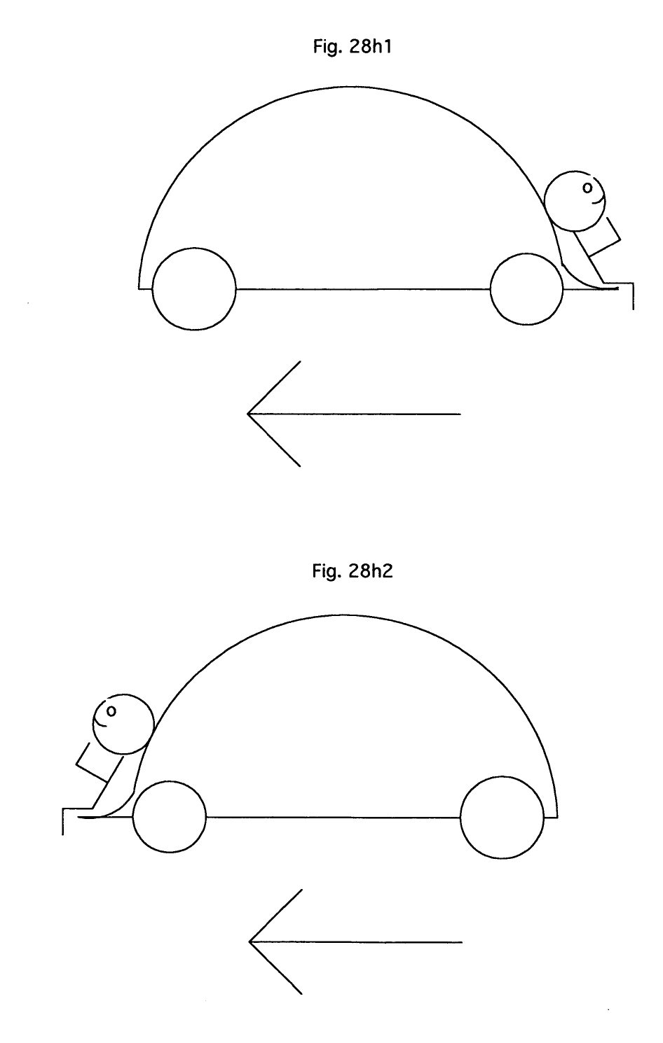

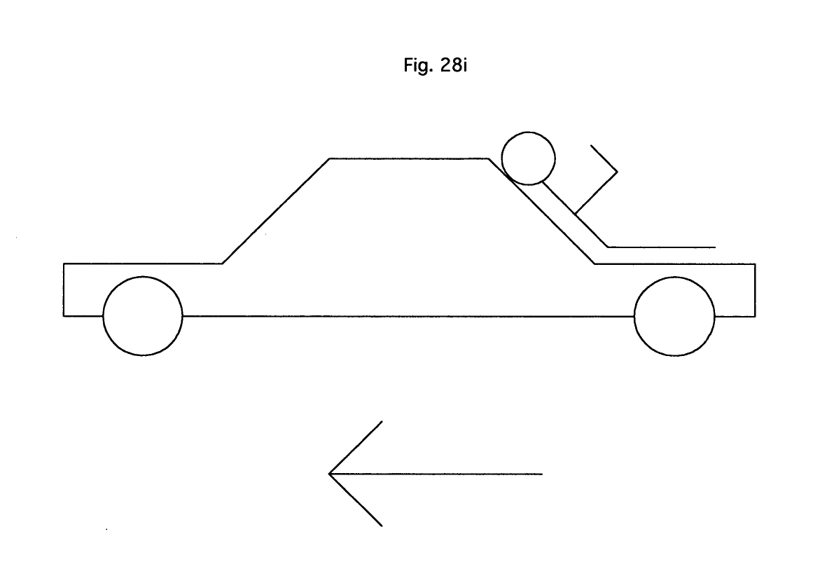

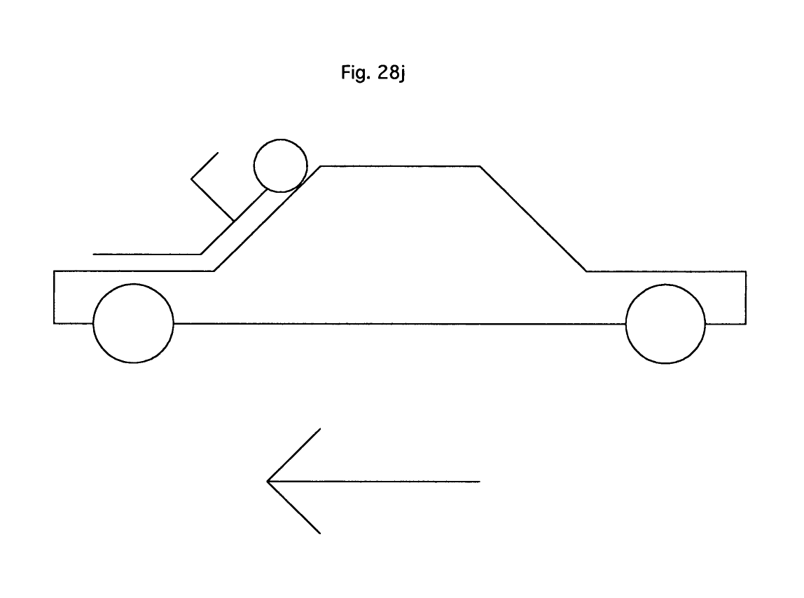

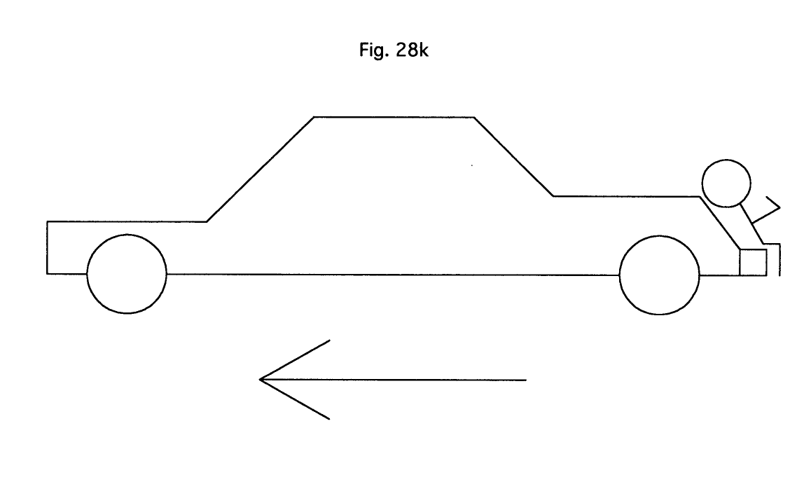

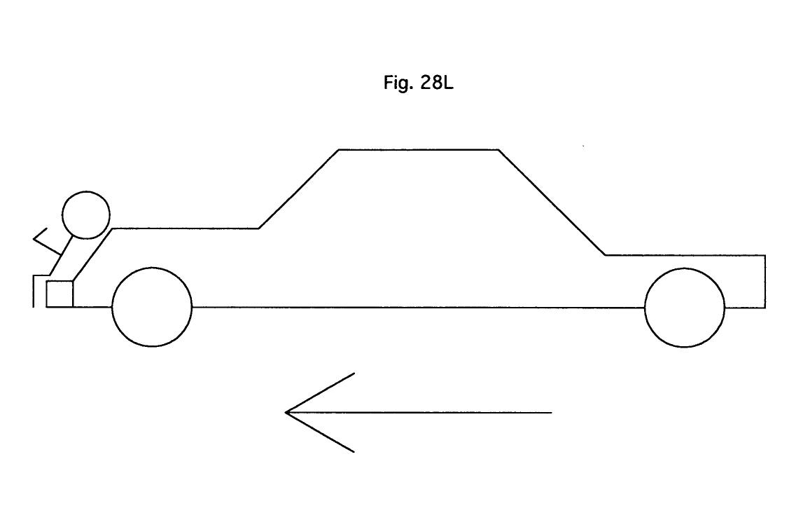

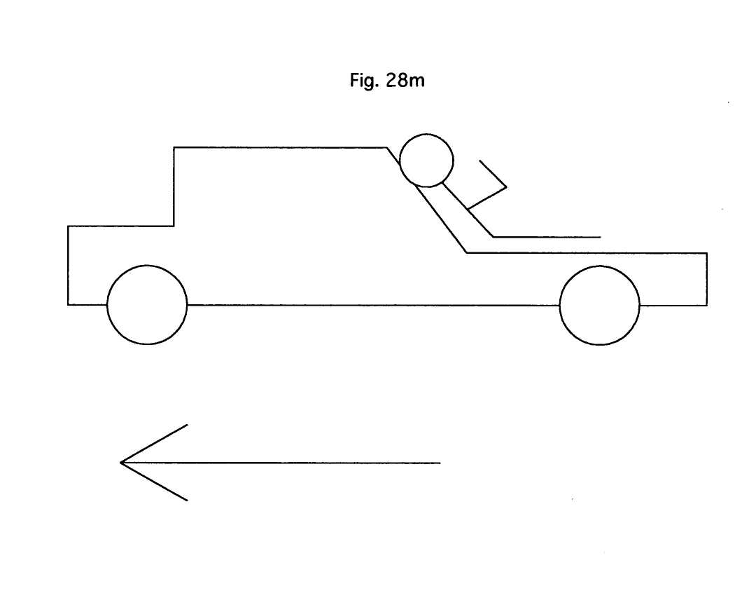

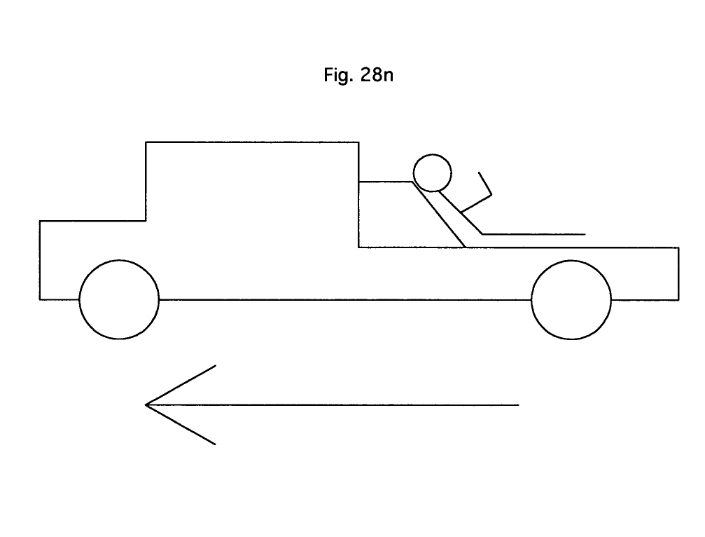

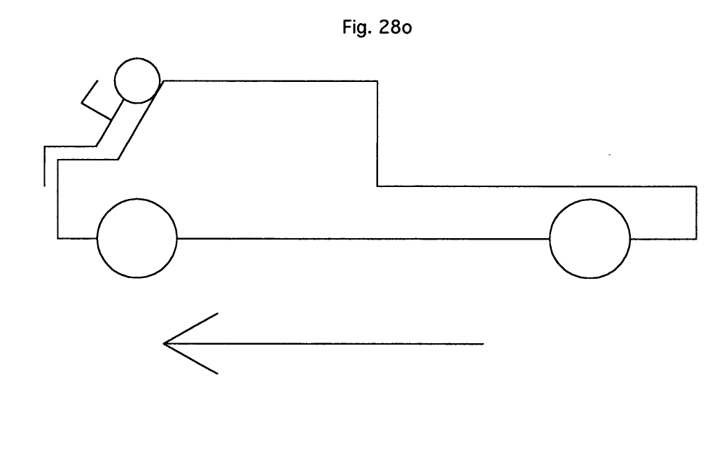

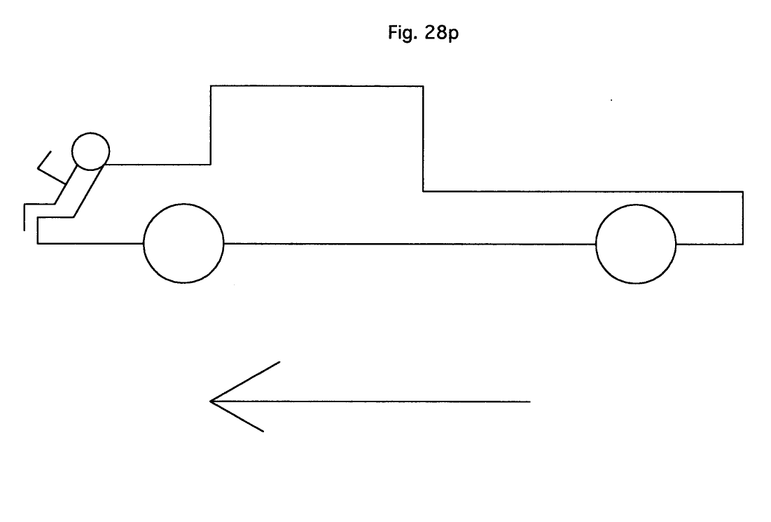

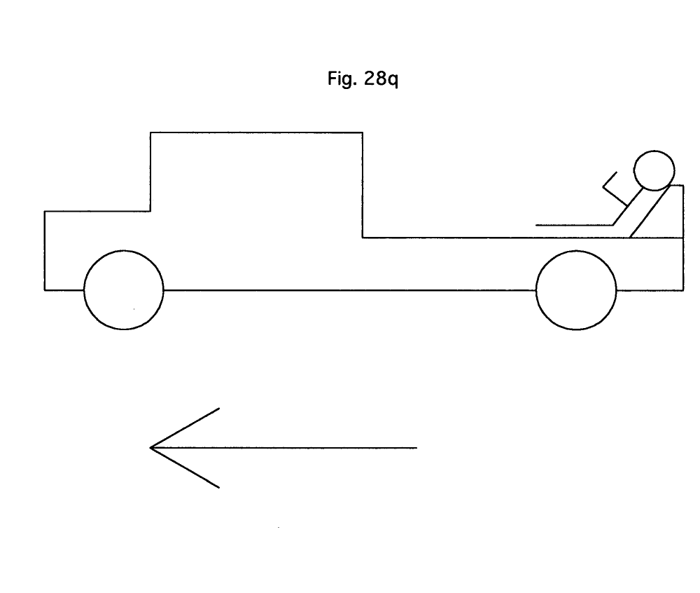

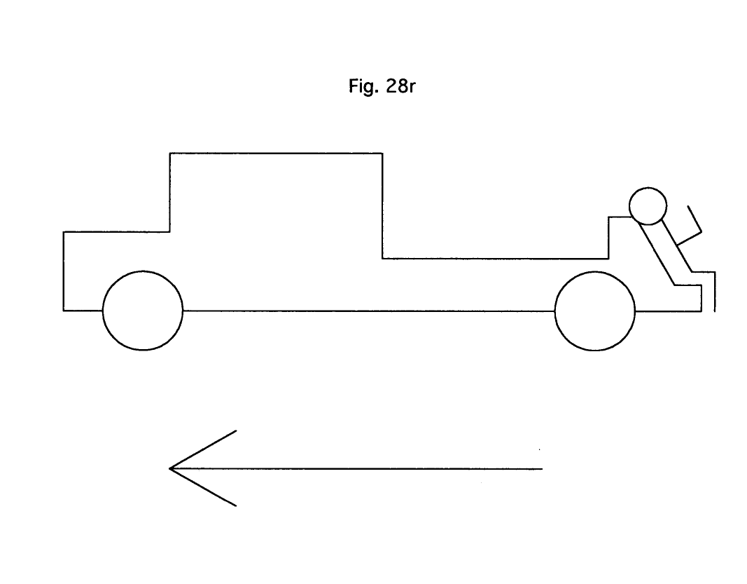

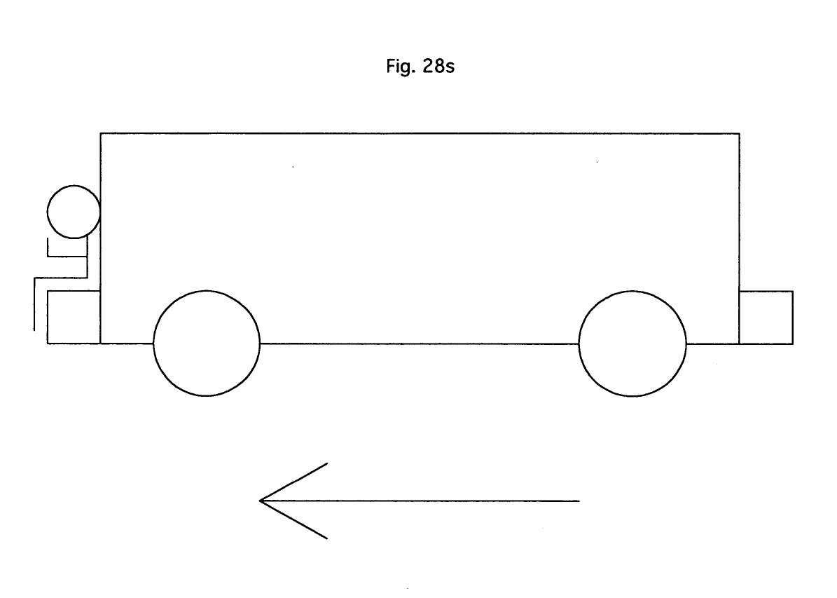

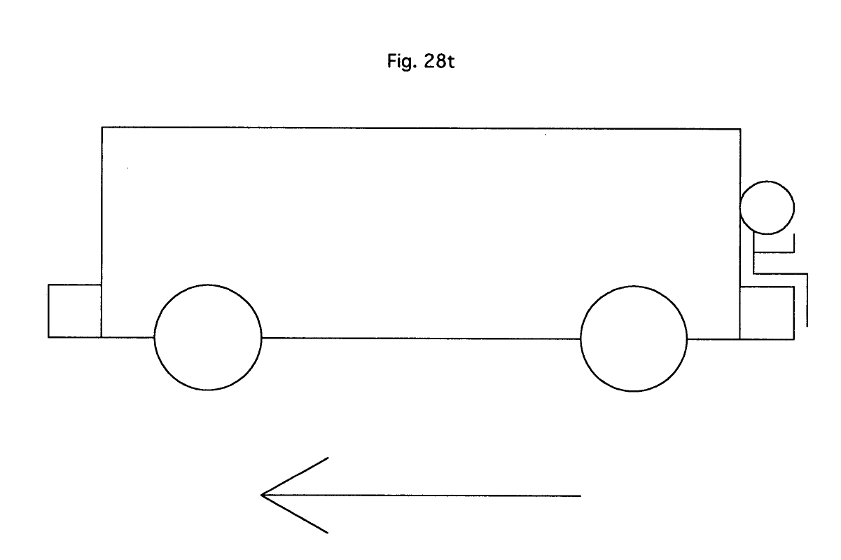

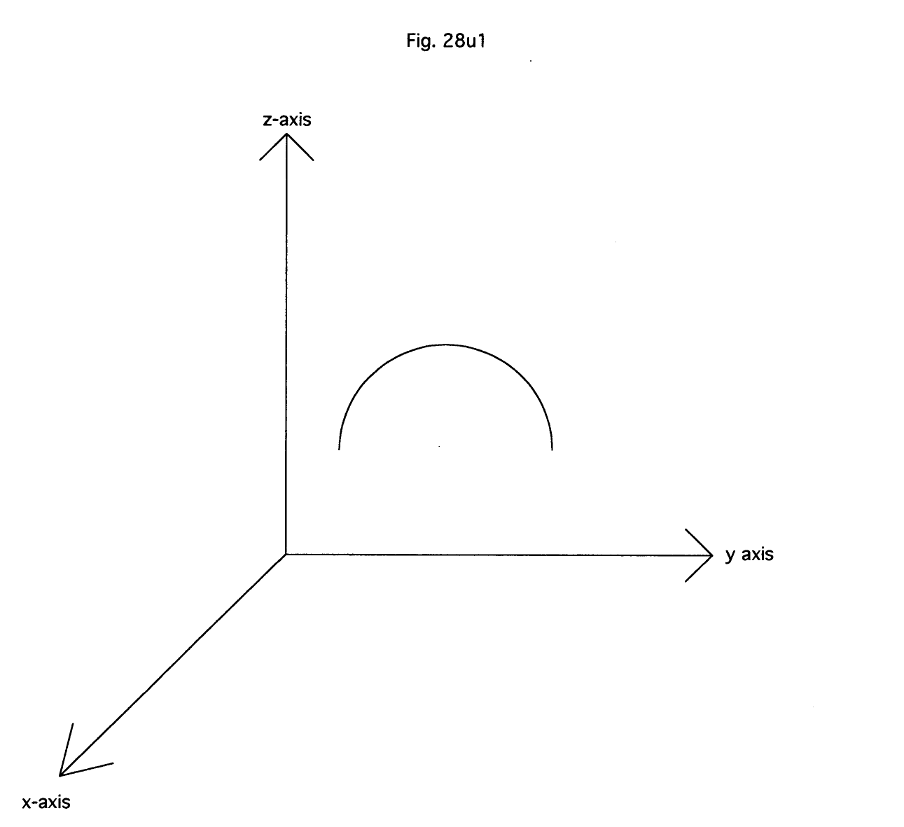

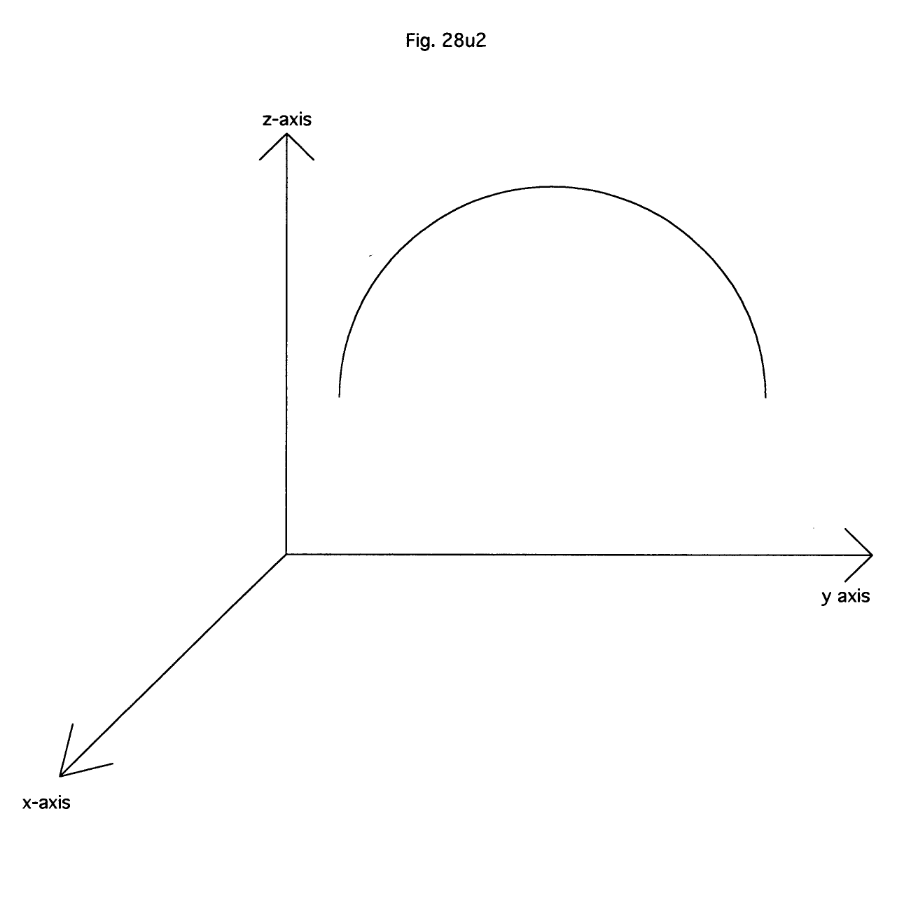

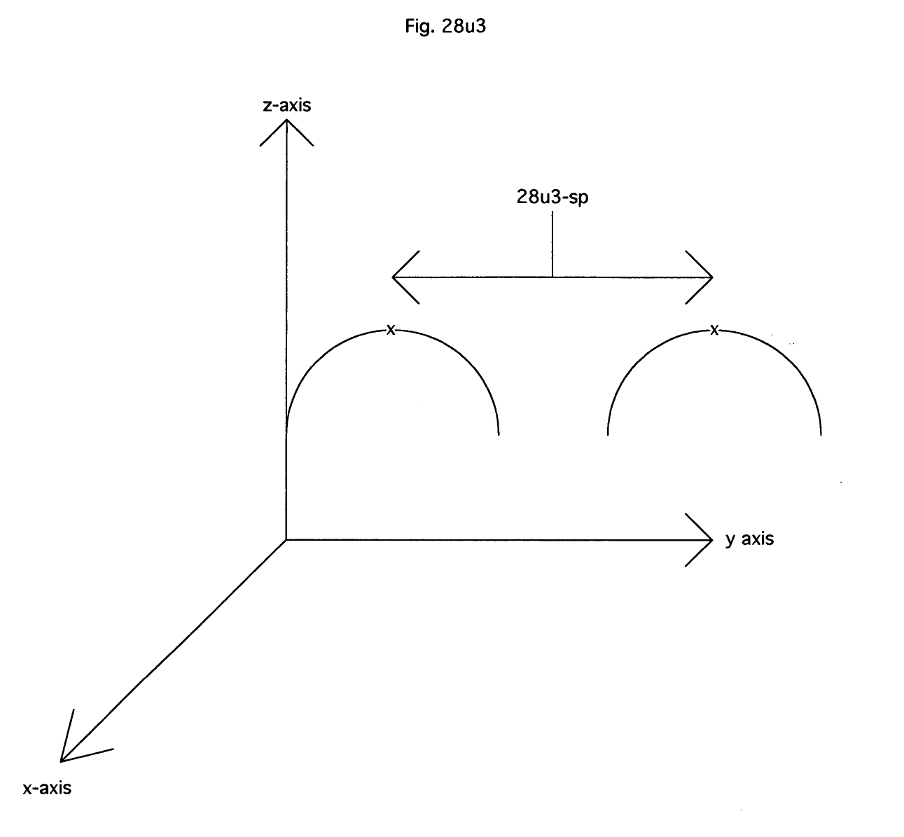

FIG. 28a

FIG. 28b

FIG. 28bb

FIG. 28c

FIG. 28da1, 28da2, 28da3

FIG. 28db1, 28db2, 28db3

FIG. 28e1, 28e2, 28e3

FIG. 28f1, 28f2, 28f3, 28f4

FIG. 28g

FIG. 28h1, 28h2

FIG. 281

FIG. 28j

FIG. 28k

FIG. 28L

FIG. 28m

FIG. 28n

FIG. 280

FIG. 28p

FIG. 28q

FIG. 28r

FIG. 28s

FIG. 28t

FIG. 28u1

FIG. 28u2

FIG. 28u3

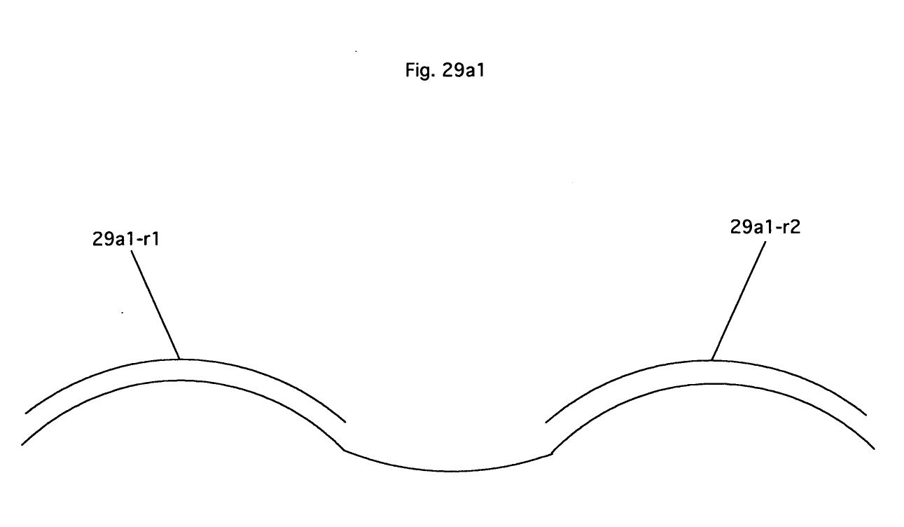

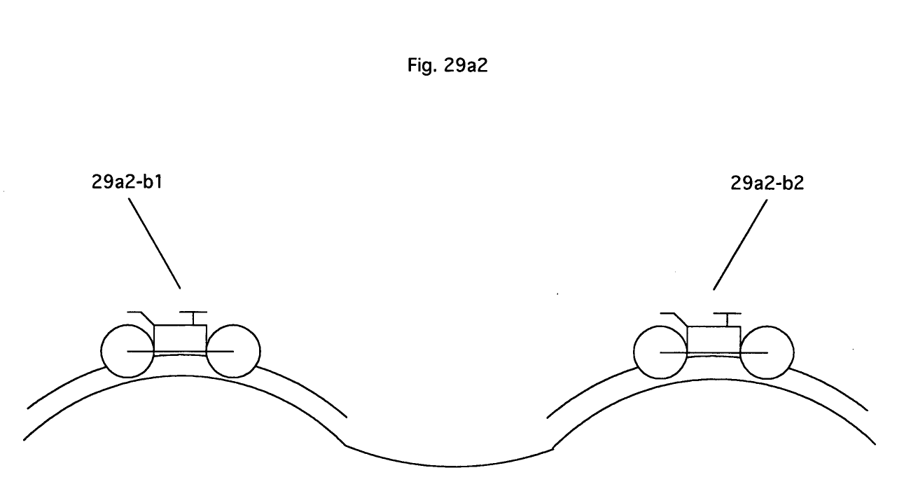

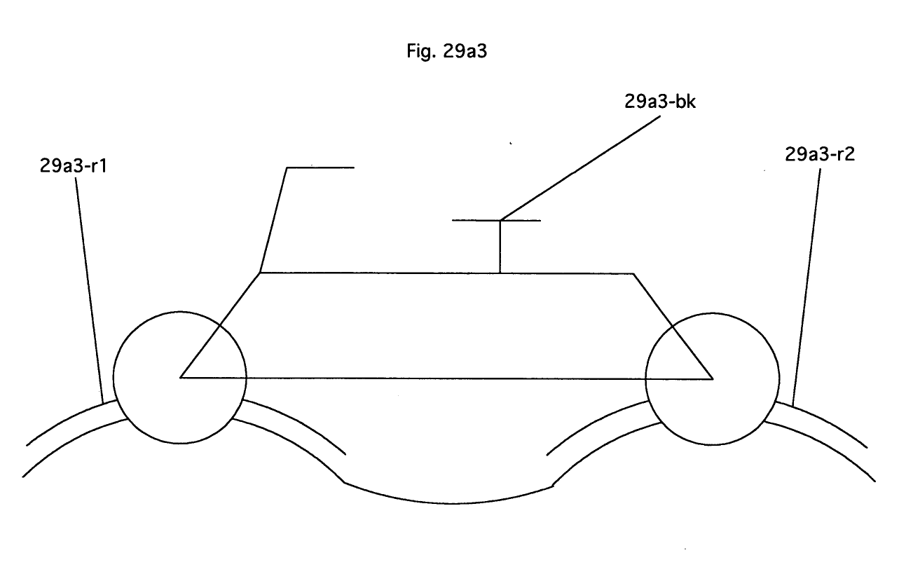

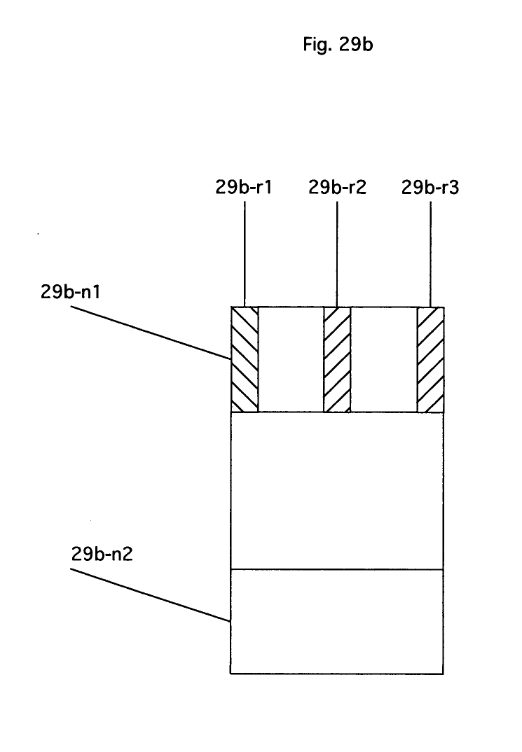

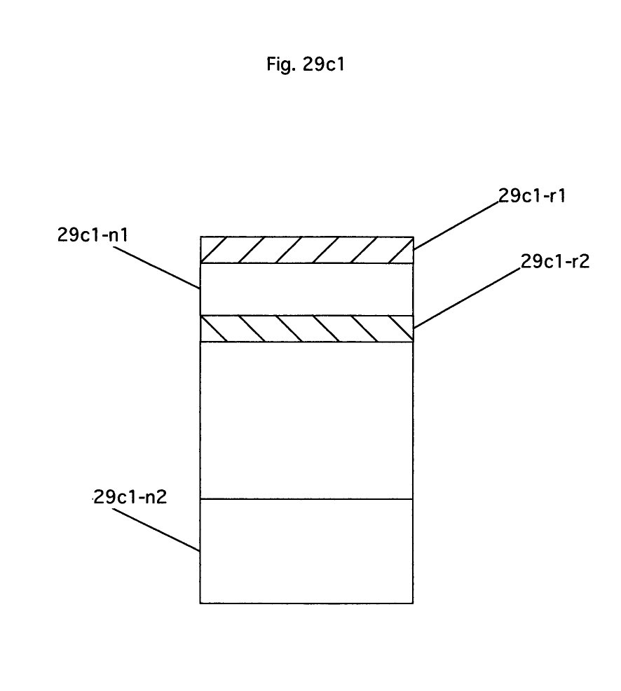

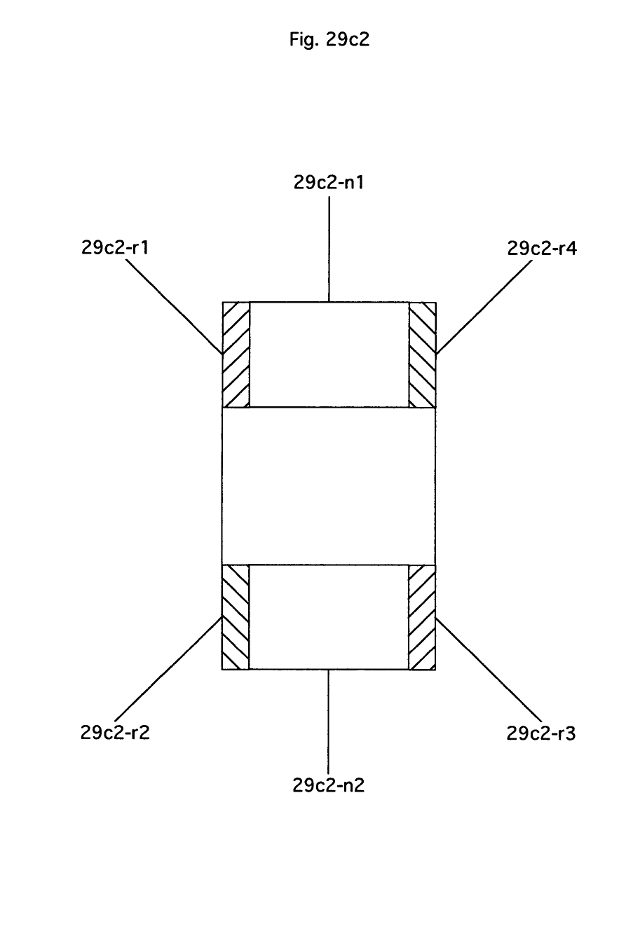

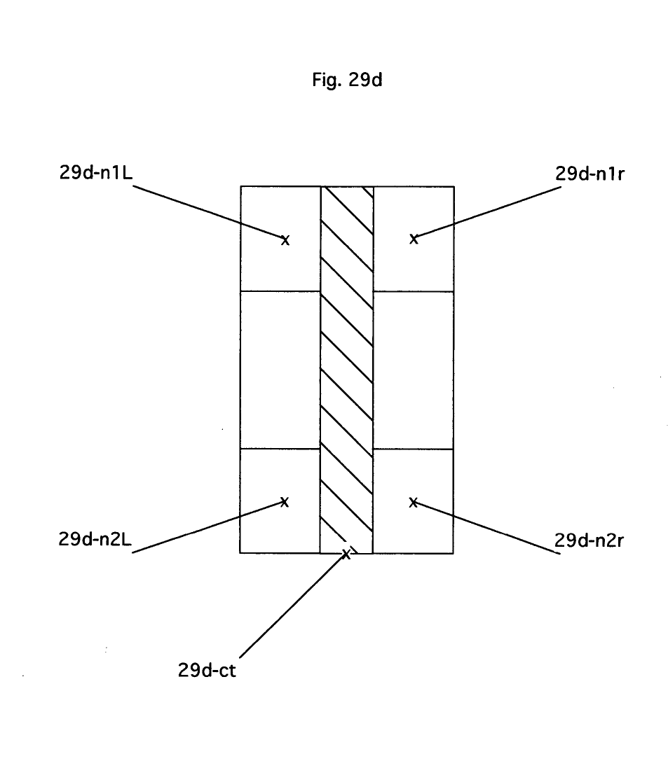

FIG. 29a1

FIG. 29a2

FIG. 29a3

FIG. 29b

FIG. 29c1

FIG. 29c2

FIG. 29d

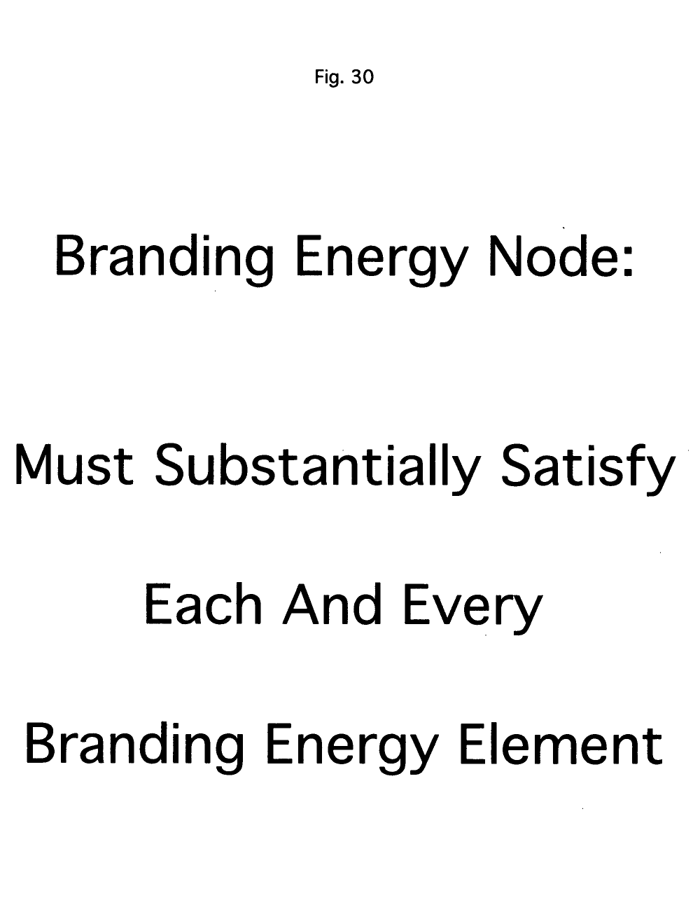

FIG. 30

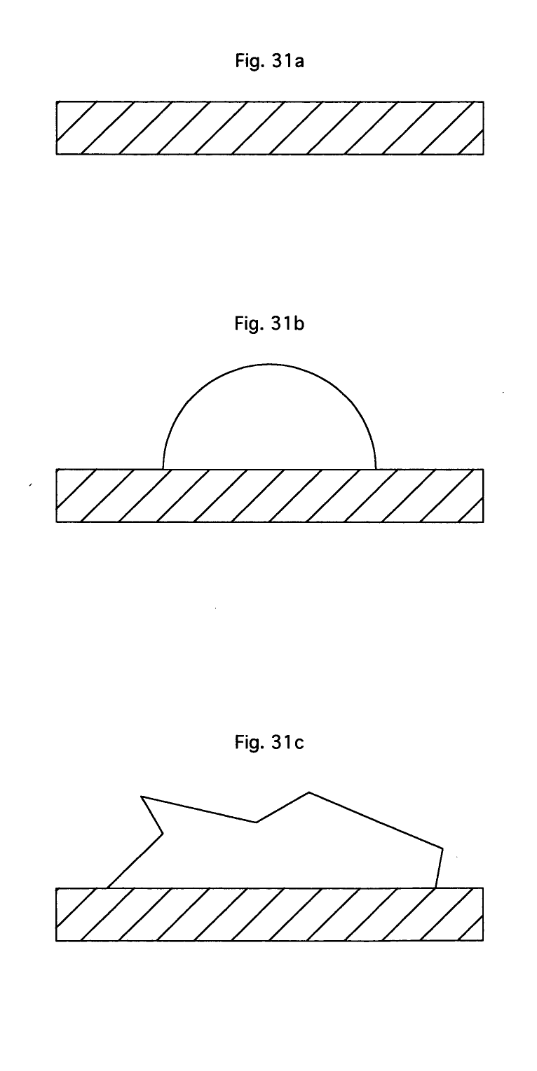

FIG. 31a, 31b, 31c

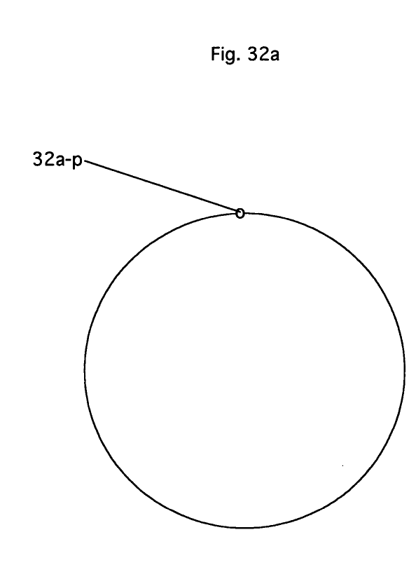

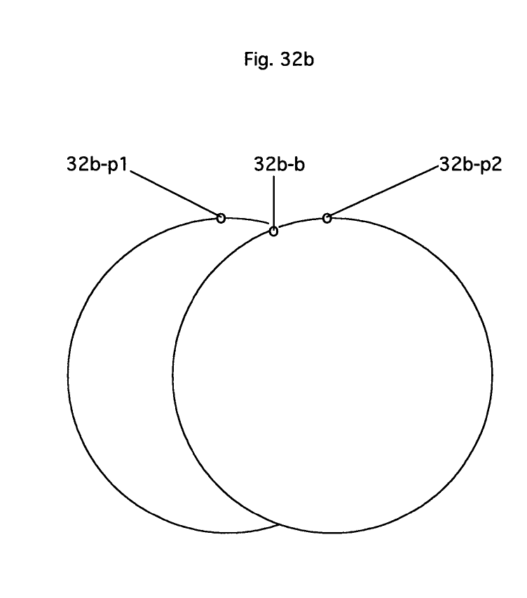

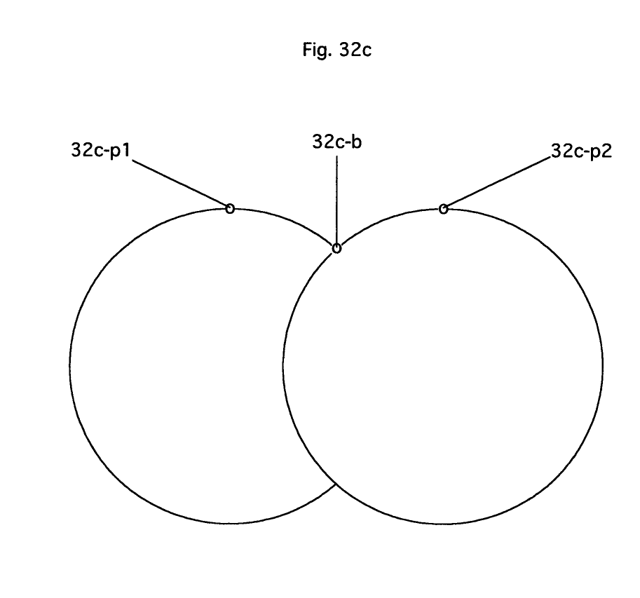

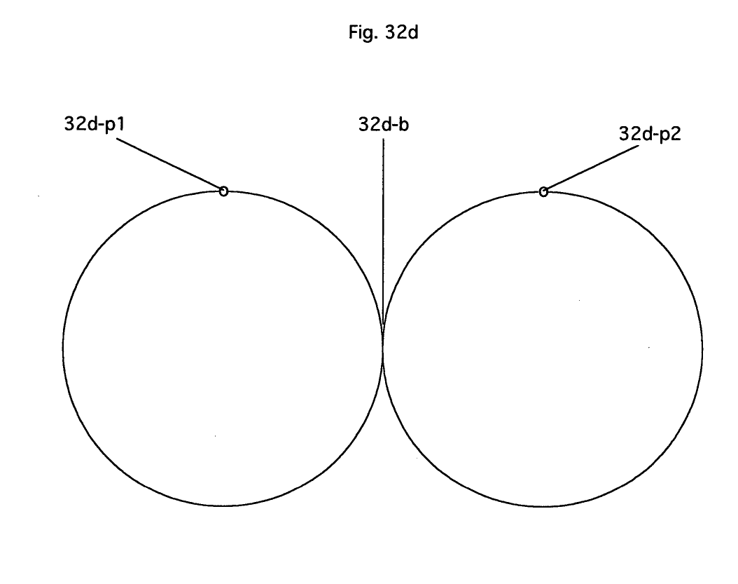

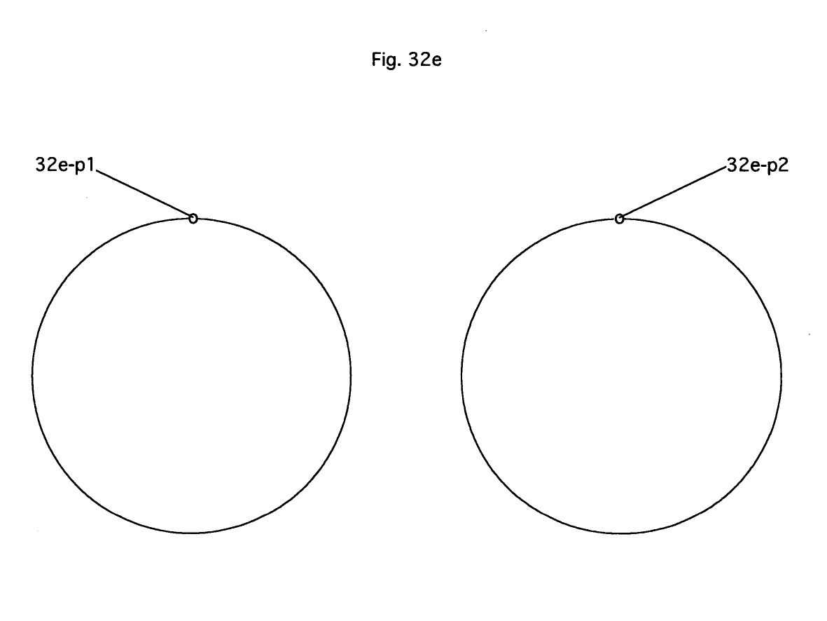

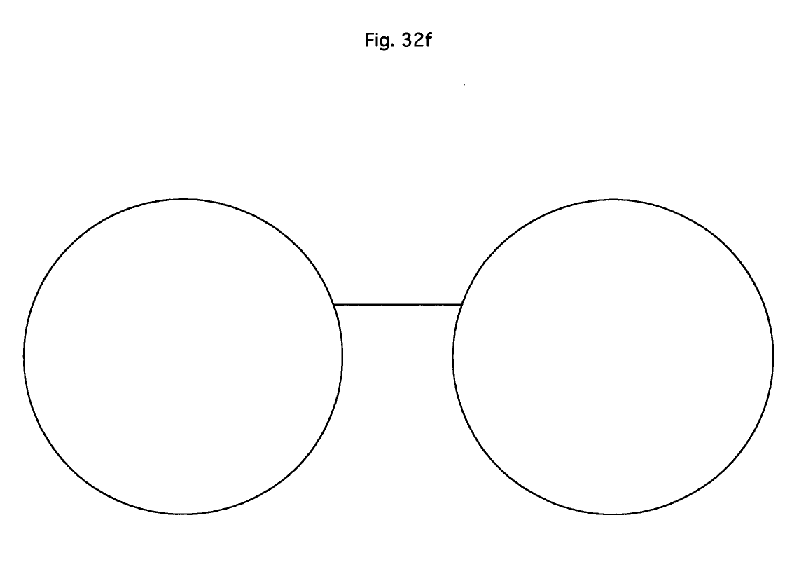

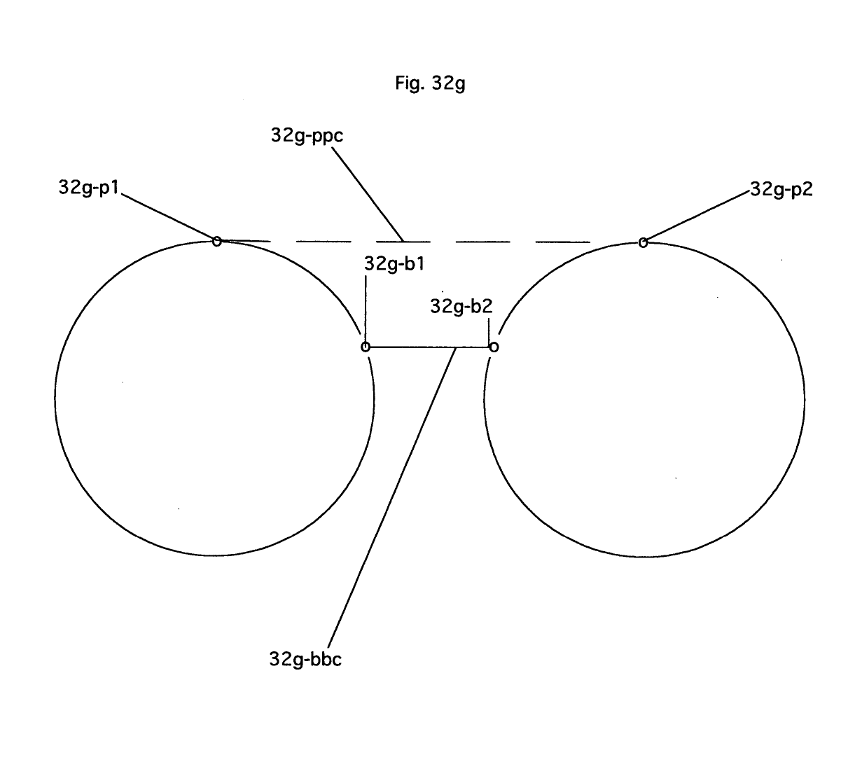

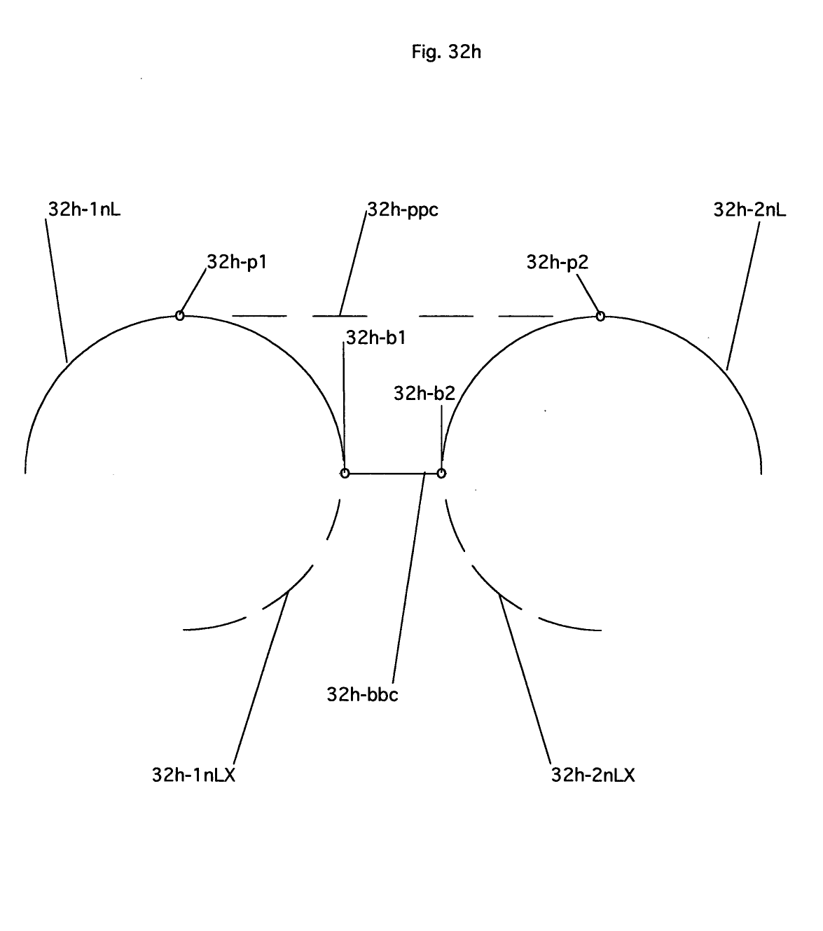

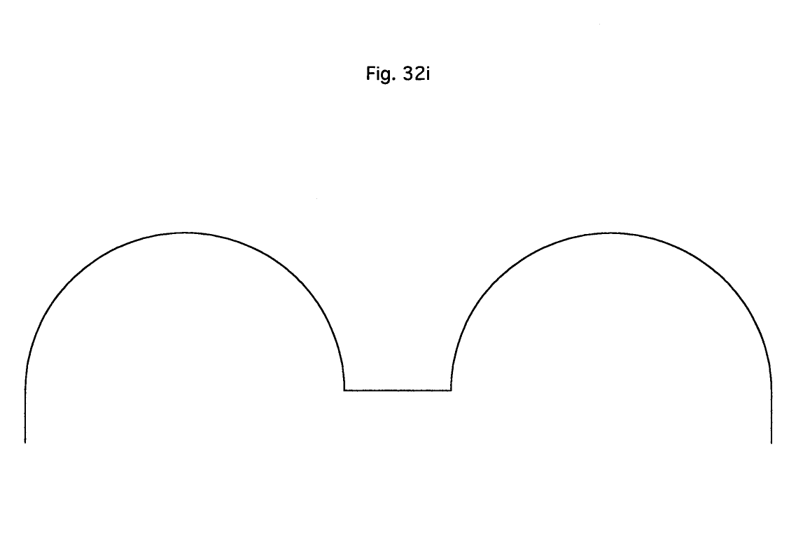

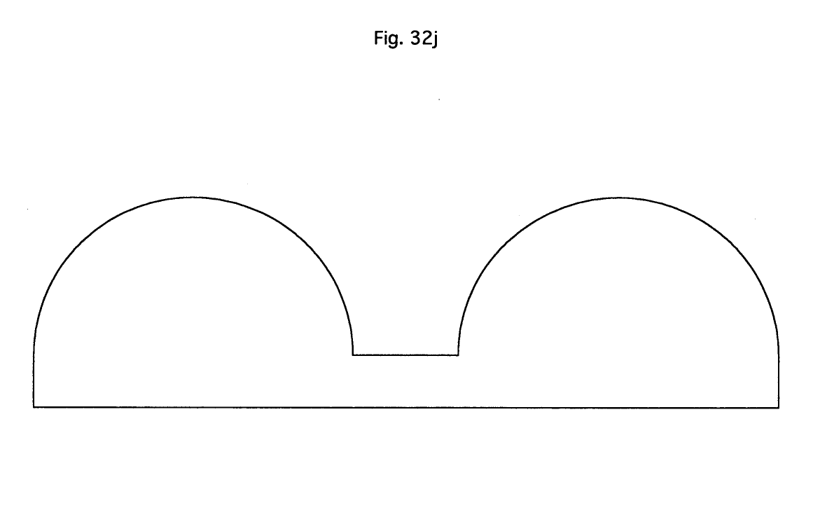

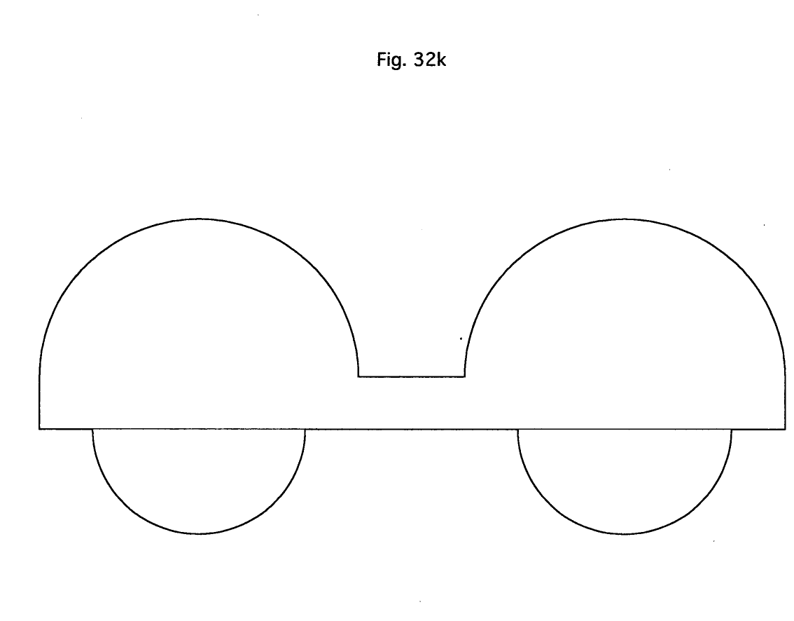

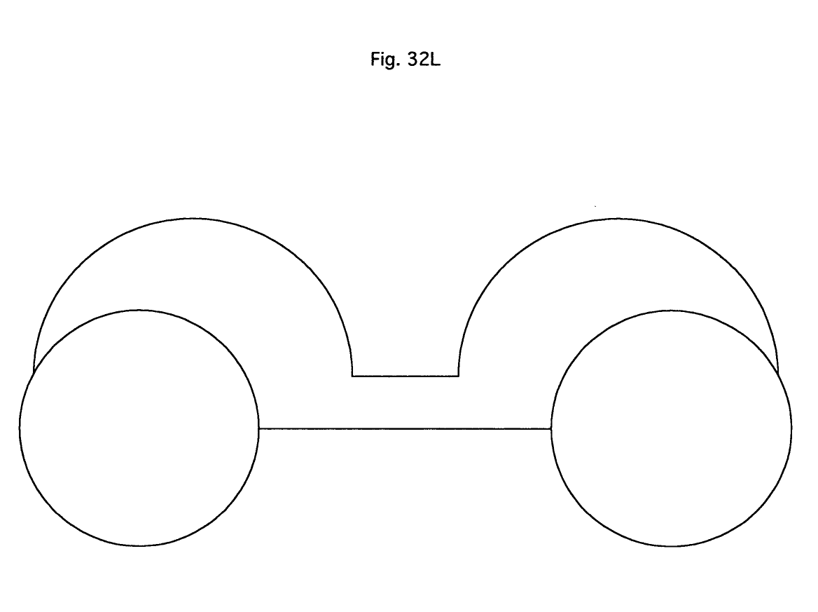

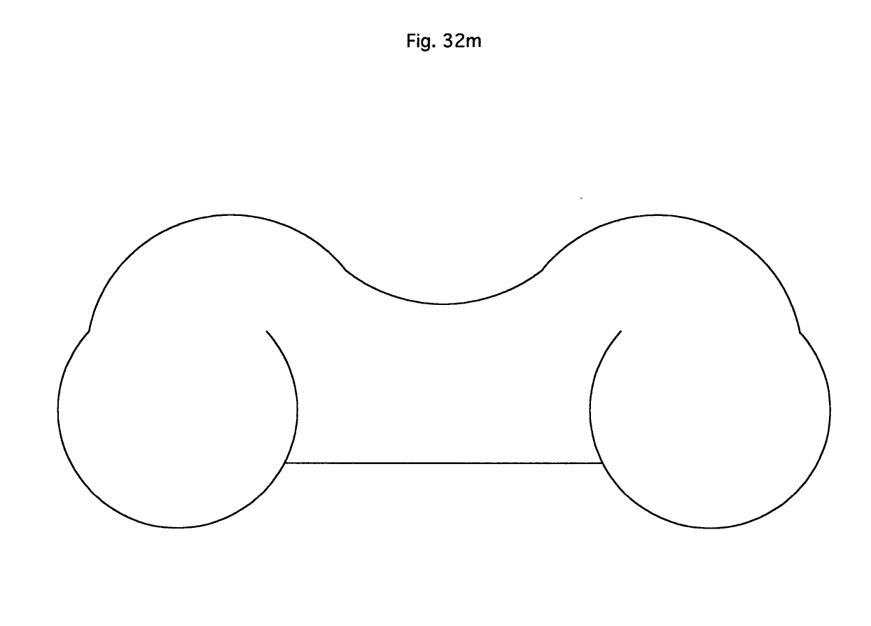

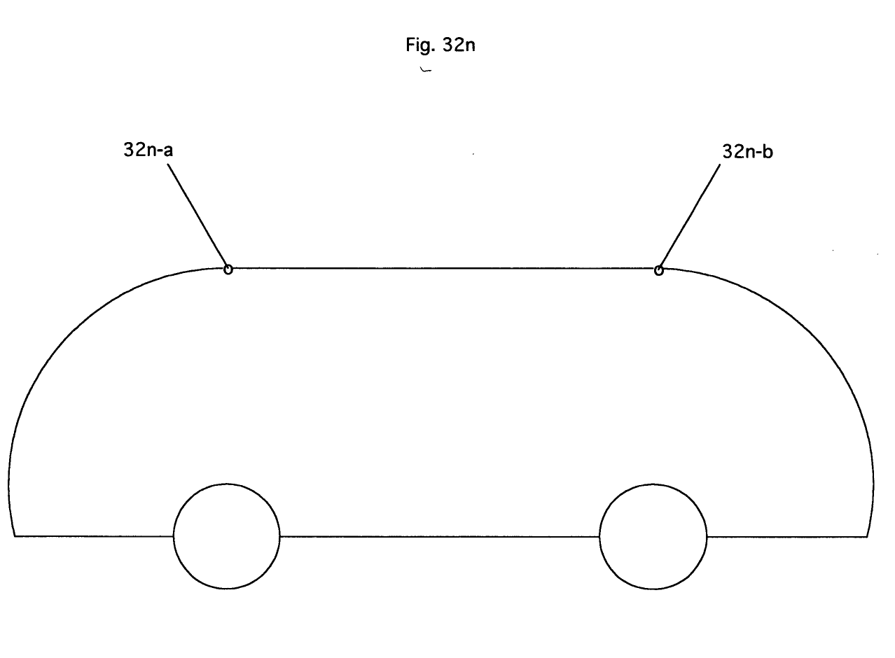

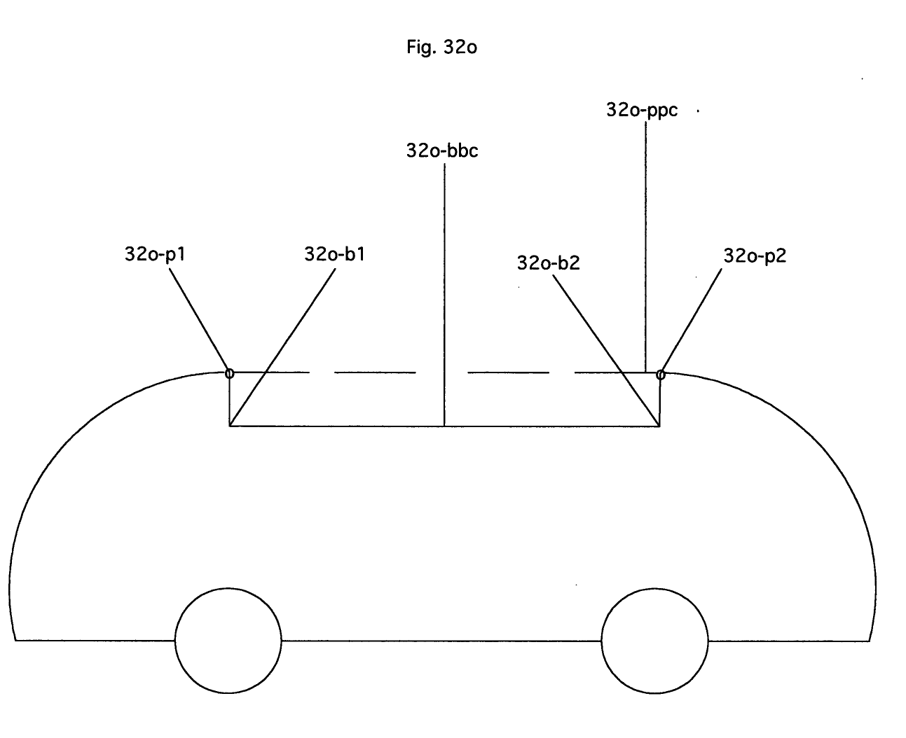

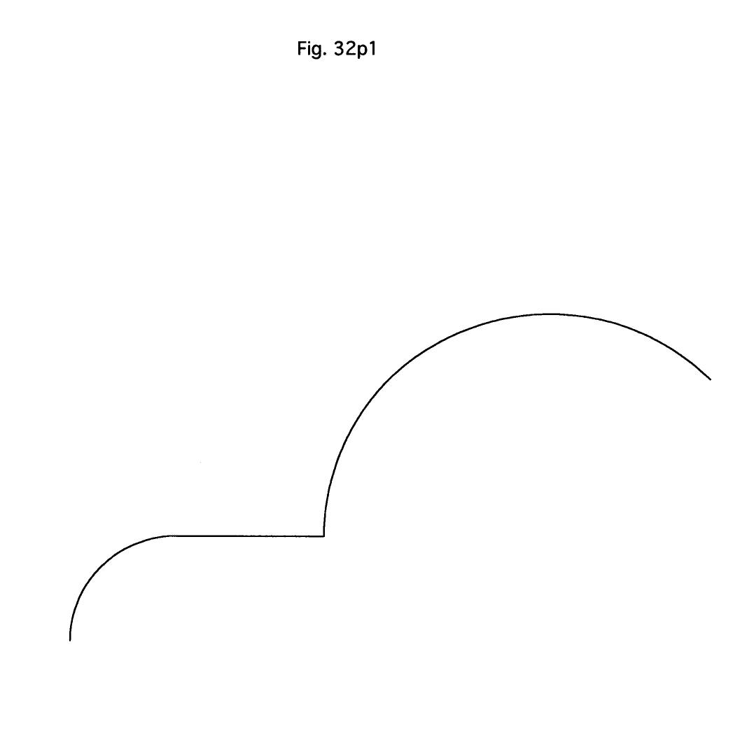

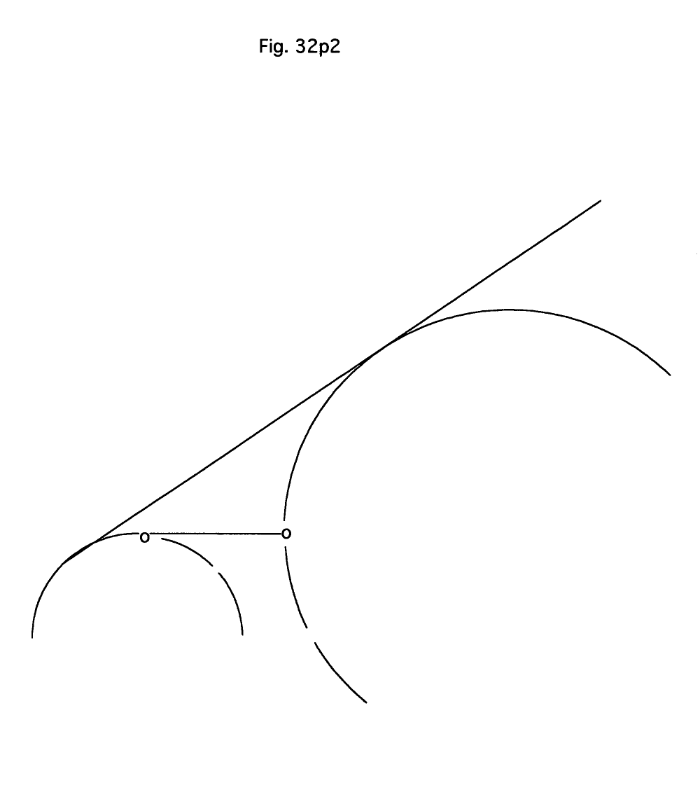

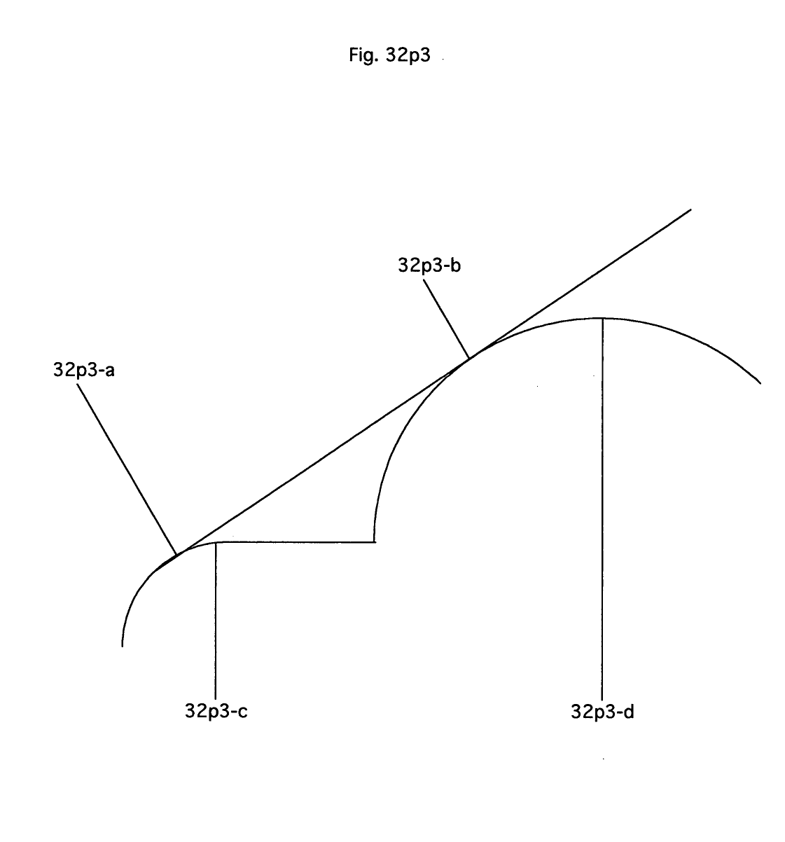

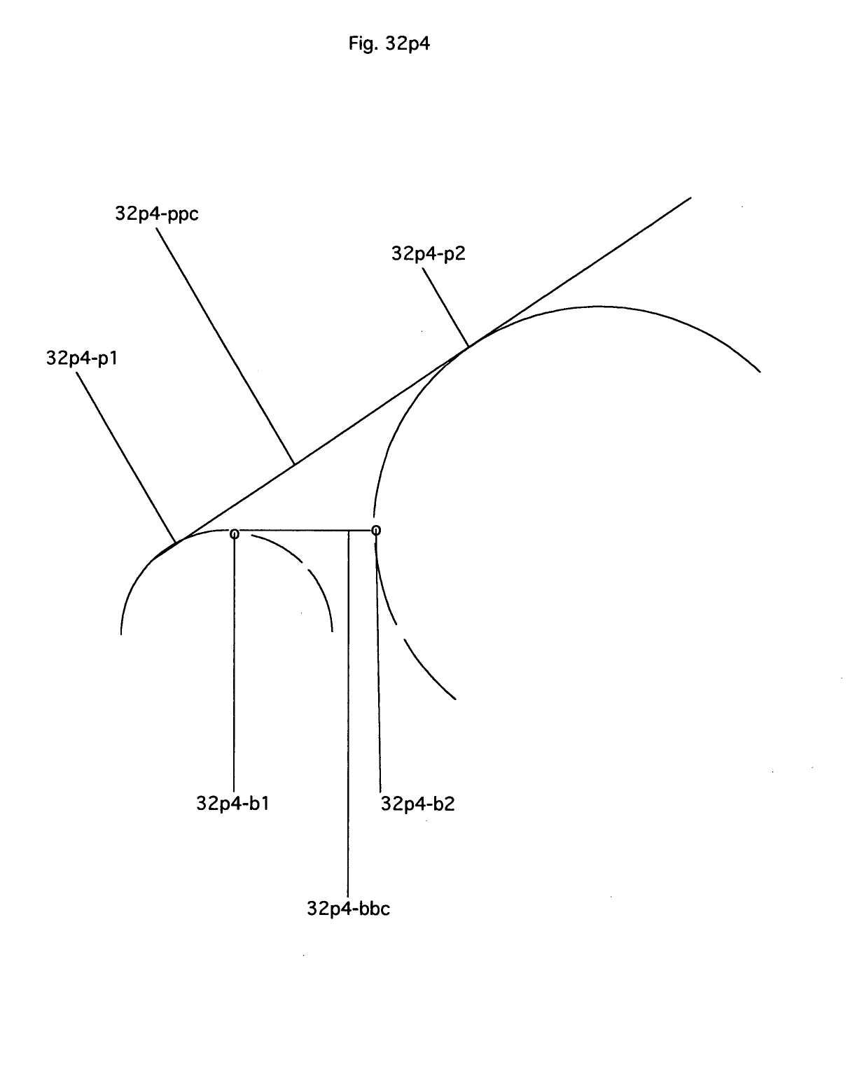

FIG. 32a

FIG. 32b

FIG. 32c

FIG. 32d

FIG. 32e

FIG. 32f

FIG. 32g

FIG. 32h

FIG. 32i

FIG. 32j

FIG. 32k

FIG. 32L

FIG. 32m

FIG. 32n

FIG. 320

FIG. 32p1

FIG. 32p2

FIG. 32p3

FIG. 32p4

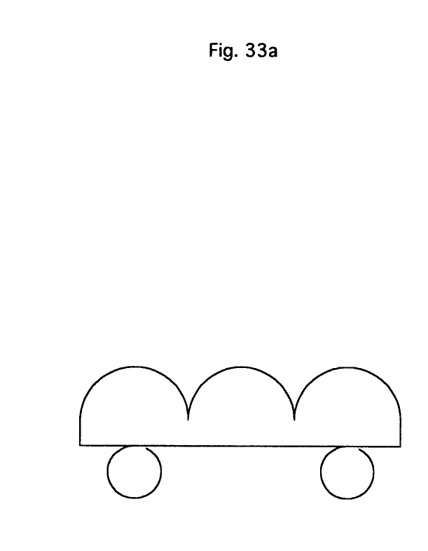

FIG. 33a

FIG. 33b

FIG. 33c

FIG. 33d

FIG. 33e

FIG. 33f

FIG. 33g

FIG. 33h

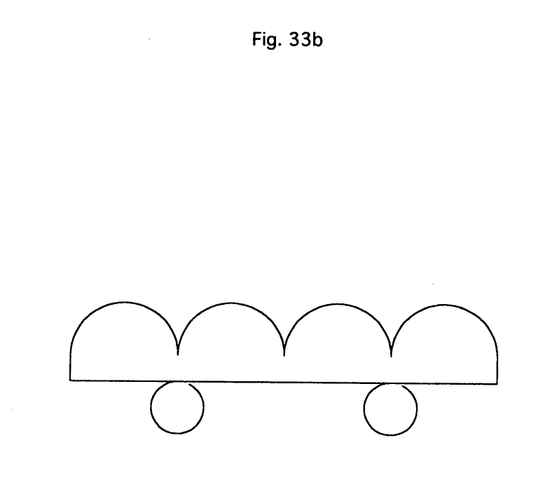

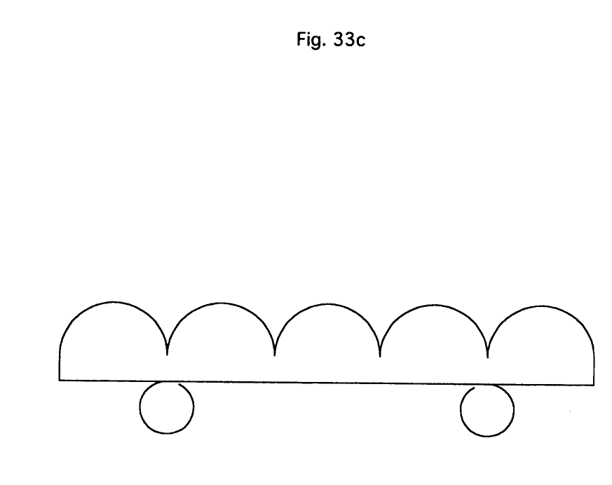

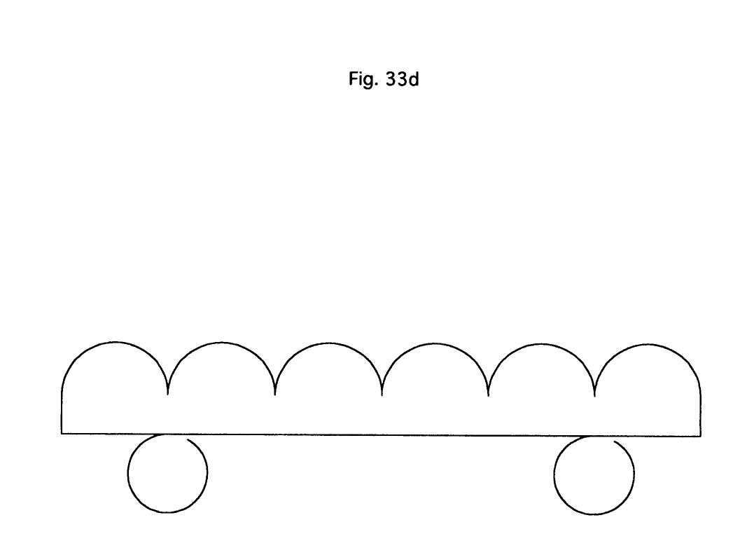

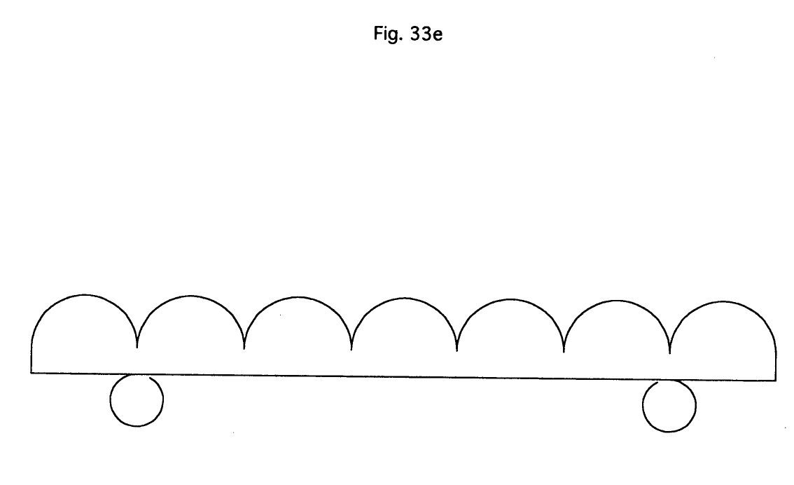

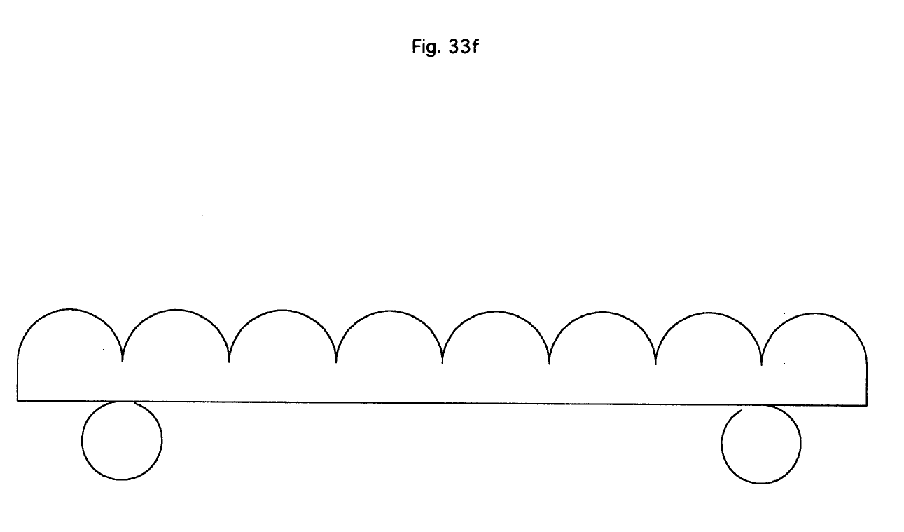

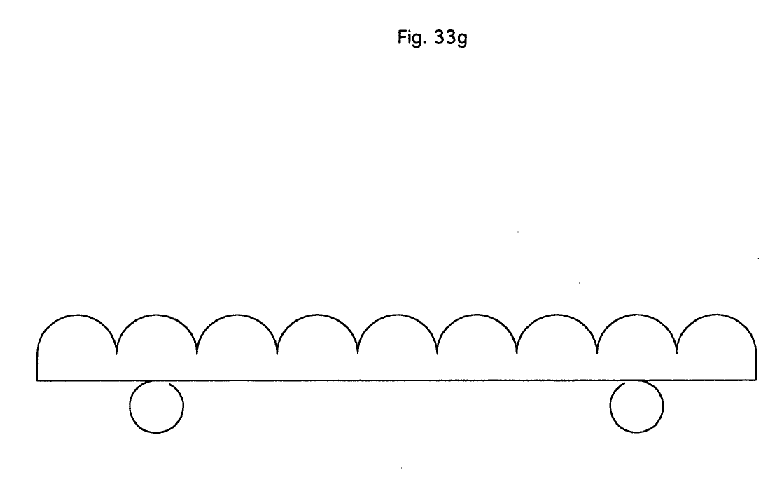

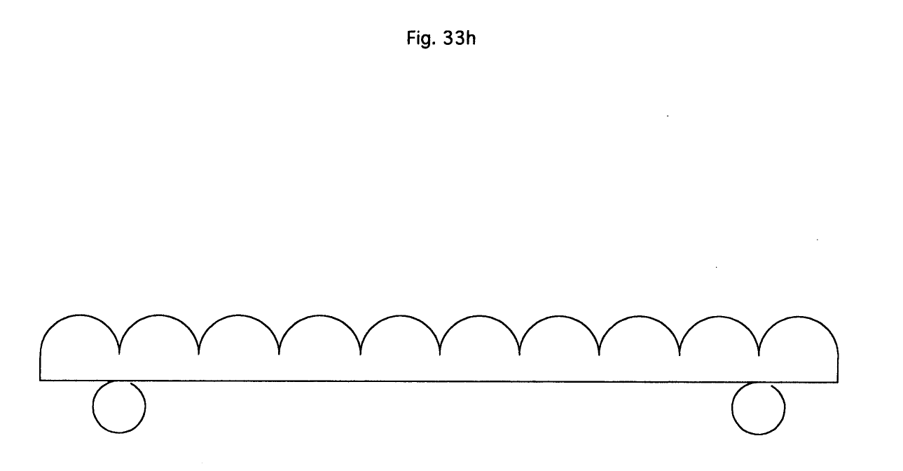

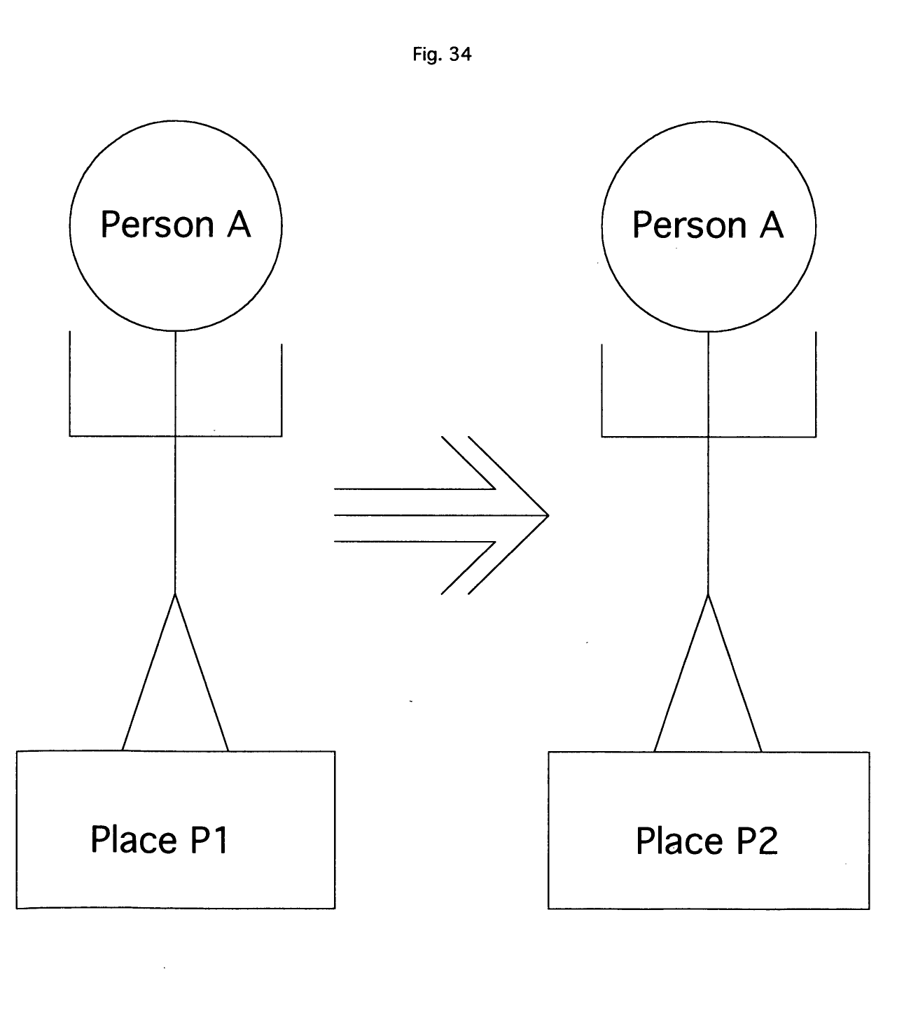

FIG. 34

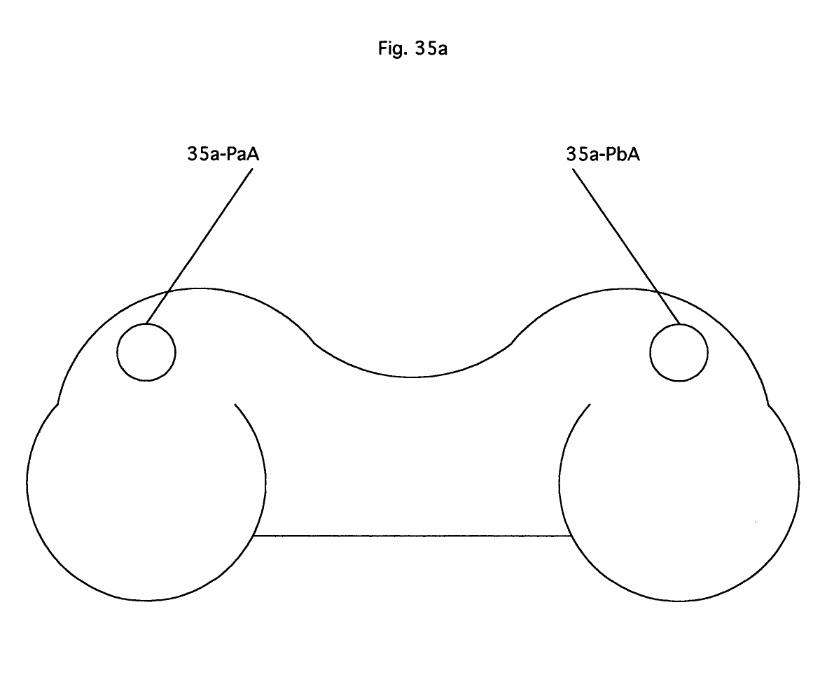

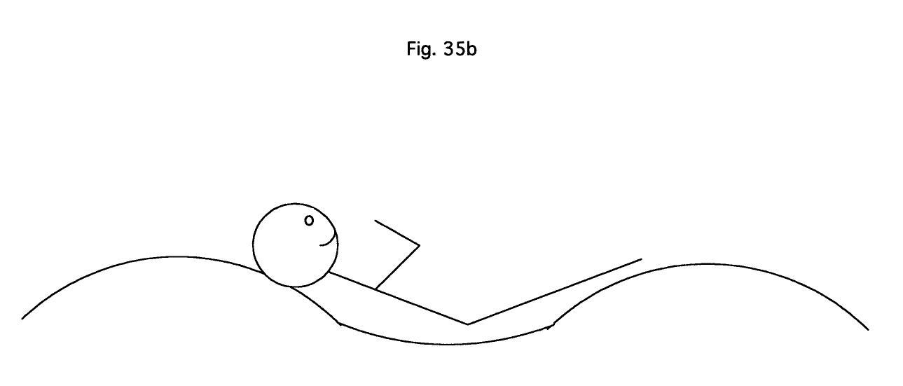

FIG. 35a

FIG. 35b

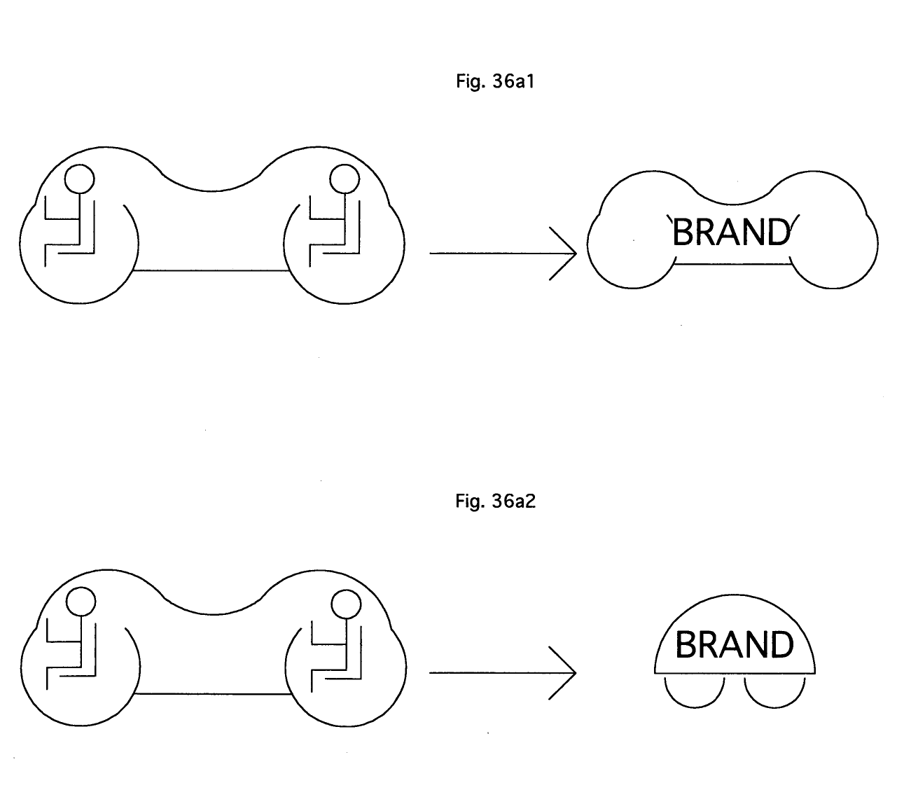

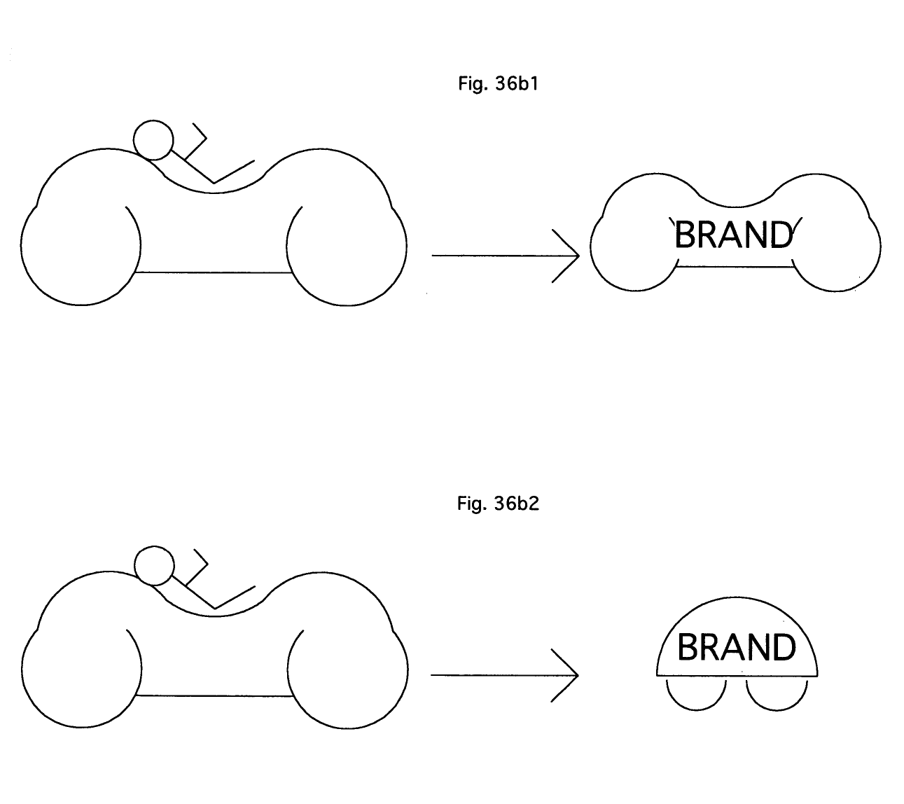

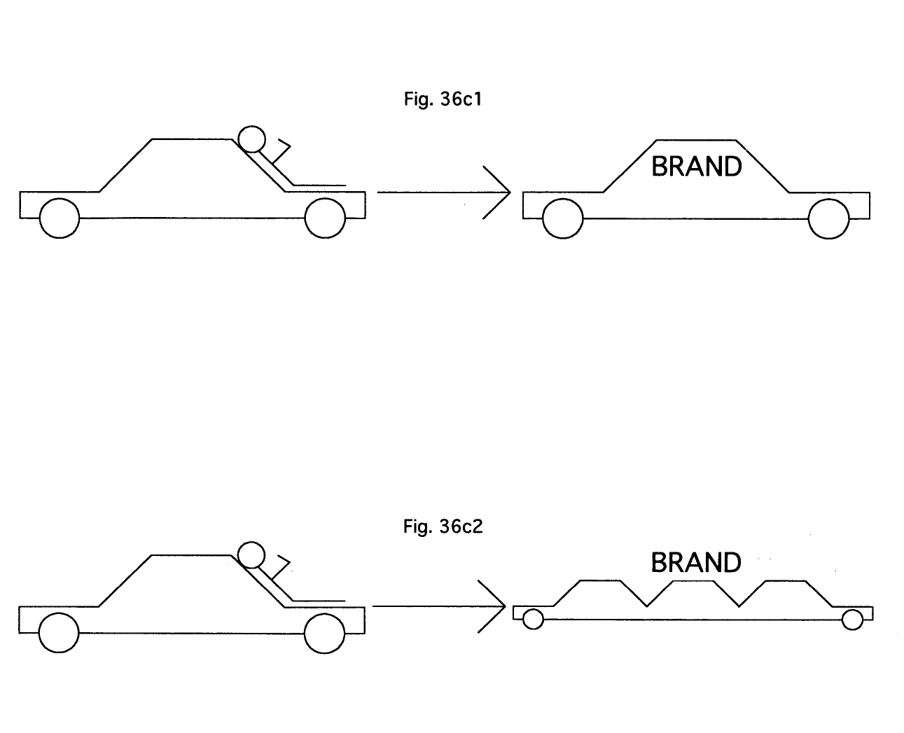

FIG. 36a1, 36a2

FIG. 36b1, 36b2

FIG. 36c1, 36c2

### SECTION FOUR: DUPLICATED CLAIMS

### Claim 401 Through-and-Including Claim 431

### SECTION FIVE: CLAIMS

### Claim 401 Through-and-Including Claim 431

### Pages Numbered Separately

### SECTION SIX: DRAWINGS

### Drawing FIG. 1 Through-and-Including Drawing FIG. 36c2

### Pages Numbered Separately

### PART ONE: BUSINESS

Application Data Sheet

0. This version (revision-4) is the most current version.

00. I hereby retain the core-kernel concept of the original invention submission:

Branding-Energy Amplification established upon the Principle of Node Plurality.
   1. I hereby cancel:
all prior claims; and
all prior specifications; and
and all prior drawings.

2. I hereby cancel all unused “place-holding” claim numbers:
claim 76 through-and-including claim 400.
   3. Please accept and add the following as new:
a. new claims: claim 401 through-and-including claim 431.
b. new specification: Page 1 through-and-including Page 279.
   (Page Count includes Duplicated claims, but not claims and not Drawings).
c. new drawings: FIG. 1 through-and-including FIG. 36c2.
   Prior Art

A. Due to the constraints of time, and to the highly focused nature of this invention, I feel that the search conducted, although brief, is substantially adequate.

B. I was not able to find any prior art that was cogently relevant to this invention.

C. Prior Art that was obliquely related is as follows:
1. U.S. Pat. No. 5,299,791
2. USD—410,428
3. USD—277,298
4. USCLASS/SUBCLASS—296/21: “Advertising & Display”
   Field Of Invention

This invention is related to the structure for bodies and tops of automobiles; especially as that structure relates to the amplification of brand, and ultimately to the amplification of brand sales volume.

Notice to the Examiner—The Volkswagen Corporation

1. A copy of my original submission (less prior art, less claims) was sent to the Chief Executive Officer of Volkswagen Corporation of America, soon after my original submission was sent to the USPTO.

2. Documentation of delivery-receipt, and delivery day-time is available upon request.

Notice to the Examiner—Duplicate Set of claims

A duplicate set of claims is included in this submission.

The first set of complete claims is hereby allocated for insertion in the Specification.

The second set of complete claims is hereby allocated for insertion in the claims.

Notice to the Examiner—Copyright

The totality of this work is in the process of application for copyright.

Notice to the Examiner—Scope of claims

The scope of this invention should be determined both by the appended claims, and by their legal equivalents, rather than by the examples given herein.

### PART TWO: TOPICS

### NOTE the subject matter within each topic is either directly, or indirectly, or both directly and indirectly

### additionally an embodiment and

### additionally an object and advantage and

### additionally a reason for utility patent status

### Topic 0: This is not a Design Patent

1. This is not a Design Patent.

2. This is not a set of Design Patents; with a Design Patent for each Embodiment.

3. This is a Utility Patent. Some of the reasons for this are presented below.

### Topic 1: The Beetle as Icon

### Drawing Figures and Drawing Descriptions FIG. 1

Everyone in the world is likely to be familiar with the Volkswagen Beetle; the beetle is arguably the most successful shape in automotive history.

Although the beetle is not completely unique with respect to curvature, it is certain that no other automobile is
as distinctive (the beetle has its own slang: “the bug”);
as enduring (the bug has been in profitable service for decades);
as endearing (the bug has been the star and leading man in many movies).

Thus the universally known roundedly rotund and shapely beetle is universally beloved.

Perhaps beetle globular rotundity mirrors the measurelessness of the circle in the way that Beethoven's Ode to Joy echoes the immortality of the circle; or the way that pi mathematically numbers circular numberlessness.

It is also quite conceivable that, in the minds of many, beetle orbular sphericity reproduces the incomparable curvaceous purity of a pregnant woman.

Or it may be, that memories of the 1960s, are coiled up, and tightly wound within the circular icon that defined an era;
that defined an era that was Birkenstock;
that defined an era that was Woodstock;
that defined an era that was.

### Topic 2: The Limousine as Standard Bearer of Brand

### Drawing Figures and Drawing Descriptions FIG. 2

Concept limos, in nontraditional shapes, have been produced by recreating popular flagship models in the limousine format;
both the Dodge-Ram limo and the Hummer limo are daring implementations;
making unmistakably bold statements;
and having body-lines which seem to extend toward infinity and beyond.

The Hummer limo is almost
the land-based version of a nuclear-powered aircraft-carrier;
complete with
impossibly-accurate laser-guided weapons;
thundering 8000-millimeter canons;
mach-10 Navy fighter-jets;
brilliant-banners beaming;
rockets red-glare gleaming;
.JOHN.PHILLIP.SOUZA.
salutes nautically-exploding from fresh-pressed dress-whites;
a
n
d
RED AND WHITE AND OLD-GLORY-BLUE snapping smartly in the salted spray.
   hummmmmmm.
   hummmmmmme.
   hummmmmmmer

People should almost be required to wear a flak-jacket while Just standing next to a Hummer limo.
B-l-G-G-E-R T-H-A-N B-l-G.
LARGER
   THAN
      LIFE.
THIS Is the limo by Hummer!
Extending the Length.
Extrapolating the Concept.
Breaching the Boundaries.
Breaking the Bonds.
Transcending the Barriers.
Acquiring the Aura.
Amplifying the Energy.
Building the Brand.
Making the Money.

### Topic 3: The Limousine as Money Machine

### Drawing Figures and Drawing Descriptions FIG. 3

There is money to be made both by manufacturing and selling limousines; and by selling limousine riding-time.

There are at least 411 cities on earth with a population of more than 1 million people. The likelihood is that each of these cities could accommodate at least 1 bug-limo.

Limousines sell for hundreds of thousands of dollars . . . manufacturing them can certainly be profitable.

Also, in modern society, there exist numerously more special events, luxury functions, and black-tie affairs than existed in times past:
each luxury event represents yet another potential sale of chauffeured-limousine riding-time.

Finally, many people have bonded with the shape of the Volkswagen beetle;
or identify strongly with the iconoclastic, counter-cultural heritage of the bug;
for these people, renting a c-o-n-v-e-n-t-i-o-n-a-l flat-topped limo would simply be out of the question.

While, conversely, arriving at their soiree in curvaceously curvaturistic, multi-humped, semi-circular, s-t-y-----------l-e, would be the very heart and soul of wit and fun. Thus, the limousine market is a crucially-pivotal market;
principally because of the potential for branding-energy amplification;
but also because of both direct limousine sales, and indirect limousine ride-time sales.

The physical extrapolation from the regular-sized flagship-model to the longer limousine format,

produces an emotional extrapolation whose intangible and incalculable affect is far greater than the mere length which is added.

The hummer limousine above is a splendid example of this.

Although, the plural-hump concept may be more appropriate for Beetle Brand Limousines, the attention-attracting Plural Roof-Node Concept may be appropriated
for any conceivable Limousine brand;
for any conceivable brand shape-contour;
for any conceivable plural-quantify of roof-top-nodes.

### Topic 4: Flat-Roof Syndrome

### Drawing Figures and Drawing Descriptions FIG. 4

In times past, there were “flat-earthers”:
people who thought that all the world was flat;
they did not realize that the world is round.

In times present, there are “flat-roofers”:
people who think that all roofs are flat;
they do not realize that roofs should be round.

The world is round;
and the people who live on the earth are round;
Very little of what we would call the natural kingdom is comprised of angularity or linearity;
Very much of what we see here on earth is comprised of curvature;
This is a good thing.

To date, because of the failure to creatively think ‘outside of the box’,
“flat-roof-syndrome” has created a nearly impenetrable flat-roof ‘glass-ceiling’;
effectively barring rounded-roof vehicles from being extrapolated, extended, and recreated in the limousine format.

To date, traditional limos are all produced with flat roofs.

### Topic 5: Attracting Attention Attractively

### Drawing Figures and Drawing Descriptions FIG. 5

Multiplied Humps. Multiplied Remembrance. Multiplied Brand.

A multi-humped beetle limousine has the potential to exponentially increase brand-awareness in a highly positive way:
If you were to see a singular Marilyn Monroe walking down the street, you probably would notice.
If, however, you were to see 88 Identical Marilyn Monroes's singlefiling fashionably in parade-dress parade, you would likely stop;
   whatever you were doing;
   and stare;
   in exasperated amazement;
Wondering all the while what in the world was going on.

In the same way,
a bug limousine with 88-humps would most surely capture and retain your attention;
any focus-group surveyed 88-years later would very likely remember the 88-humped limousine in a very fond and very positive way.

### Topic 6: DNA & Natural Law

### Drawing Figures and Drawing Descriptions FIG. 6

A camel with one camel hump is a member of the species “Camelus dromedarius”;

A camel with two camel humps is a member of the species “Camelus bactrianus”.

The DNA of C. dromedarius is unique relative to the DNA of C. bactrianus.

The DNA of C. bactrianus is unique relative to the DNA of C. dromedarius.

The DNA of any is distinctly discretely definably different than the DNA of any other.

The differences in DNA produce differences in appearance (one lump or two).

Also, the differences in DNA produce differences in function:
It is far easier to adapt a two-humped camel, than a one-humped camel, to be ridden by a human being.

By extension then,
a Volkswagen beetle limousine with 88 humps, does not look the same, does not function the same, and is, in fact, not the same, as a Volkswagen beetle with 1 hump;
Because they do not share identical Automotive DNA.

### Topic 7: Proposal & Discovery of New Automotive Species

### Drawing Figures and Drawing Descriptions FIG. 7

As a way to amplify the branding energy of the singular Volkswagen Beetle (Buggus singularitus),

I propose an entirely new species:
the plurally humped Volkswagen Beetle: Buggus infinitus.

Eventually within this work,
The concept of curved beetle plurality above, will be extended and generalized, to encompass and include plurality of any arbitrary shape: Arbitraricus infinitus;

For now,
The focus will be exclusively on plurality as it pertains to the Volkswagen Beetle.

By adding additional humps to the curved concept embodied in the Volkswagen Beetle, several important advantages will be obtained.

By far, the most important of these advantages is
the potential to attract attention attractively;
the potential to exponentially increase brand awareness in a highly positive way;
the potential to exponentially amplify the energy of brand.

Increasing advantages accrue with increasing humps:
A limousine with 8 humps would be extremely distinctive;
and could be extremely valuable
in the extremely lucrative extreme-limousine marketplace.

A sports utility vehicle with both enormous forward and humongous rearward steroid-saturated humps, would attract attention like no other suv in the highly competitive, and highly profitable sport utility vehicle marketplace.

Both Beetle spinoffs could optionally make extensive use of existing tooling, and existing parts, like sunroofs and sunroof parts like gaskets; and windows and window parts like frames and gaskets etc.

Later, more advantages will be discussed; however, the key advantage that plurality provides is BRANDING-ENERGY-AMPLIFICATION.

### Topic 8: Genesis: Biological Cell Division

### Drawing Figures and Drawing Descriptions FIG. 8a-FIG. 8m Claim 2

### See Also Drawing Figures and Drawing Descriptions FIG. 32a-32p4

In the second claim, the following language is used:
“a first beetlelike curve obtained biologically by the biological automotive cellular division of the basic concept of beetlelike curvature as uniquely expressed in the Volkswagen beetle . . . .”

Biological Cell Division is the core concept of the biology of life;

Automotive Cell Division is therefore,
a uniquely powerful and potent paradigm within which to coalesce the core concept of this Invention: Plurality (and to a much lesser extent, curvature).

The concept of Automotive Cell Division very accurately describes the conceptual-intuitive genesis of this invention.

Later, in the section (Topic 32) marked Node Independence, in the “Doctrines” section, the concept of Automotive Cell Division will be used to precisely quantify the independent status of an independent node.

Discrete steps in the process of Automotive Biological Cell Division are as follows:
Initial Independence
Conception
Differentiation (Cell Division)
Completing Differentiation
Completed Differentiation
Integration
Completing Integration
Completed Integration

### Topic 9: The Rolling Automotive Billboard & Times Square Plurality & Branding Energy The Role of the Attraction of Attention

### Drawing Figures and Drawing Descriptions FIG. 9a1-FIG. 9d4 claim 7

Portions of claim number 7 read as follows: “ . . . create, in affect,
a rolling automotive billboard
   for attracting attention; and
   for amplifying the energy of brand; . . .
encreasing the net number of nodes per unit automotive length; and thereby enhancing the node resolution;
   the node resolution measured in nodes per unit automotive length;
   much like a television set; and a times square display board;
      both of which are rated in nodes per unit length;
   so as to effectively create, in affect, the rolling automotive billboard;
enlarging the physical sizing of each node;
   so as to effectively create, in affect, the rolling automotive billboard; and thereby enhancing the visibility of the rolling automotive billboard; and thereby entensifying the visual impact of the rolling automotive billboard; and thereby entensifying the emotive and cognitive impact of the rolling automotive billboard on the human brain; very much like the dazzling display boards at times square; . . .
whereby, the plurally noded rolling automotive billboard implicitly and continuously functions as an amplifier of the energy of brand;
and whereby, the amplifier of the energy of brand implicitly and continuously functions as the rolling automotive billboard.”

This is only part,
but nevertheless an extremely important part, of what it means to amplify the energy of brand;

By integrally enforming huge, multiple hump-like roof-projections upon the roof of an automobile,
attention will invariably be attracted;
remembrance will invariably be attained;
Branding Energy will invariably be amplified.

Optionally also,
lighting may be arranged along the node surfaces in order to further attract attention.

Attracting Attention and Evoking Memory are the Primary Tools employed in the Art and Science of the Discipline of Advertising.
Multiplied Nodes.
Multiplied Visibility.
Multiplied Recognizability.
Multiplied Remembrance.
Multiplied Brand.
Multiplied Sales.
Multiplied Brand.
Multiplied Profits.
Multiplied Brand.

### Topic 10: Money Multiplication & Branding Energy the Role of Echoed Shape and Evoked Memory

### Drawing Figures and Drawing Descriptions FIG. 10 Claim 8

Portions of claim number 8 read as follows:
“expressing . . . an architectural shape which is architecturally associated architecturally with a branded shape of a shaped brand;
enmirroring architecturally the shaped architectural resemblance of the branded shape; and
echoing the memory of the branded shape; . . . and
evoking the memory of the shaped brand; . . . and
enhancing the visibility . . . by enpluralizing the total number of nodes enformed; and
encreasing the recognizability . . . by appropriately enscaling the physical sizing of the nodes enformed; and
encatalyzing . . . via the enmirrored architectural resemblance; and
   via the echoed memory; . . . and
   via the evoked memory; . . . and
   via the enhanced visibility; and
   via the encreased recognizability; the amplification of the sales of any of the species of the genus of the shaped brand, including the very vehicle itself;
enchanneling the amplified profits, from the encatalyzed sales, to any company owning . . . any of the branding rights, to any of the species of the genus of the shaped brand, including the very vehicle itself.”

Making money is the primary purpose of this patent; all other objectives are subservient to this one.

In the preceding topic,
making money was accomplished by attracting attention to the branding energy amplifier itself;

In the present topic,
making money is accomplished both by attracting attention to the branding energy vehicle amplifier itself, (the Branding Energy Amplifier vehicle itself comprises a brand),
and by echoing the physical resemblance of a (pre-existing) branded entity,
and thereby evoking the cognitive remembrance of a (pre-existing) branded entity.

Making the enpluralized multi-humped branding-energy-amplifying vehicle itself visually appealing and memorable,

makes all of the other vehicles associated with the branding-energy vehicle visually appealing and memorable;

Which makes the brand itself visually appealing and memorable . . .

Sales are catalyzed, and profits are channeled, and . . . money is made.

Attracting Attention and Evoking Memory are the Primary Tools employed in the Art and Science of the Discipline of Advertising.

### Topic 11: The Sunroof & Solar Energy Multiplication

### Drawing Figures and Drawing Descriptions FIG. 11a-FIG. 11b

Sunroofs may be installed in any of the multi-noded embodiments herein;

however, the following discussion relates especially to a curved sunroof installed in at least one curved beetlelike hump of a multihumped Volkswagen Beetle branding energy amplifier.

Prisms have long been used to introduce light into spaces which are relatively lacking in light.

Ancient sailing-vessels used emerald-colored octagonal prisms set into the decking surface, to bring light directly down to the chambers below.

New houses (and retrofitted old houses) often use flexible light-baffles, with a prismatic lens set on the roof-deck above, to bring natural-light (free-for-the-taking) to bathrooms, and kitchens, and other rooms or spaces lacking in light.

Here, the curvature of the curved sunroof, functions as a quasi-prismatic lens, for gathering more light for transmission to the interior.

Also, the greater surface area of the curved surface (compared with a flat surface), allows more unit-area for light to pass through; relative to the substantially flat surface of the industry-standard flat sunroof.

Light gain is multiplied (per automobile),
because humps & sunroofs are multiplied, that is, added recursively; see topic 15 for more information on parameter multiplication.

Solar energy (sunlight) is very important to human health because a number of biological processes are critically dependent upon light:
including the metabolism of vitamin d, and serotonin, and melatonin.

Of course, sunroofs may be substantially fixed and immobile;

Or they may be substantially movable between an open state and a closed state.

Additionally, in Topic 28, “The Node as Beach-Chair”, even greater solar-energy gain is attained using exterior (outdoor) seat-forming nodes.

Finally,

I have chosen the industry standard substantially flat sunroof as the basis for comparison in the claims;

Certainly other sunroof shapes are possible (triangular, square, parallelepiped, etc.);

However, for reasons of
ergonomics,
aesthetics,
customer preference,
manufacturing efficiency,
aerodynamics,
and other potential reasons,

None of those designs are realistically feasible within the automotive marketplace as it is known today.

### Topic 12: Acoustics

### Drawing Figures and Drawing Descriptions FIG. 12 claim 9

A curved roof,
although not a true parabola, behaves sufficiently similar to a true parabola, to be considered a true parabola, or at least a quasi-parabola; at least within the context of the automotive interior.

Acoustic isolation:
By virtue of the plurality of curved beetlelike quasi-parabolic roofs, distinct acoustical environments exist within and under each curved roof-hump within the common interior space of the automobile; and
Therefore the passengers under a given roof-hump of a given automobile, can be isolated to a substantial degree, from the passengers under another roof-hump of the same automobile;
All those who have suffered through the agony of extended road trips will readily applaud this feature.

Optional Tuning: Each curved hump may be optionally entuned as desired, to attain a predetermined acoustic parameter or frequency response.

There are four distinct acoustical environments:
1. A non-parabolic environment;
   here, acoustic-energy is wasted.
   (The “exterior nonadjacent area” in claim 9)
2. An area adjacent to a parabolic environment,
   but not within the “umbrella” of the parabola;
   here, acoustic energy is rejected,
   much like a bandstop filter.
   (The “exterior adjacent area” in claim 9);
3. An area within the “umbrella” of the parabola, but not at the focus;
here, acoustic-energy is redirected toward the focus,
and is conserved and enhanced,
much like a bandpass filter and an amplifier.
   (The “interior inside area exclusive of the quasifocalpoint” in claim 9);
4. An area within the “umbrella” of the parabola, and at the focus;
   here also, acoustic-energy is also redirected toward the focus,
   and is also conserved and enhanced,
   much like a bandpass filter and an amplifier.
   (The “interior quasifocalpoint” in claim 9);

### A. Acoustic Quality Accumulation Rating

1. Acoustic Quality Accumulation Rating=Interior Intensity+Exterior Intensity

2. For the purposes of the claims 1 have used a nonstandard method to measure Acoustical Quality (The Acoustic Quality Accumulation Rating, AQAR) in order to quantifiably enumerate the acoustical contribution of each Node (roof) in a plurally Noded (plurally roofed) automotive vehicle; especially a plurally-Noded Quasi-Parabolic vehicle.

3. The AQAR for both a plurally-Noded Quasi-Parabolic vehicle, and a singular-Noded Industry Standard vehicle will be determined, and then compared.

4. The comparison will show that a plurally-Noded Quasi-Parabolic vehicle is acoustically superior to a singular-Noded Industry Standard vehicle.

5. Methods: Inside the quasiparabola: Interior Intensity
a. Let a sound source of a predetermined frequency and a predetermined intensity be placed inside the Node, at the Node quasifocalpoint of the plurally-Noded Quasi-Parabolic vehicle; and at the Node centerpoint of the singular-Noded Industry Standard vehicle.
b. Let the sound source be triggered.
C. Let the resultant intensity be measured inside the Node at a predetermined position near the outermost portion of the Node, but still within the interior portion of the Node.
d. Let each resultant Interior Intensity be assigned a positive value.

6. Methods: Outside the quasiparabola: Exterior Intensity:
a. Let a sound source of a predetermined frequency and a predetermined intensity be placed at a predetermined position outside of the Node.
b. Let the sound source be triggered.
c. Let the resultant intensity be measured inside the Node at the Node quasifocalpoint of the plurally-Noded Quasi-Parabolic vehicle; and at the Node centerpoint of the singular-Noded Industry Standard vehicle.
d. Let each resultant Exterior Intensity be assigned a negative value.

### B. The Whole Vehicle Acoustic Quality Accumulation Rating

1. Whole Vehicle Acoustic Quality Accumulation Rating (WVAQAR):
   WVAQAR=Interior Accumulation+Exterior Accumulation
2. Interior Accumulation: Accumulate all of the Interior Intensities.
3. Exterior Accumulation: Accumulate all of the Exterior Intensities.

### C. Results

1. The (claimed) plurally-Noded Quasi-Parabolic vehicle will have a large-positive interior accumulation, and a small-negative exterior-accumulation;
The net WVAQAR will be a large-positive rating.

2. The singular-Noded Industry Standard vehicle will have a small-positive interior accumulation, and a large-negative exterior-accumulation;
The net WVAQAR will be at best a small-positive rating.

3. The (claimed) plurally-noded Quasi-Parabolic vehicle will be acoustically superior to singular-Noded Industry Standard vehicle.

### D. The Equivalence of Alternative Methods

0. The method described above is equivalent to the method described in the claims, as will be shown below.

00. The method described in the claims was only used to enhance ease of claiming.

1. The Method shown above can be illustrated as follows:
{+[I(1)+I(2)+ . . . +I(n)]}+{−[E(1)+E(2)+ . . . +E(n)]}.
Where
I=interior intensity of the plurally-Noded Quasi-Parabolic vehicle
E=exterior intensity of the plurally-Noded Quasi-Parabolic vehicle
   {+[i(1)+i(2)+ . . . +i(n)]}+{−[e(1)+e(2)+ . . . +e(n)]}.
   Where
i=interior intensity of the sinaular-Noded Industry Standard vehicle
e=exterior intensity of the sinaular-Noded Industry Standard vehicle.

In other words, All of the Interior Intensities are added together and assigned a positive value; and
All of the Exterior Intensities are added together and assigned a negative value; then
Both of these quantities are added together.

Note:

Although the singular-Noded Industry Standard vehicle by definition has only 1 Node,

(And therefore does not require the “sub n” arbitrary Node ‘iterator’ notation format), the arbitrary “sub n” notation format is included anyway for the sake of symmetry.

2. The WVAQAR of the plurally-noded Quasi-Parabolic vehicle exceeds The WVAQAR of the singular-Noded Industry Standard vehicle by the following amount:
{+[I(1)+I(2)+ . . . +I(n)]}+{−[E(1)+E(2)+ . . . +E(n)]}−{+[i(1)+i(2)+ . . . +i(n)]}+{−[e(1)+e(2)+ . . . +e(n)]}={[I(1)−i(1)]+ . . . +[I(n)−i(n)]}−{[E(1)−e(1)]+ . . . +[E(n)−e(n)]}=n×{[I(k)−i(k)]−[E(k)−e(k)]}=n×{[I(k)−i(k)]+[−E(k)−(−(e(k))]}=n×{[I(k)−E(k)]−[i(k)−e(k)]}=n×{[I(k)+−E(k)]−[i(k)+−e(k)]}

Therefore: the plurally-Noded Quasi-Parabolic vehicle AQAR exceeds the singular-Noded Industry Standard vehicle AQAR by the following per Node amount:
[I(k)+−E(k)]−[i(k)+−e(k)].

The term:
[I(k)+−E(k)]
is
the per Node signed positively Interior Intensity{I(k)} of the plurally-Noded Quasi-Parabolic vehicle, plus
the per Node signed negatively Exterior Intensity {E(k)} of the plurally-Noded Quasi-Parabolic vehicle.

The term:
[i(k)+−e(k)]
is the analogous quantity, but for the singular-Noded Industry Standard vehicle.

The minus sign between the two terms merely indicates
that we are finding the amount by which the plurally-Noded Quasi-Parabolic vehicle exceeds the singular-Noded Industry Standard vehicle;
In other words the differential amount.

3. This is exactly what is claimed in claim number 9:
attaining implicitly an acoustic quality accumulation rating of c;
   per unit node;
      where c is shorthand for curved; and
observing a lower acoustic quality accumulation rating of f;
   per unit node;
   for the industry standard substantially flat topped roof;
   where f is shorthand for flat; and
surpassing the acoustic quality accumulation rating of the acoustically inferior flat roof, by a quantity c minus f; [the differential amount] per unit node; and
accumulating a whole vehicle acoustic quality accumulation rating of the quantity c minus f, multiplied by the number of nodes n;

Therefore, Acoustic quality is multiplied per automobile,
because humps are multiplied per automobile, that is, added recursively; Topic 15: Parameter Multiplication.

Finally,
the abstract concepts of acoustic-energy, and its conservation and enhancement, become tangible and beautiful and breathtaking when seated in a bandshell anchored in the water on a serenely summer evening picturesque and peaceful.

Multiplying acoustic quality.

Isolating the occupants from undesirable noise.

Enveloping the occupants with pleasurable acoustic energy;
much like that in a bandshell; or in a symphonic space for music.

Intensifying the auditory enjoyment.

### Topic 13: Spatial Volume Multiplication

### Drawing Figures and Drawing Descriptions FIG. 13a-FIG. 13b

Within the interior space of any given automobile,
the maximum ceiling height (roof height) is ergonomically constrained by ergonomic factors;
If the roof-ceiling is too far above the head, the interior of the automobile will seem cavernous and hollow and detached and uninviting.

If, however, the roof height is only locally changed (changed only in a local area), then, a much higher roof height will be tolerated and even preferred by the people within.
Much like
   a bay window in a home; or
   a bell-tower living-room above a home; or
   a breakfast nook;
a local enlargement
   provides added volume for living;
   as well as a cozy, and secluded, and warm & fuzzy space for just being.

A box-like and substantially parallel-sided locally-raised roof-height is another possibility;
however, within the automotive context:
   if indeed “beauty is its own excuse for being” . . .
   then such ugliness would be quite defenseless.

The only real-world solution, is to use a rounded and curved locally-raised roof height; this is especially critical or at least desirable when plural roof-hump-nodes are employed.

This is the solution adopted by both the new beetle, and by the old and original beetle.

Finally, People are territorial by nature, and need substantial quantities of ‘living space’.

Spatial volume is multiplied per automobile (Topic 15), because humps are multiplied, that is, added recursively.

### Topic 14: Privacy & Tranquility Multiplication

### Drawing Figures and Drawing Descriptions FIG. 14a-FIG. 14c

When you are at a restaurant on a date with a woman who is nearly perfect,
you want to sit in a booth.
Period.
Not a table.
Not a counter.
Not anything but a booth.
Period.

There is nothing even remotely like a quiet, cozy, and intimate booth to provide intimacy for intimate conversation.

A bay-window;
a breakfast-nook;
a living-room bell-tower above the roof-top of a home;
all of these function in very much the same way;

So does a rounded-roof in an automobile . . . especially a rounded roof with a rounded sunroof

Privacy is multiplied per automobile (Topic 15) because humps are multiplied, that is, added recursively.

### Topic 15: Parameter Multiplication

### Drawing Figures and Drawing Descriptions FIG. 15a-FIG. 15c

Multiplication is merely defined as repeated addition.

When a given quantity or parameter is differentially greater per roof-node;

and when

a plural quantity of roof-nodes is employed;
the per roof-node differential amount is repeatedly added (recursively added) together; and is, therefore, multiplied by the number of roof-nodes.

### Topic 16: Mathematical Determinability of Overall Length

### Drawing Figures and Drawing Descriptions FIG. 16a

A very substantial quantity of very substantial arguments have been presented, and will be presented, directed toward the inevitable and proper conclusion that these plurally-humped (plurally-noded) automobiles, created for the amplification of the energy of brand, are, in fact, worthy of utility patent status.

The Mathematical Determinability of Length is yet another reason for the just and proper conferation of utility patent status.

Since these Branding-Energy Amplifier automobiles are formed by recursively cloning discrete Beetlelike humps (discrete nodes),

the overall length will be (given some appropriate assumptions),

a stepwise function growing stepwisely by discrete chunks, not infinitely variable, as with conventional automobiles.
   If we let:
h=horizontal length of the hump (node) or hump fragment (node fragment);
(for this example we have assumed h is constant for all humps (nodes));
s=horizontal hump-to-hump (node-to-node) spacing;
(for this example we have assumed s is constant for all humps (nodes));
f=horizontal front-end projection;
r=horizontal rear-end projection;
n=number of humps (nodes);
   (for this example, we have assumed n to be an integer which is greater-than-or-equal-to 2);
   (n will always be greater-than 1; but n will not always be an integer);

Then, the length L, of a multi-hump (multi-node) branding-energy amplifier, is
L=f+r+(n×h)+([n−1]×s).

Note: The length will also be constrained by limitations imposed by:
the jurisdiction in which the automobile is licensed;
the maximum steering angle;
the minimum radius of the streets upon which the automobile will be traveling;
etc.

### Topic 17: The Sports Utility Vehicle as Money Machine

### Drawing Figures and Drawing Descriptions FIG. 17a-FIG. 17t

The Sports Utility Vehicle as it exists within the United States in the year 2004 is a paradox.
On the one hand certain political groups would prefer that the Government ban outright all further SUV production; and the U.S. Government itself is constantly imposing new taxes and new regulations on SUVs;
While on the other hand, consumers in general, have absolutely fallen in love with the SUV.

Manufacturers, for their part, see the monstrously bulging and physically enormous SUV as an absolute ca$h cow.

All manufacturers are continually seeking new ways to effectively tap this extraordinarily lucrative market.

Concept 1: The Beetle SUV as Animal

A dual-humped
jacked-up
testosterone-laced
steroid-saturated
sinew-snapping
curvaturistically-globular
wide-framed
four-doored
four-on-the-floored
four-wheeled
four-wheel-drive-d
big and b-aaaaa-d
and ‘ahnery’
and almost downright animalistic
   ESS-YU-VEEE
      Bug-A-Bug-On-Steroids . . .

May be the perfect way to tap break into this market.

Concept 2: The Beetle SUV as kitten

A twin curved
and softly spoken
and diminutively delicate
and cuddly petite
and warm and fuzzy
and teeny and tiny little suv a kind of kinder and gentler suv . . .

May be more appropriate for narrower roadways, and for increased fuel efficiency; while still offering the advantages of curvature-plurality for attractively attracting attention (BE Amplification), and the headroom space increase implicitly provided by curved rooftop vehicles.

Concept 3: The Beetle SUV as “Luv-Bug”

The classic Valentines Day Heart:

The center-area between the front and rear humps (nodes) may be formed in the shape of the upper split-center-crease of the Valentines Day Heart; and

The two hump-halves (node-halves) may be formed in the shape of the upper heart-halves of the Valentines Day Heart.

. . . It is ‘heart and soul’ . . . .

Concept 4: The Plural Roof-Node-Concept as Brand-X SUV

Although, the twin-hump concept may be more appropriate for vehicles modeled after the Volkswagen Beetle,

The attention-attracting Plural Roof-Node-Concept may be appropriated
for any conceivable SUV brand; and
for any conceivable brand shape-contour; and
for any conceivable plural quantity of roof-top-nodes.
   Concept 5: Roof Modification—Physically Amplified Humps (Nodes)

Physically Larger rooftop humps (nodes):
1. Are easier to see; and therefore
2. Attract more attention; and therefore
3. Amplify more of the energy of brand; and
4. Allow substantially more headroom inside.

Physically larger rooftop humps (nodes) are especially useful in larger (wide-body) vehicle formats; such as the SUV and the Limousine.

Physically larger rooftop humps (nodes) are substantially more visible and recognizable and memorable:
they build brand in a more dynamic and “souped-up” and supercharged way.
   Concept 6: Roof Modification—Tubelike Humps (Nodes)

Please also refer to Topic 18, and Topic 29.

A substantially tubelike profile is obtained when the principal-radii front-view is increased toward infinity; and when the principal-radii included-angle front-view is adjusted so as to trim the curve to substantially match the width of the automobile;

the substantially flat tubelike curve is flat across the top when viewed from the front, and curved when viewed from the side.

A huge tubelike profile radiates an “attitude”: “big and bad and ahnery”; which is perfect for an offroad SUV animal.

The Tubular configuration provides more headroom than a non-tubular configuration;

In the non-tubular configuration the roof-line tapers downward along the line of the tubular reference-axis; thereby nullifying a portion of the interior headroom.

Review: Physically Amplified Rooftop Humps (Nodes)

1. Greater Visibility;
2. And therefore Greater Potential to Amplify the Energy of Brand;
3. More Interior Headroom;
4. Tubular Configuration Allows Wider Vehicle Frame;
5. And therefore Increased Lateral Stability;
6. Tubular (‘Tube’) Configuration especially in the Offroad SUV Platform provides the ‘tude’ in ‘attitude’.

### Topic 18: The Brand as Anchor Acceptable Deviation from a Branded Shape

### Drawing Figures and Drawing Descriptions FIG. 18a1-FIG. 18i3

Concept 1: Which Brands may be Amplified

The shape of the Volkswagen beetle is the shape of primary importance within this work; however, claims are both presented and intended to encompass the shape of any brand including the following, (but not excluding any which are not following):
the Audi tt;
the Cooper mini; and
the shape of the plurally-noded vehicle itself, (which itself implicitly constitutes a brand); and
the shape of any plurally-noded arbitrarily-shaped vehicle.

Therefore, to restate,
A two-noded Sports Utility Vehicle may be configured as an Amplifier of the Energy of Brand for:
   the Volkswagen Beetle (new or old-style), the Audi tt, the Cooper mini, the two-noded SUV itself, or any other brand; and
A multi-noded Limousine Vehicle may be configured as an Amplifier of the Energy of Brand for:
   the Volkswagen Beetle (new or old-style), the Audi tt, the Cooper mini, the multi-noded Limousine itself, or any other brand; and
An arbitrarily-shaped plurally-noded Vehicle may be configured as an Amplifier of the Energy of Brand for:
   the Volkswagen Beetle (new or old-style), the Audi tt, the Cooper mini, the arbitrarily-plurally-noded vehicle itself, or any other brand.
      Concept 2: How Much Branded Shape is Sufficient for Amplification

In order to Amplify the Branding Energy of any particular brand,
1. The branded shape of the shaped brand must be sufficiently echoed or expressed,
   2. So that a memory of the (branded) shape is echoed,
      3. So that a memory of the (shaped) brand is evoked.
         Concept 3: Acceptable Permutations of Branded Shape Expression

1. Substantially the identically exact shape of the shaped brand.

2. Substantially the identically exact shape of the shaped brand, except that it has been scaled to a physically smaller size.

3. Substantially the identically exact shape of the shaped brand, except that it has been scaled to a physically larger size.

4. Substantially the approximately similar but not the precisely exact shape of the shaped brand.

5. Substantially arbitrarily shaped but bearing a sufficiently slight resemblance to evoke at least a faint emotive remembrance of the shaped brand.

Concept 4: Replication vs. Repetition

1. Replication:
A set of 8 identical twin babies is an example of replication;
A set of 8 identical Volkswagen beetles (identical shapes) is an example of replication.

2. Repetition:
A set of 8 unrelated but human babies is an example of repetition;
A set of 8 automobiles having curved roofs (similar but not identical shapes), for example a Beetle, an Audi tt, a Porsche, etc, is an example of repetition.

3. Replication is stronger than Repetition.

Concept 5: Acceptable Conceptual Permutations of Branded Shape Expression

1. Shape: Any shape or contour;
provided Concept 2 is substantially satisfied.

2. Scale: Any scale or sizing;
provided Concept 2 is substantially satisfied.

3. Spacing: Any node may be physically spaced apart any distance from any other node;
provided Concept 2 is substantially satisfied.

4. in Sufficiency: Any insufficiency relative to the set of all points comprising the complete shape set:
Any fragmentation or incompleteness or partial-shape portion;
provided Concept 2 is substantially satisfied.
   Concept 2 reprinted:
   Concept 2: How Much Branded Shape Is Sufficient for Amplification

In order to Amplify the Branding Energy of any particular brand:
1. The branded shape of the shaped brand must be sufficiently echoed or expressed,
   2. So that a memory of the (branded) shape is echoed,
      3. So that a memory of the (shaped) brand is evoked.
         Concept 6: The Generalized Markush Paradigm as an Automated Tool for the Automatic Generation of Modified (Not Replicated) Shape

1. Markush Paradigm:
a. Altering (modifying) at least one Node Shape Paradigm; and
b. Altering (modifying) at least one Node Shape Parameter.

2. The Node Shape Paradigm alteration selected from the group consisting of
node contour alterations and
node scaling alterations and
node spacing alterations and
node fragmentation alterations.

3. The Node Shape Parameter alteration selected from the group consisting of
sideview median radii alterations and
sideview principle radii alterations and
sideview median radii included angle alterations and
sideview principle radii included angle alterations and
sideview median radii scaling coefficient alterations and
sideview principle radii scaling coefficient alterations and
sideview hump to hump spacing alterations and
frontview median radii alterations and
frontview principle radii alterations and
frontview median radii included angle alterations and
frontview principle radii included angle alterations and
frontview median radii scaling coefficient alterations and
frontview principle radii scaling coefficient alterations and
frontview hump to hump spacing alterations and
topview median radii alterations and
topview principle radii alterations and
topview median radii included angle alterations and
topview principle radii included angle alterations and
topview median radii scaling coefficient alterations and
topview principle radii scaling coefficient alterations and
topview hump to hump spacing alterations.

4. The alterations performed as desired
provided Concept 2 is substantially satisfied.
   Concept 7: Potential Reasons for Modifying the Branded Shape of a Shaped Brand

1. Achieve a sizing accommodation.

2. To give the brand a ‘new look’ or a ‘fresh coat of paint’, while still retaining branding rights to the branded shape of the shaped brand.

3. Other potential reasons are easily imaginable.

Concept 8: Explanation of Terms used in the Markush Paradigm above

0. See drawing figures and drawing descriptions FIG. 18a1-FIG. 18i3.

1. Node Contour: The Shape of the Shaped Brand.

2. Node Scaling: The Size of the Shape of the Shaped Brand.

3. Node Spacing: The Physical Distance of Separation between any two (usually adjacent) Nodes.

4. Node Fragmentations:
The Degree of Incompleteness attained by a Shaped Node relative to the complete totality of the Shape of the Shaped Brand.

5. Side View: The View from the Side of the Automobile, the y-z plane; (substantially within the plane-of-travel and substantially perpendicular to the direction-of-travel).

6. Front View: The View from the Front of the Automobile, the x-z plane; (substantially within the plane-of-travel and substantially parallel to the direction-of-travel).

7. Top View: The View from the Top of the Automobile, the x-y plane; (substantially perpendicular to the plane-of-travel).

8. Median Radii: A way to describe the path of an arbitrary shape, when the shape Is comprised of many small-radii curves;
A median curve is first drawn through the arbitrary shapes, and then the radius of this curve is determined; this radius is the median radius;
More than one median radius is the ‘median radii’.

9. Principle Radii: A way to describe the path of an arbitrary shape, when the shape is comprised of one principle curve and many more substantially smaller curves;
The principle curve is identified, and then the radius of this curve is determined; this radius is the principle radius;
More than one principle radius is the ‘principle radii’.

10. Median Radii Included Angle:
The angle subtended by the set of shapes, is merely a way to describe how much of the complete shape is utilized, whether a substantially complete shape, or only an incomplete and partial-fragment of the shape.
The subtended angle is the included angle.

11. Principle Radii Included Angle:
The angle subtended by the set of shapes is merely a way to describe how much of the complete shape is utilized, whether a substantially complete shape, or only an incomplete and partial-fragment of the shape.
The subtended angle is the included angle.

12. Median Radii Scaling Coefficient:
Just like the ‘enlargement’ or the ‘reduction’ function on a Copy Machine.
The Included Angle remains constant during the scaling, but the distance from the vertex of the Included Angle to the scaled shape changes, becoming either farther away from the vertex (enlargement), or closer to the vertex (reduction).

13. Principle Radii Scaling Coefficient:
Just like the ‘enlargement’ or the ‘reduction’ function on a Copy Machine.
The Included Angle remains constant during the scaling, but the distance from the vertex of the Included Angle to the scaled shape changes, becoming either farther away from the vertex (enlargement), or closer to the vertex (reduction).

14. Hump to Hump Spacing:
The Physical Distance of Separation between any two (usually adjacent) Nodes-Shapes.
   Concept 9: Some Special Cases

0. See drawing figures and drawing descriptions FIG. 18a1-FIG. 18i3.

1. Split-Left—-Split-Right Hump:
A singular hump (when viewed from the side), becomes a split hump (split left & split right), but both humps share a common centerline.
Potentially useful for the storage of gear on the rooftop.
For a visual examples:
   See Topic 17: The SUV as Money Machine; and
   See Topic 29: Rooftop Storage. 2. Offset-Split-Left—Offset-Split-Right Hump:
A singular hump (when viewed from the side), becomes a split hump (split left & split right), but both humps do not share a common centerline, so the left-hump (set) becomes longitudinally offset relative to the right-hump (set). Potentially useful for the storage of gear on the rooftop.

### Topic 19: General Shapes For Potential Use in Rooftop Nodes

### Drawing Figures and Drawing Descriptions FIG. 19a-FIG. 19d

Concept 1: Shape

1. Curved: Circular, Elliptical, Parabolic, Arbitrary curvature, etc.

2. Substantially Flat At Top of Node; Rectilinear: Square, Parallelepiped, etc.

3. Pointed At Top of Node: Triangular, etc.

4. Any other shape.

Concept 2: Function

1. The shapes described in this or any other section are not mere convexities or geometrical whimsicalities; the ultimate function of all of the shapes described herein is financial function: making money by amplifying the Energy of Brand.

### Topic 20: The Pervasive Principle of Plurality

### Drawing Figures and Drawing Descriptions FIG. 20a-FIG. 20e

Concept 0: State of the Art & The Industry Standard

1. The non-plural, singular-node rooftop is The Industry Standard.

Concept 1: Core-Kernel: The Plurality Principle

1. The nucleus of this patent dissertation is this: Plurality of Node.

Concept 2: Integer-al Plurality

1. Any plural quantity of complete Nodes is claimed (both directly, and indirectly).

2. Thus: 2-nodes, 3-nodes, 4-nodes, 5-nodes, 6-nodes, 7-nodes, 8-nodes, 9-nodes, 10-nodes, . . . , 387-nodes, are all claimed.

Concept 3: Fraction-al Plurality

1. Any plural quantity of Fractional Nodes is claimed (both directly, and indirectly).

2. Thus 1_{—}½-nodes, 3_{—}¼-nodes, . . . , 10_{—}⅔-nodes, . . . , 387_{—}⅘-nodes, are all claimed.

Concept 4: Stipulations

1. Stipulations which modify and modulate the strict universal and absolute nature of The Plurality Principle will be found within the “Doctrines” Sections which follow.

Concept 5: One-Roof Syndrome

1. In times past, there were “Flat-Earthers”: people who thought that all the world was flat; they did not realize that the world is round.

2. In times present, there are “One-Roofers”: people who think that all automobiles have only one roof, they do not yet realize that automobiles should have more than one roof.

Concept 6: The Antidote For One-Roof Syndrome

1. The Plurality Of Node Principle is hereby presented as the antidote and the verbal vaccine for the scourge of One-Roof Syndrome.

Concept 7: Multiplied Node. Multiplied Brand. Multiplied Money.

1. Multiplied Node.

2. Multiplied Brand.

3. Multiplied Money.

### Topic 21: Plurality As Mood-Maker

### Drawing Figures and Drawing Descriptions FIG. 21a-FIG. 21b

Concept 1: Applicability

1. The following applies to all Plurally-Noded Vehicles, but it applies especially to the multi-humped Volkswagen Beetle (Buggus infinitus).

Concept 2: Fun

1. An automobile with, say, 8 roof-humps,
will look like no other automobile has ever looked;
it will generate a jovial and lighthearted and fun-loving atmosphere.

2. High-School Seniors riding around on Prom Night;
Newlywed Sweethearts out on Their Night;
Grandma celebrating her 98th birthday tooling down The Coastal Freeway;
all these . . . and hundreds of millions more besides.

3. a. Attracting Attention Attractively.
b. Inducing Endearing Laughter.
c. Engendering Enduring Memory.

### Topic 22: Node Latin

### Drawing Figures and Drawing Descriptions FIG. 22a-FIG. 22e

Concept 1: Volkswagen Beetle

1. Buggus infinitus: many-humped beetle

2. Buggus singularitus: single-humped beetle (the bug we all know and love)

Concept 2: Audi tt

1. Audius tt: many-humped tt

2. Audius singularitus: single-humped tt (conventional)

Concept 3: Cooper mini

1. Coopernicus infinitus: many-humped Cooper mini

2. Coopernicus singularitus: single-humped Cooper mini (conventional)

Concept 4: Any Arbitrary Shape:

1. Arbitraricus infinitus: many-humped arbitrarily-shaped automobile

2. Arbitraricus singularitus: single-humped arbitrarily-shaped automobile

### Topic 23: Connecting The Dots

### Drawing Figures and Drawing Descriptions FIG. 23a-FIG. 23c

1. The nodes may be interconnected in any and every conceivable way.
a. Therefore, line segments, curves, or any other geometrical configuration may be used.
b. Preferably, highly stylized and stylish methods will be used:
such as a gently curved or gently radiused upwardly-open (convex) arc.

2. Please refer to the section entitled “The Node as Beach-Chair” (Topic 28) for claimed embodiments which use the intervening-area between two Nodes (preferably curving humplike nodes) as a seating surface.

### Topic 24: Saving Money

### Drawing Figures and Drawing Descriptions FIG. 24a-FIG. 24d

Concept 1: Standard Tooling

1. Depending on the Sizing-Scale and the Shape desired, the standard tooling used to create the standard Branded Shapes of a Shaped Brand may be (but not must be) used to form the plural Nodes used in the Plural-Node Embodiments.

Concept 2: Standard Parts

1. Depending on the Sizing-Scale and the Shape desired, the standard parts used to create the standard subsections of the Branded Shape Automobile may be (but not must be) used to form the subsections used in the Plural-Node Embodiments.

2. Therefore, sunroofs and sunroof parts like gaskets, doorframes and doorframe parts, windowframes and windowframe parts, etc., may be used as desired.

### Topic 25: BEAUTY & TRUTH

### Drawing Figures and Drawing Descriptions FIG. 25a-FIG. 25c

Concept 1: The Past as Prologue

1. The following lofty and poetic prosody was penned in centuries long since past:
“If eyes were made for seeing,
then beauty is its own excuse for being.”

2. In Mathematics,
equations which are true
are often
equations which are beautiful,
a
n
d
equations which are not beautiful
are often
equations which are not true.
   Concept 2: Timeless Elegance

1. Timeless elegance especially as articulated by
the principle of plural node-curvature, which itself articulates and emulates the graceful and timeless sweeping elegance of a sinusoidal waveform,
is a very tangible expression of intangible design magnificence;
This is that very same design magnificence which we are seeking herein.

2. Using the concept of the plural-node in general; and plural-curvature in specific;
we desire to create multi-hump beetles which are
   whimsically fanciful;
   pleasingly proportioned;
   functionally useful; and
   beautiful and desirable in their own right
      Concept 3: Emulation

1. There is an emerging trend in product design in which products are designed to emulate the physical likenesses of the people who will be using those products;
Several magazines have run articles to this affect including, I believe, Interior Design Magazine & Wired Magazine.

2. Thus, increasingly we see products in the marketplace which have features which resemble and mirror and echo human features such a set of human eyes, human legs, etc;
This must have been done principally because studies conducted by advertising firms must have indeed demonstrated that including such features verv positively impacts sales volume.

3. Because plural-nodes, for example twin Beetlelike curved humps, echo human features such as eyes, and ears, and etc., we can expect some net increase in sales volume due only to the affects of the Theorem-Postulate of Advertising cited above.

Concept 4: Marshall McLuhan Rides Again

1. In many of the early issues of Wired magazine, Marshall McLuhan was often cited; quoted; immortalized; and idolized;
He was famous for such concepts as
   “ . . . the wheel is an extension of the foot.”
   “ . . . the steering wheel is an extension of the hand . . . ” etc.

2. In the case of the multi-curved Beetlelike humps, the rooftop humps become a visual-extension of the wheels.

### Topic 26: The Node As Mobile-Home

### Drawing Figures and Drawing Descriptions FIG. 26a-FIG. 26b

Concept 1: The Airstream Trailer Legacy

1. When most people, especially people of middle-to-late vintage,
think of a mobile home (that is a mobile home, not a trailer park), a bubble surrounding an Airstream Trailer pops into their head.

2. The Airstream Trailer is not claimed because it fails to satisfy several of the Node Doctrine Criteria;
(Please refer to the Node Doctrines Section); the most important of these is “The Node Independence” Doctrine.

Concept 2: The Mobile Home As Enlarged Volkswagen Beetle (With Plural Humps)

1. All of the reasons presented, and remaining to be presented, are reasons for the success of a plurally-noded, especially plurally-curved plurally-noded mobile home.

2. Relative to the mobile home, the most important of these reasons are
a. vastly amplified interior headroom space (within the curved hump);
b. vastly amplified sunlight flux potential (curved sunroofs within the curved humps);
c. vastly amplified Branding EnergyAmplification;
d. due to vastly amplified physical sizing.

3. Claims are presented which detail both
a. a motonzed mobile home;
b. a towable mobile home.
   Concept 3: The Horse Trailer As Enlarged Volkswagen Beetle (With Plural Humps)

1. A horse trailer (or any other trailer) could also be recreated in this format.

### Topic 27: The Cooper Mini Limousine: Coopernicus Infinitus

### Drawing Figures and Drawing Descriptions FIG. 27a-FIG. 27c

Concept 1. Cooper Mini Limousine as Repeating Square Wave

1. The Volkswagen Beetle was Portrayed above as an elegant and beautiful sinusoidal waveform.

2. By extension and by analogy,
the Cooper Mini may be enpluralized to become an elegant and beautiful squareusoidal waveform:
   a repeating square-wave wave-form.

3. The principal reason for the creation of a Cooper mini Limousine is the Amplification of the Energy of Brand, through the creation of a Standard-Bearer for the brand; the Concept Limousine.

4. Additionally, all of the reasons cited or to be cited,
may be applied by analogy to the Cooper mini; the most important of these reasons is The Principle of Plurality as a means to attract attention.

### Topic 28: The Node as Beach Chair

### Drawing Figures and Drawing Descriptions FIG. 28a-FIG. 28u3

Concept 0: Introduction

a. Solar Power:
Human Beings are in many ways Solar-Powered Beings.
People need sunshine.
Sunlight is critical for such things as Vitamin D metabolism; Serotonin metabolism; and Melatonin metabolism.

b. Elements Of Life: Earth, Wind, Fire, Water, . . . and Chair:
Archie Bunker had his Lazy-Boy Recliner.
The leading man in the musical “Oklahoma” had his front porch rocker where
   “every night my honeylamb and I, sit alone and talk, and watch a hawk making l-a-a-a-z-y circles in the sky”.
King Solomon had his kingly throne (Royal chair).
The chair Is a crucial and Indispensably part of human life.

c. The Great Outdoors:
Modern men and modern women spend
   far too much time Indoors; and
   far too much time indoors while outdoors (that is, driving in their cars); and
   far too little time really outside in genuine fresh air and genuine sunshine.

d. “On” vs. “In”:
1. People sit in their car, why can't they sit on their car?
2. In the claims:
   any Node,
      any Branding Energy Amplifying Node (a Branding Energy Amplifying Node is defined in Topic 30); or
      any generic Node (a Node is generically defined in Topic 31);
   whose exterior surface
   forms an exterior seating-surface which people potentially sit on
   is called an “on type seatforming node”

e. The Complete Seat: Parts of the Chair:
1. “Thoraxal”: Critical; That portion against which the back rests.
2. “Rumpal”: Critical; That portion upon which the rumpus rests.
3. Leg Area: Does not include Rumpal Area; Not Critical;
   Only a few of the embodiments herein contain a leg portion;
   If provided, it should be long enough to fully accommodate the legs.
4. Footrest: Not critical;
   Only a few of the embodiments herein contain a footrest portion;
   The foot-rest can also serve as a foot-stop for bracing.
5. Headrest: Not critical;
   Only a few of the embodiments herein contain a headrest portion.

f. Things To Do While Sitting Outside On A Chair:
1. Watch a Ball Game; a Parade; or The Fourth of July Fireworks.
2. Soak up the Sun; the Sand; and the Surf.
3. Enjoy Twinkling Starlight from Stars which Twinkle.
4. Do that Homework you have been putting off for so long.

g. Surface Contour & The “RolloffAffect”:
1. If, either the thoraxal surface or the rumpal surface, is substantially convex,
   then a person seated on these surfaces might very well roll off.
2a. If, either the thoraxal surface or the rumpal surface, is substantially concave,
   then a person seated on these surfaces will be substantially more comfortable, and will be substantially less likely to roll off. Called thoraxal curvature modification, and rumpal curvature modification in the claims.
2b. Therefore, for example,
   If the thoraxal surface were to be a hatchback,
   then, the hatchback surface could be made slightly concave, instead of slightly convex, in order to decrease the Rolloff affect; and
to make the seating surface thus formed substantially more comfortable. Similar methods may be used for the Rumpal surface.
3a. If, either the thoraxal surface or the rumpal surface, is substantially flat,
   then a person seated on these surfaces will be substantially more comfortable, and will be substantially less likely to roll off.
   Called thoraxal flatness modification, and rumpal flatness modification in the claims.
3b. Therefore, for example,
   If the Rumpal surface were to be a front engine hood surface,
   then, the hood surface could be made slightly flat, instead of slightly convex, in order to decrease the Rolloff affect; and
to make the seating surface thus formed substantially more comfortable. Similar methods may be used for the Thoraxal surface.
4. General Node Contour:
   In addition to the modifications above, and
   in addition to the modifications to follow,
   the node itself may need to be modified:
      FIG. 28u1: shows a sideview node shape modification;
      FIG. 28u2: shows a sideview node sizing modification;
      FIG. 28u3: shows a sideview node spacing modification.

h. Thoraxal Surface Angle of Recline:
0. Called thoraxal reclining angle modification in the claims.
1. No Recline:
   Thoraxal surface substantially vertical;
   Not very comfortable.
2. Partial Recline:
   Thoraxal Surface sloped gently backward;
   Comfortable;
   Probably the best configuration.
3. Full or Almost Full Recline:
   Thoraxal Surface radically raked backward;
   Probably not very practical.

i. Rumpal Portion Slope of Recline:
0. called rumpal slope modification in the claims.
1. No slope:
   Rumpal Surface substantially horizontal;
   Not very comfortable.
2. Slight slope:
   Rumpal Surface slightly sloped backward;
   Comfortable;
   Probably the best configuration.
3. Radical Slope:
   Rumpal Surface Radically Sloped;
   Similar to the Classic LL Bean Northeastern Wooden Lawn Chair.

j. Node Shape relative to Branded Shape
1. Any shape: Curved, Flat, etc.
2. Any Brand: Volkswagen Beetle, Audi tt, Cooper mini, etc.
k. An integrally-formed seating surface itself implicitly attracts aftention.
   Concept 1: The Roof as Recliner—Embodiment 1

The discussion that follows, applies to any two adjacent rooftop nodes; But applies especially to Beetlelike curved rooftop humps.

For centuries, people have traveled across endless terrain on the backs of humped camels;
perched atop and between the twin exterior camel-humps.

If those same humps were:
scaled larger In size (radius), and
spaced farther apart, then . . .
the camel-proportions would approach
the proportions of the twin-hump SUV described herein!
   Please refer to the “Node as Beach Chair” Drawings Section, for an illustration of people relaxedly reclining on the roof between the twin-humps of their twin-humped SUV, watching Fourth of July Fireworks at the State Fair (!).
   Concept 2: Hatchback Half-Recline—Embodiments 2a, 2b, and 2c

The discussion that follows applies to any rear hatchback surface;
But applies especially to the Beetle hatchback surface.

Even as the roof can become a full-recliner, so also can the hatchback of the Volkswagen Beetle, become a haff-recliner.

With only a few minor modifications,
modifications which will in no way diminish the safety of the automobile, the rear-hatchbackof the Volkswagen “bug” can become . . .
   the loveseat for the ‘luv-bug’ of the next generation.

When the Beetle Hatchback surface is appropriately modified for seating,
the singular hump will become a singular hump plus a fraction of a hump; and therefore
is claimable with appropriate claimage;
and is claimed with appropriate claimage.

Please refer to the “Node as Beach Chair” Drawings Section, for an illustration of people relaxedlyreclining on the hatchback surface of their modified Volkswagen Beetle watching Fourth of July Fireworks at the State Fair (!).

Note: The hatchback “latch” should be relocated to a new position; a position away from the Thoraxal Zone (the Human Back).

Note: A padded seat-cushion overlay, stowable within the vehicle, may be additionally optionally provided to increase reclining comfort.

Concept 2a: Embodiment 2a

Hatchback forms Thoraxal Surface And
Bumper Extension forms Rumpal Surface.

If the bumper surface is extended to form the Rumpal portion of the seat, then there are substantially two possibilities:
Possibility 1: The Bumper surface is continuous across the width;
   This is one of the two best solutions.
Possibility 2: A portion of the Bumper surface is ‘relieved’ or cut-away to accommodate hatchback closure;

Possibility 2:
Not a very desirable solution, because cutting-away a portion of the bumper is very likely to affect the bumper-function of the bumper.
A replaceable bumper-insert could be provided, but again, this is a sub-optimal solution.
   Concept 2b: Embodiment 2b
Hatchback forms Thoraxal Surface And Both Bumper Extension and Hatchback Extension Form Rumpal Surface; (Hatchback Extension Overlays Bumper Extension).

This embodiment potentially provides for unimpeded hatchback closure;
And does not materially affect hatchback function, or bumper function;
And provides a painted (and smooth and clean) seating surface (rather than a potentially greasy elastomeric bumper surface);
This is one of the two best solutions.
   Concept 2c: Embodiment 2c
Hatchback forms both Thoraxal Surface And Rumpal Surface; No Bumper.

Not a viable solution because a bumper is not included; yet a bumper is required.

Alternatively, the hatchback surface could provide both
the Thoraxal Surface and the Rumpal Surface if the hatchback extension were raised above the bumper; in that way, bumper function would not be materially affected; however, if the hatchback extension touches or is supported by the bumper, then Embodiment 2c becomes in affect Embodiment 2b.
   Concept 3: Arbitrarily-Shaped-Node Seat-Formation On-Type Seat-Forming Nodes
   A. Seat-Forming-Node Elements:
   1. Passenger Compartment Node: the Node formed by any part of the passenger compartment.
Thus, the Node
   formed by the Roof (Passenger Compartment);
   and-or the Front Windshield (Passenger Compartment);
   and-or the Rear Windshield (Passenger Compartment);
   and-or the Front Hatchback surface (Passenger Compartment);
   and-or the Rear Hatchback surface (Passenger Compartment);
   and-or the rear-part of the cab of a pick-up truck (Pssngr Cmptmt); is a Passenger Compartment Node.

2. Energy-Absorbing Bumper Node:
the Node formed by a Bumper ‘compartment’.

3. Trunk Compartment Node:
the Node formed by the trunk compartment.

4. Engine Compartment Node:
the Node formed by the Engine Compartment.

5. Truck Bed Compartment Node:
the Node formed by the truck bed ‘compartment’.

6. Tailgate Node:
the Node integrally formed by the tailgate ‘compartment’.
Note: There exist several patents relating to the tailgate used as a storage compartment for gear (such as ramp-storage, tool-storage, etc).
Note: I have seen several seats which attach to the tailgate; but I have not seen any which use the tailgate as an Integrally-formed seat.
   7. Tool Compartment Node:
the Node integrally formed by an accessory tool-storage box (compartment) located within a truck bed compartment.
Note:
   As a means for claiming merely a tool-box modified as described above, only the tool-box itself will be directly claimed; the bed of the pick-up truck will be claimed inferentially.

### B. Seat-Forming-Node Combination Embodiments:

Seat-Forming-Node Combination Embodiment 1:

Thoraxal Portion Passenger Compartment Node

Rumpal Portion Passenger Compartment Node
a. This is a restatement of Embodiment 1 above.
b. Two adjacent roofforming-nodes, such as Cooper-mini style substantially flat-topped roof-nodes, for example, is yet another possible embodiment which is classified here.
c. This is a restatement of Embodiment 2c above.
d. This could be considered a restatement of one of the implementations of Embodiment 2b above.
   Seat-Forming-Node Combination Embodiment 2:

Thoraxal Portion Passenger Compartment Node

Rumpal Portion Energy-Absorbing Bumper Node

a. This is a restatement of embodiment 2a above.

b. Some potential embodiments classified here include:
1. The rear of a cargo-van (thoraxal) & the rear bumper (rumpal).
2. The rear of an SUV (thoraxal) & the rear bumper (rumpal).
3. The rear of a station-wagon (thoraxal) & the rear bumper (rumpal).

c. This could be considered a restatement of one of the implementations of Embodiment 2b above.

Seat-Forming-Node Combination Embodiment 3:

Thoraxal Portion Passenger Compartment Node
Rumpal Portion Both Passenger Compartment Node And Energy-Absorbing Bumper Node

a. This is a restatement of embodiment 2b above.

Seat-Forming-Node Combination Embodiment 4:

Thoraxal Portion Passenger Compartment Node

Rumpal Portion Trunk Compartment Node
a. Some potential embodiments classified here include:
   1. The rear windshield of a sedan (thoraxal) & the trunk (rumpal).
      Seat-Forming-Node Combination Embodiment 5:

Thoraxal Portion Passenger Compartment Node

Rumpal Portion Engine Compartment Node
a. Some potential embodiments classified here include:

1. The front windshield of a sedan (thoraxal) & the engine compartment (rumpal).

2. The front windshield of a station-wagon (thoraxal) & the engine compartment (rumpal).

3. The front windshield of a pick-up truck (thoraxal) & the engine compartment (rumpal).

4. The front windshield of an SUV (thoraxal) & the engine compartment (rumpal).

5. The front windshield of a van (thoraxal) & the engine compartment (rumpal).

Seat-Forming-Node Combination Embodiment 6:

Thoraxal Portion Passenger Compartment Node

Rumpal Portion Truck Bed Compartment Node
a. The rear portion of a pick-up truck cab (thoraxal) & the bed of the pick-up.
   Seat-Forming-Node Combination Embodiment 7.

Thoraxal Portion Tool Compartment Node

Rumpal Portion Truck Bed Compartment Node
a. The rear portion of a drop-in tool-box for a pick-up truck (thoraxal) & the bed of the pick-up; located at the front of the truck bed.
b. The front portion of a drop-in tool-box for a pick-up truck (thoraxal) & the bed of the pick-up; located at the rear of the truck bed.
   Seat-Forming-Node Combination Embodiment 8:

Thoraxal Portion Tailgate Node

Rumpal Portion Energy-Absorbing Bumper Node
a. The outside portion of the tail-gate of a pick-up truck (thoraxal) & the rear bumper.
   Seat-Forming-Node Combination Embodiment 9:

Thoraxal Portion Tailgate Node

Rumpal Portion Truck Bed Compartment Node

a. The inside portion of the tail-gate of a pick-up truck (thoraxal) & the bed of the pick-up.

Seat-Forming-Node Combination Embodiment 10:

Thoraxal Portion Trunk Compartment Node

Rumpal Portion Energy-Absorbing Bumper Node

a. The trunk compartment of a sedan (thoraxal) & the rear bumper.

Seat-Forming-Node Combination Embodiment 11:

Thoraxal Portion Engine Compartment Node

Rumpal Portion Energy-Absorbing Bumper Node
a. Some potential embodiments classified here include:
   1. The engine compartment of a sedan (thoraxal) & the bumper (rumpal).
   2. The engine compartment of a station-wagon (thoraxal) & the front bumper (rumpal).
   3. The engine compartment of a pick-up truck (thoraxal) & the front bumper (rumpal).
   4. The engine compartment of an SUV (thoraxal) & the front bumper (rumpal).
   5. The engine compartment of a van (thoraxal) & the front bumper (rumpal).

### Topic 29: Rooftop Storage

### Drawing Figures and Drawing Descriptions FIG. 29a1-FIG. 29d

Concept 0: Roof Modification—Rooftop Storage

Very often it is necessary to transport very large and bulky items such as bicycles, and canoes, and Yugos, and the like; This is especially true with Sports Utility Vehicles.

Below some methods are presented for adapting rooftop nodes (especially humped rooftop nodes) for accommodating rooftop storage racks;
This is by no means an exhaustive list—other methods are easily imaginable.
   Concept 1: Roof Modification-Vertically Stacked Storage Racks

FIG. 29a1 Shows vertically stacked storage racks, vertically stacked on the z-axis (the vertical axis).

FIG. 29a2 Shows one rack mounted on each node, with one bicycle stored on each rack.

FIG. 29a3 Shows one rack mounted on each node, with one bicycle stored on each set of two racks.

Concept 2: Roof Modification—Laterally Stacked Storage Racks

FIG. 29b Shows a laterally stacked storage racks,
laterally stacked on the x-axis (the lateral axis).
The major-axis of each rack is aligned with the y-axis (the longitudinal axis).
   Concept 3 Roof Modification-Longitudinally Stacked Storage Racks

FIG. 29c1 Shows Longitudinally stacked storage racks,
longitudinally stacked on the y-axis (the longitudinal axis).
The major-axis of each rack is aligned with the x-axis (the lateral axis).
They may be mounted on the rooftop nodes, or between the rooftop nodes, in the center of the vehicle.

FIG. 29c2 Shows both
laterally stacked and longitudinally stacked storage racks.
The major-axis of each rack is aligned with the y-axis (the longitudinal axis).
   Concept 4 Roof Modification—Longitudinal Center-Trench Storage Rack

FIG. 29d Shows a singularcenter-positioned longitudinal rooftop trench,
in which a rack may be mounted longitudinally between the two front nodes and the two rear nodes.
Plural racks also may be mounted within this trench.

### Topic 30: Branding Energy Amplification Doctrine

### Drawing Figures and Drawing Descriptions FIG. 30

To substantially satisfy the totality of the Branding Energy Amplification Doctrine for Branding Energy Nodes,

Each Node considered to be a Branding Energy Node (BE Node), on a BEA vehicle, Must substantially satisfy the criteria set forth within each and every Branding Energy Element

### Topic 31: Branding Energy Element 1: Node Protuberance

### Drawing Figures and Drawing Descriptions FIG. 31a-FIG. 31c

0. To substantially satisfy the criteria for BE Element 1, the BE Node must substantially be a Protuberance, a Hump, or a Bump.

1. By Dictionary Definition, a node is defined in part as “a protuberance”.

2. By Dictionary Definition, a protuberance is defined in part as “a swelling or bulging out”, and as “a hump, a bump”.

3. See Topic 28 (“The Node as Beach Chair”) for some unconventional BE Node examples.

4. A Node which is not specifically designated as a BE Node is a generic Node.

5. A generic Node is merely a Protuberance, a Hump, or a Bump.

6. A Rooftop Node or Roofforming Node is a BE Node which forms a rooftop for a BEA vehicle; See Topic 35: “Human Accommodation”.

7. A Seafforming Node is a BE Node which forms an exterior seating surface for a BEA vehicle; See Topic 35: “Human Accommodation”.

### Topic 32: Branding Energy Element 2: Node Independence

### Drawing Figures and Drawing Descriptions FIG. 32a-FIG. 32p4

0. To substantially satisfy the criteria for BE Element 2,
the BE Node must substantially be an Independent Node;
An Independent Node is a Node that substantially satisfies the criteria for the NonCoincidence Subdoctrine.

00. To substantially satisfy the criteria for the NonCoincidence Subdoctrine,
within the zone of adjacency,
   the PlumbPlumb Connector must substantially be in NonCoincidence with
   the BoundaryBoundary Connector.

000. The PlumbPlumb Connector and the BoundaryBoundary Connector are substantially in NonCoincidence when and if they Intersect in one and only one point; or when they never intersect

A. DEFINITIONS

1. Line of Sight:
Within this section, the Nodes are usually viewed relative to a Line of Sight which is substantially perpendicular to the direction of travel, and substantially within a plane which is substantially parallel to the plane of travel.
   That is, they are usually viewed in the side view (the y-z plane).
   Embodiments are specified in which the Nodes are also formed relative to the front view, and relative to the top view;
and may be formed relative to any combination of the three views.

2. Profile:
the view of an object along the line of sight, especially (but not exclusively) the side view.

3. Trace:
A set of points which comprise the profile shape of an automobile.

4. Locus:
A set of points.

5. Node Locus:
The set of points which comprise a Node.

6. Zone Of Adjacency:
An intervening area between a first Node Locus, and a substantially adjacent second Node Locus.

7. Zone of Adjacency Locus:
A set of points which form a portion of the profile trace of an automobile, located between a first Node locus, and a substantially adjacent second Node Locus;
but which does not include any points pertaining to either the first Node Locus, or the second Node Locus.

8. First Node Locus:
The set of points which form the first Node.

9. Second Node Locus:
The set of points which form the second Node.

10. First Node Locus Extension:
The set of points
excluding the first Node Locus, that would be formed within the Zone Of Adjacency,
if the first Node Locus were to be extended substantially along the path defined by the first Node Locus, but beyond the endpoint of the first Node Locus.

11. Second Node Locus Extension:
The set of points excluding the second Node Locus, that would be formed within the Zone Of Adjacency,
if the second Node Locus were to be extended substantially along the path defined by the second Node Locus, but beyond the endpoint of the second Node Locus.

12. Plumb:
Uppermost-Point Standard (common definition):
In most cases the uppermost point of a given Node Locus.

Straight-Bar Standard (rigorous definition):
The Plumb for a given Node Locus is that point where a straight bar first touches the Node Locus when the straight bar is lowered from above, and layed upon each of two substantially adjacent Node Locii.

FIG. 32p3 and FIG. 32p4:
Here is a special case where the Plumb points are not the uppermost points;
Node 1: The uppermost point is point 32p3-c, but the actual Plumb point is point 32p3-a.
Node 2: The uppermost point is point 32p3-d, but the actual Plumb point is point 32p3-b.
The difference, however, is only academic since, even if the Plumb points were taken as the uppermost points, the PlumbPlumb Connector would only intersect the BoundaryBoundary Connector at one point (point 32p3-c), and by definition would still remain substantially in NonCoincidence;
   And would therefore still remain Independent.

13. PlumbPlumb Connector:
A line segment connecting a first Node Plumb, and a substantially adjacent second Node Plumb.

14. Boundary:
That point, within the Zone Of Adjacency, where the following three locii intersect:
   the Zone Of Adjacency Locus, and a given Node Locus, and a given Node Locus Extension.

15. BoundaryBoundary Connector:
A line segment connecting a first Node Boundary, and a substantially adjacent second Node Boundary.

16. Special Case: Vertical Discontinuity:
In the event of a vertical discontinuity, the boundary point Is taken as the point along the discontinuity, which Is closest to the Zone of Adjacency Locus.
This special case definition preserves both the spirit of the NonCoincidence Subdoctrine and the spirit of the Criteria for the Node Independence Element.
FIG. 32o shows just such a case:
<32o-p1>: The first Node Plumb point.
<32o-b1>: The first Node Boundary point is taken as the point along the discontinuity which is closest to the Zone of Adjacency Locus, therefore, the Boundary becomes point 32o-b1.
   The PlumbPlumb Connector and the BoundaryBoundary Connector are in NonCoincidence.
<32o-p1> & <32o-p2>: This symmetric situation is symmetrically similar.

17. Special Case: Two Nodes having unequal radii, or unequal radii-center-point vertical-axis location:
In other words, a straight-bar laid across the tops of both Nodes, is not substantially horizontal.
See item 12, the definition of Plumb, for analysis.
   B. Discussion
1. Further discussion will be found within the NonCoincidence Drawings Section.
2. The NonCoincidence Subdoctrine implicitly defines the allowable spacing between any two substantially adjacent BE Nodes:
   If two Nodes are too close, they will merge and become, in affect, one Node.

FIG. 32a:
<32a-p>: The first Node Plumb and the second Node Plumb are the same point, therefore the two Nodes have merged into one Node. The Nodes are too close.
3. The NonCoincidence Subdoctrine implicitly defines the allowable incompleteness or fragmentation of any BE Node:
   if a Node is too incomplete, the Plumb point and the Boundary point will be substantially the same point FOR BOTH NODES, and therefore, the PlumbPlumb Connector and the BoundaryBoundary Connector, will be Coincidental, and therefore, not substantially in NonCoincidence. The Nodes are too incomplete.

FIG. 32n:
The Airstream mobile-home trailer is a perfect example of this:
<32n-a>: The Plumb point and the boundary point are the same point, (First Node);
<32n-b>: The Plumb point and the boundary point are the same point, (Second Node);
The PlumbPlumb Connector and The BoundaryBoundary Connector are therefore the same line-segment.
The two connectors are not in NonCoincidence.
4. To Review, any two substantially adjacent BE Nodes of a BEA vehicle may have any degree of Spacing, and any degree of incompleteness, and any shape, and any scaling (size), provided that they are substantially in NonCoincidence.

### Topic 33: Branding Energy Element 3: Node Plurification

### Drawing Figures and Drawing Descriptions FIG. 33a-FIG. 33h

0. To substantially satisfy the criteria for BE Element 3, a Plurality of BE Nodes must be enformed upon the vehicle bearing the BE nodes.
1. Plurality is the ‘Heart and Soul’ of this invention.
2. Plurality of Node is the principal reason that BE vehicles attract attention.
3. Attracting Attention is the principal rule of the Art and Science of Advertising.
4. Plurality means More-Than-One.
5. More-Than-One means: 1 & ¼, 2 & ½, 12, 328 & ⅔.
6. Not every Node on a BEA vehicle must be a BEA-Node.

### Topic 34: Branding Energy Element 4: Human Conveyance

### Drawing Figures and Drawing Descriptions FIG. 34

0. To substantially satisfy the criteria for BE Element 4,
   The vehicle bearing the BE Nodes, must be able to obtain applicable certification from all applicable Goveming Authorities;
      and must be designed, engineered, and manufactured for the express purpose of the transportation of Human Passengers, without special permit, at least upon all publicly-traveled non-freeway road-systems; and preferably upon all publicly-traveled freeways.

A valuable function of Government is to establish criteria regarding both the roadworthiness, and the safety (under crash-test-conditions), relative to vehicles intended primarily for the conveyance of human passengers, under human-passenger-class operational-constraints.
1. The purpose of this patent Is
   a. To obtain protection for a vehicle which will vehicularly-convey human-beings from place to place, while serving as a marketing-tool
   b. And to obtain protection for a vehicle which will serve as a marketing-tool, while vehicularly-conveying human-beings from place to place.
2. The purpose of this patent is not to obtain protection for a whimsical parade-float, forged by some inter-galactic cosmosian collision in a universe f-a-a-a-a-r away, fusing Rube-Goldberg-like matter, with Buckminster-Fuller-type anti-matter . . .
3. The famous ‘Oscar-Meyer-Weiner’ Float, would fail to meet certification requirements from applicable Goveming Authorities;
   it would also fail to satisfy the criteria for other BE Elements.

### Topic 35: Branding Energy Element 5: Human Accommodation

### Drawing Figures and Drawing Descriptions FIG. 35a-FIG. 35b

0. To substantially satisfy the criteria for BE Element 5, the BE Node must substantially be reasonably capable of accommodating or potentially-accommodating human-beings.
1. Accommodating orpotentially-accommodating means:
   a. Satisfying either b, or c, or both b and c;
      where both b, and c are defined below.
   b. “In-type” Node:
      Accommodating or potentially-accommodating Human-Beings who are or potentially will be substantially enclosed in a BE Node.
   c. “On-type” Node:
      Accommodating or potentially-accommodating Human-Beings who are or potentially will be substantially resting on a BE Node.
2. Reasonably capable of accommodating or potentially accommodating means:
   Substantially designed, engineered, and manufactured for the express purpose of the accommodation or potential accommodation of Human Beings who are or potentially will be . . .
   Therefore, a curved-hump on some curvingly-racy Italian sports-car, could be considered to be an “on-type” Node for potential “on-type” accommodation;
   in reality, it has neither been designed, nor engineered, nor manufactured for the express purpose of “accommodating or potentially accommodating human-beings”.
3. Resting means:
   Substantially resting, sitting, lounging, reclining, partially reclining, etc.
4. Although Nodes and humps could be used to accommodate mechanical systems, such function is merely ancillary to the primary functions stated above.

### Topic 36: Branding Energy Element 6: Branding Energy Amplification

### Drawing Figures and Drawing Descriptions FIG. 36a1-FIG. 36b2

0. To substantially satisfy the criteria for BE Element 6, the BE Node must Amplify the Energy of Brand.
1. Amplify the Energy of Brand means:
   Satisfying either a, or b, or c, or d, or e, or f, or any combination thereof;
   where a, and b, and c, and d, and e, and f, are defined below
   a. Attract attention to the BE vehicle itself by the formation of plural BE Nodes.
   b. Attract attention to the BE vehicle itself by the formation of at least one integrally-formed exterior seating surface, and by the formation of plural BE Nodes.
c. Attract attention to an architecturally-associated brand;
   through the formation of architecturally-associated plural BE Nodes;
d. Attract attention to an architecturally-associated brand by the formation of at least one integrally-formed exterior seating surface, and by the formation of architecturally-associated plural BE Nodes;
e. Attract attention to the BE vehicle itself by the formation of at least one integrally-formed exterior seating surface.
f. Attract attention to an associated-brand by the formation of at least one integrally-formed exterior seating surface.
2a. Plural BE Nodes themselves, implicitly attract attention.
2b. The BE vehicle which bears the plural BE Nodes itself, implicitly comprises a brand.
2c. Plural BE Nodes are defined in BE Element 3 above.
3a. Nodes are architecturally-associated by echoingly-expressing, in the Node shape, that shape which is sufficiently similarto the shape of an associated brand, so as to evoke at least some memory of the associated brand.
3b. Plural architecturally-associated BE Nodes themselves, implicitly attract attention.
3c. The BE vehicle which bears the plural architecturally-associated BE Nodes itself, implicitly comprises a brand.
4a. An integrally-formed seating surface itself, implicitly attracts attention.
4b. The BE vehicle which bears the integrally-formed seating surface itself, implicitly comprises a brand.
4c. Integrally-formed means implicitly-formedby the exterior-surface of the BE Node;
   that is by the exterior surface of the vehicle or the exterior surface of a BE node;
   not, for example, by a chair bolted to the exterior surface of a vehicle;
   or by classic-style side-positioned running-boards.
4e. Integrally-formed and lmplicitly-formed also means:
   specifically formed to be a resting-surface or potential resting surface for (at least one) human being:
      “ . . . specifically designed and specifically engineered and specifically manufactured to be specifically a resting specific surface specifically for human beings specifically.”
5. Attracting Attention and Evoking Memory are the Primary Tools employed in the Art and Science of the Discipline of Advertising.

### PART THREE: DRAWING DESCRIPTIONS

### Drawing Figure Primary Numbers Correspond to Topic Numbers

### Drawing Figures are indicated by Bold Numbers

### Drawing Figure Reference Numerals are indicated by arrow-brackets

### Example: Reference Numeral 27-KAR. LE is indicated as<27-KAR.LE.>

1. Not claimed idealized representation of the standard Volkswagen Beetle (VB).

2. Not claimed idealized representation of the Hummer Limousine.

3. Claimed VB Branding Energy Amplifier (BEA).

4. Not claimed idealized representation of the standard flat-roofed Limousine.

5. Attracting Attention Attractively: Marilyn Monroe times 88.

6. Camelus dromedarius (Camel with one hump): not easy to ride;
Camelus bactrianus (Camel with two humps): easy to ride.

7. New Automotive Species:
In this case one plus one is greater than two.

8a. Singular autonomous maternal beetlelike hump (Buggus singularitus);
Mother-cell visible;
The daughter-cell is not yet visible;
   Initial Independence
   Conception

8b. Buggus singularitus beginning the process of undergoing automotive cell-division; both the mother-cell and the daughter-cell are visible.
Differentiation (Cell Division)

8c. Buggus singularitus undergoing automotive cell-division;
both the mother-cell and the daughter-cell are visible. Differentiation (Cell Division) Continues

8d. Completing Differentiation:
Cloned Buggus singularitus attaining full autonomy and independence from the mother-cell maternal Buggus singularitus curvature-cell;
Both the mother-cell (Buggus singularitus), and the daughter-cell (cloned Buggus singularitus) are completely formed, and autonomous, and independent. Completing Differentiation

8e. Completed Differentiation:
Completed Differentiation

8f. Integration: The two curves are joined together in interdependence; in a manner that preserves their independence; and prevents the obscuration of their individuality; and in keeping with BE Node Doctrine 2: the Independence Doctrine; and looks good doing so in the process;
Integration

8g. Cellular Integration continues.
Integration Continues

8h. Cellular Integration continues.
Integration Continues

8l. Cellular Integration continues.
Integration Continues

8j. Cellular Integration continues.
Integration Continues

8k. Cellular Integration continues.
Integration Continues

8L. Cellular Integration continues.
Integration Continues

8m. Cellular Integration complete.
Completed Integration

9a1. Resolution equal to one dot per unit area.

9a2. Resolution equal to four dots per unit area.

9b1. Resolution equal to one roof per unit automotive-length.

9b2. Resolution equal to two roofs per unit automotive-length;
curved humps also attract attention more effectively than standard rectilinear shapes.

9c1. Resolution equal to one roof per unit automotive-length;
standard Limousine.

9c2. Resolution equal to six roofs per unit automotive-length; VB BEA Limousine;
curved humps also attract attention more effectively than standard rectilinear shapes.

9d1. Ceiling Height equal to h<9d1-h>.

9d2. A curved roof allows a higher ceiling-height because a high flat ceiling in an automotive-context feels ergonomically cavernous;
a high curved ceiling in an automotive-context feels ergonomically spacious.

9d3. A high flat ceiling in an automotive-context feels ergonomically cavernous.

9d4. A high curved ceiling in an automotive-context feels ergonomically spacious.

10. Evoked memory.

11a. Industry Standard flat sunroof; less transmitted light per unit sunroof length.

11b. Curved sunroof; more transmitted light per unit sunroof length;
because the curved quasi-prismatic lens offers more surface area, and because of the quasi-lens affect of the curved sunroof; also, the plural roofs mean plural sunroofs; and the plural sunroofs mean plural sunlight.

12. <12-a> acoustic-energy in a non-parabolic area is rejected (bandstop filter);
<12-b> acoustic-energy adjacent to a parabolic area is rejected (bandstop filter);
<12-c> acoustic-energy within a parabolic area and at the quasi-focus is enhanced (bandpass filter and amplifier);
<12-d> acoustic-energy within a parabolic area, but not at the quasi-focus is enhanced (bandpass filter and amplifier).

13a. Spatial volume:
A high flat ceiling in an automotive-context feels ergonomically cavernous and hollow.

13b. Spatial volume:
A high curved ceiling in an automotive-context feels ergonomically spacious.

14a. Privacy and Tranquility:
A Booth surrounds and secludes diners in privacy and tranquility;
<14a-p1>: person 1; <14a-p2 1>: person 2; <14a-t>: table; <14a-b>: booth;
A surroundingly-curved Beetlelike hump functions like a surroundingly-private booth.

14b. A table in a restaurant is unsecluded and unsurrounded;
instead ‘surrounded’ by other diners, or Isolated by open space;
<14b-p1>: person 1; <14b-p2 1>: person 2; <14b-t>: table.

14c. A serving counter in a restaurant unsecluded and unsurrounded;
instead, ‘surrounded’ by other diners or isolated by open space;
<14c-p1>: person 1; <14c-p2 1>: person 2; <14c-t>: table.

15a. Twelve parameters added together.

15b. Twelve parameters multiplied together (Four×Three).

15c. Twelve parameters added together equal twelve parameters multiplied together;
Multiplication is defined as repeated addition.

16a. Length is mathematically determinable (given some appropriate assumptions);
conventional (non-Noded) automobiles are infinitely variable (non-determinable);
<16a-f>: front-end projection; <16a-h>: hump length; <16a-s>: hump-to-hump spacing;
<16a-r>: rear-end projection; <16a-n1>: Node 1; <16a-n2>: Node 2; <16a-n3>: Node 3.

17a. Claimed 2-hump VB BEA Sports Utility Vehicle (SUV).

17aa. Claimed 2-hump VB BEA Sports Utility Vehicle (SUV).

17b. Claimed 2-hump VB BEA Sports Utility Vehicle (SUV).

17c. Claimed 2-hump VB BEA Sports Utility Vehicle (SUV).

17d. Claimed 2-hump (or 4-hump) VB BEA Sports Utility Vehicle (SUV).

17e. Claimed 2-hump VB BEA Sports Utility Vehicle (SUV).

17f. Claimed 2-hump VB BEA Sports Utility Vehicle (SUV).

17g. Claimed 2-hump VB BEA Sports Utility Vehicle (SUV).

17h. Claimed 2-hump VB BEA Sports Utility Vehicle (SUV).

17l. Claimed 2-hump VB BEA Sports Utility Vehicle (SUV).

17j. Claimed 2-hump VB BEA Sports Utility Vehicle (SUV).

17k. Claimed 2-hump (or 3-hump) VB BEA Sports Utility Vehicle (SUV).

17L. Claimed 2-hump (or 3-hump) VB BEA Sports Utility Vehicle (SUV):
VB BEA SUV as animal.

17m. Claimed 2-hump VB BEA Sports Utility Vehicle (SUV):
VB BEA SUV as kitten.

17n. Claimed 2-hump VB BEA Sports Utility Vehicle (SUV):
VB BEA SUV as luv-bug;
The center crease <17n-h> represents the center crease of a heart;
Other depictions show more voluptuously-shaped heart-halves (end-hump curves);
Of course, these could be used as well.

17n. Claimed 2-hump VB BEA Sports Utility Vehicle (SUV):
BEA as Brand-X SUV.

17p. Claimed 2-hump VB BEA Sports Utility Vehicle (SUV).

17q. Claimed tubelike VB BEA SUV rooftop humps;
Tubelike rooftop humps give the vehicle an affitude.

17r. Reserved for future use.

(17s) claimed Two-Hump Suv with humps that are formed such they are visible from the ends; (any number of humps; any type of vehicle).
Side-view, and Front-view, and Top-view humps claimed indirectly in all claims;
Side-view, and Front-view, and Top-view humps called out specifically in the main Markush-claim (claim 411), where all three Views are specified.
FIG. 17s1: Front view
FIG. 17s2: Side view

(17t) claimed Two-Hump Suv with humps that are formed such they are visible from the ends; (any number of humps; any type of vehicle).
Side-view, and Front-view, and Top-view humps claimed indirectly in all claims;
Side-view, and Front-view, and Top-view humps called out specifically in the main Markush-claim (claim 411), where all three Views are specified.
FIG. 17t1: Front view
FIG. 17t2: Side view

18a1. Arbitrary branded shape standard.

18a2. Cloned shape is Identical to standard.

18a3. Cloned shape is identical to standard except scaled to a smaller size.

18a4. Cloned shape is identical to standard except scaled to a larger size.

18a5. Cloned shape and standard are approximately similar.

18a6. Cloned shape is arbitrarily-shaped but bears a sufficiently slight resemblance, to evoke at least a faint emotive remembrance of the standard.

18b1. Arbitrary branded shape standard.

18b2. Any shape may be used; even square and other rectilinear shapes;
(Markush claim 411: Node Contour Alteration);
(Markush claim 418: Sideview Node Shape Modification).

18b3. Arbitrary branded shape standard.

18b4. Any scale (sizing) may be used
(Markush claim 411: Node Scaling Alteration);
(Markush claim 418: Sideview Node Sizing Modification).

18b5. Arbitrary branded shape standard.

18b6. Any spacing may be used
(Markush claim 411: Node Spacing Alteration);
(Markush claim 418: Sideview Node Spacing Modification).

18b7. Arbitrary branded shape standard.

18b8. Any partial-portion may be used
(Markush claim 411: Node Fragmentation Alteration).

18c1. <18c1-r>: Markush claim 411: Sideview Median Radii.
<1 8c1-ia>: Markush claim 411: Sideview Median Radii Included Angle.

18c2. Markush claim 411: Sideview Median Radii Scaling Coefficient;
(here 0.75 scaling coefficient).

18d1. <18d1-r>: Markush claim 411: Frontview Median Radii
<18d1-ia>: Markush claim 411: Frontview Median Radii Included Angle.

18d2. Markush claim 411: Frontview Median Radii Scaling Coefficient;
(here 0.75 scaling coefficient).

18e1. <18e1-r>: Markush claim 411: Topview Median Radii
<18e1-ia>: Markush claim 411: Topview Median Radii Included Angle.

18e2. Markush claim 411: Topview Median Radii Scaling Coefficient; (here 0.75 scaling coefficient).

18f1. <18f1-r>: Markush claim 411: Sideview Principle Radii.
<18f1-ia>: Markush claim 411: Sldeview Principle Radii Included Angle.

18f2. Markush claim 411: Sideview Principle Radii Scaling Coefficient;
(here 0.75 scaling coefficient).

18g1. <18g1-r>: Markush claim 411: Frontview Principle Radii.
<1 8g1-ia>: Markush claim 411: Frontview Principle Radii Included Angle.

18g2. Markush claim 411: Frontview Principle Radii Scaling Coefficient;
(here 0.75 scaling coefficient).

18h1. <18h1-r>: Markush claim 411: Topview Principle Radii
<18h1-ia>: Markush claim 411: Topview Principle Radii Included Angle.

18h2. Markush claim 411: Topview Principle Radii Scaling Coefficient;
(here 0.75 scaling coefficient).

18l1. <18i1-hh>: Markush claim 411: Sideview Hump to Hump Spacing.

18i2. <18i2-hh>: Markush claim 411: Frontview Hump to Hump Spacing.

18i3. <18i3-hh>: Markush claim 411: Topview Hump to Hump Spacing.

19a. Any shape may be used; herein shape is sometimes called ‘contour’.

19b. Any shape may be used; herein shape is sometimes called ‘contour’.

19c. Any shape may be used; herein shape is sometimes called ‘contour’.

19d. Any shape may be used; herein shape is sometimes called ‘contour’.

20a. Industry Standard singular-roof sedan.

20b. Claimed 2-hump sedan/SUV.

20c. Claimed 2-hump sedan/SUV.

20d. Claimed 2-hump sedan/SUV.

20e. Claimed 7-hump Limousine.

21a. Lighthearted and Fun Limousine.

21b. Lighthearted and Fun Limousine.

22a. Not claimed: Buggus singularitus.

22b. Not claimed: Audius singularitus.

22c. Not claimed: Coopernicus singularitus.

22d. Not claimed: Arbitraricus singularitus.

22e. Claimed: Arbitraricus infinitus.

23a. Linear Node-to-Node connection.

23b. Convexly-curved Node-to-Node connection.

23c. Concavely-curved Node-to-Node connection.

24a. Forming-tool for B. singularitus.

24b. B. singularitus.

24c. Forming-tool for B. singularitus potentially used as forming-tool for B. infinitus.

24d. B. infinitus.

25a. Beautiful equations are often true equations.

25b. The object-standard of an emulation.

25c. The emulation of an object-standard; features of the emulation, mirror the features of the standard; Marshall McLuhan rides again.

26a. The Classic Airstream trailer.

26b. Claimed Buggus infinitus configured as a mobile-home (towable or motorized).

27a. Not claimed: Coopernicus singularitus.

27b. Claimed Coopernicus infinitus.

27c. Claimed Coopernicus infinitus.

28a. In general, people do not get enough sunshine.

28b. Earth, Wind, Fire, Water, . . . . Chair.

28bb. The Chair as element; Chairium is listed on The Periodic Table right next to Oxygen.

28c. <28c-t>: Thoraxal portion: that portion against which the back (thorax) rests.
<28c-r>: Rumpal portion: that portion upon which the rump (rumpus) rests.

28da1. Convex Thoraxal shape: unstable equilibrium.
Most windshields, for example, are convex.

28da2. Concave Thoraxal shape: stable equilibrium;
called thoraxal curvature modification in Markush claim 418.

28da3. Flat Thoraxal shape: relatively stable equilibrium.
called thoraxal flatness modification in Markush claim 418.

28db1. Convex Rumpal shape: unstable equilibrium. Many trunks, for example, are convex.

28db2. Concave Rumpal shape: stable equilibrium;
called rumpal curvature modification in Markush claim 418.

28db3. Flat Rumpal shape: relatively stable equilibrium.
called rumpal flatness modification in Markush claim 418.

28e1. Thoraxal Surface: No Recline.
called thoraxal reclining angle modification in Markush claim 418.

28e2. Thoraxal Surface: Partial Recline.
called thoraxal reclining angle modification in Markush claim 418.

28e3. Thoraxal Surface: Full or almost Full Recline.
called thoraxal reclining angle modification in Markush claim 418.

28f1. Rumpal Surface: No Slope.
called rumpal slope modification in Markush claim 418.

28f2. Rumpal Surface: Slight Slope.
called rumpal slope modification in Markush claim 418.

28f3. Rumpal Surface: Radical Slope.
called rumpal slope modification in Markush claim 418.

28f4. Both Thoraxal Surface and Rumpal Surface: Full Recline and Radical Slope.
called thoraxal reclining angle modification in Markush claim 418, and rumpal slope modification in Markush claim 418.

28g. The Roof as Recliner;
Seat-Forming-Node Combination Embodiment 1.

28h1. Hatchback Half-Recline, rear surface;
Seat-Forming-Node Combination Embodiment 2, and Seat-Forming-Node Combination Embodiment 3.

28h2. Hatchback Half-Recline, front surface;
Seat-Forming-Node Combination Embodiment 2, and
Seat-Forming-Node Combination Embodiment 3.

28l. Seat-Forming-Node Combination Embodiment 4.

28j. Seat-Forming-Node Combination Embodiment 5.

28k. Seat-Forming-Node Combination Embodiment 10.

28L. Seat-Forming-Node Combination Embodiment 11.

28m. Seat-Forming-Node Combination Embodiment 6.

28n. Seat-Forming-Node Combination Embodiment 7

28o. Seat-Forming-Node Combination Embodiment 5.

28p. Seat-Forming-Node Combination Embodiment 11.

28q. Seat-Forming-Node Combination Embodiment 9.

28r. Seat-Forming-Node Combination Embodiment 8. 28s. Seat-Forming-Node Combination Embodiment 11.

28t. Seat-Forming-Node Combination Embodiment 2.

28u1. Called Sideview Node Shape Modification in Markush claim 418.

28u2. Called Sideview Node Sizing Modification in Markush claim 418

28u3. Called Sideview Node Spacing Modification in Markush claim 418;
<28u3-sp>: Spacing between Nodes.

29a1. Vertically stacked (z-axis) storage racks;
<29a1-rl>: rack 1;
<29a1-r2>: rack 2.

29a2. Vertically stacked (z-axis) storage racks;
<29a2-b1>: bicycle 1;
<29a2-b2>: bicycle 2.

29a3. Vertically stacked (z-axis) storage racks;
<29a3-r1>: rack 1;
<29a3-r2>: rack 2;
<29a3-bk>: bicycle.

29b. Laterally stacked (x-axis) storage racks;
the major-axis of each rack is aligned with the longitudinal axis (the y-axis);
<29b-n1>: node 1;
<29b-n2>: node 2;
<29b-rl>: rack 1;
<29b-r2>: rack 2;
<29b-r3>: rack 3.

29c1. Longitudinally stacked (y-axis) storage racks;
the major-axis of each rack is aligned with the lateral axis (the x-axis);
<29c1-n1>: node 1;
<29c1-n2>: node 2;
<29c1-r1>: rack 1;
<29c-r2: rack 2.

29c2. Both Laterally stacked and Longitudinally stacked;
the major-axis of each rack is aligned with the longitudinal axis (the y-axis);
<29c2-n1>: node 1;
<29c2-n2>: node 2;
<29c2-rl>: rack 1;
<29c2-r2>: rack 2;
<29c2-r3>: rack 3;
<29c2-r4>: rack 4.

29d. Longitudinal center-trench;
<29d-n1L>: node 1 Left;
<29d-n1r>: node 1 right;
<29d-n2L>: node 2 Left;
<29d-n2r>: node 2 right;
<29d-ct>: center-trench.

30. Branding Energy Amplification Doctrine: A Branding Energy Node must substantially satisfy each and every Branding Energy Element

31a. No Protuberance.

31b. Protuberance.

31c. Protuberance.

32a. Initial Independence:
Conception:
<32a-p>: Plumb point on an arbitrary Node Locus.

32b. Differentiation (Cell Division):
<32b-p1>: Plumb point 1 on an arbitrary Node Locus.
<32b-p2 1>: Plumb point 2 on an arbitrary Node Locus.
<32b-b>: Boundary point on an arbitrary Node Locus.
The boundaryboundary connector (here a point) is in noncoincidence with the plumbplumb connector.

32c. Differentiation continues:
<32c-p1>: Plumb point 1 on an arbitrary Node Locus.
   <32c-p2 1>: Plumb point 2 on an arbitrary Node Locus.
   <32c-b>: Boundary point on an arbitrary Node Locus.

32d. Differentiation continues:
<32d-p1>: Plumb point 1 on an arbitrary Node Locus.
   <32d-p2 1>: Plumb point 2 on an arbitrary Node Locus.
   <32d-b>: Boundary point on an arbitrary Node Locus.

32e. Completed Differentiation: <32e-p1>: Plumb point 1 on an arbitrary Node Locus. <32e-p2 1>: Plumb point 2 on an arbitrary Node Locus.

32f. Integration:
The boundaryboundary connector (here a line), is in noncoincidence with the plumbplumb connector.

32g. Integration continues:
<32g-p1>: Plumb point 1 on an arbitrary Node Locus.
   <32g-p2 1>: Plumb point 2 on an arbitrary Node Locus.
   <32g-b1>: Boundary point 1 on an arbitrary Node Locus.
   <32g-b2>: Boundary point 2 on an arbitrary Node Locus.
<32g-ppc>: PlumbPlumb Connector.
<32g-bbc>: BoundaryBoundary Connector.

32h. Integration continues:
<32h-p1>: Plumb point 1 on an arbitrary Node Locus.
   <32h-p2 1>: Plumb point 2 on an arbitrary Node Locus.
   <32h-b1>: Boundary point 1 on an arbitrary Node Locus.
   <32h-b2>: Boundary point 2 on an arbitrary Node Locus.
<32h-ppc>: PlumbPlumb Connector.
<32h-bbc>: BoundaryBoundary Connector.
<32h1 nL>: Node Locus 1.
<32h-2nL>: Node Locus 2.
<32h1 nLX>: Node Locus 1 Extension.
<32h-2nLX>: Node Locus 2 Extension.

32l. Integration continues.

32j. Integration continues.

32k. Integration continues.

32L. Integration continues.

32m. Completed Integration.

32n. Not claimed: Airstream Trailer.
<32n-a>: This point is both the first Node Plumb point and the first Node Boundary.
<32n-b>: This point is both the second Node Plumb point and the second Node Boundary.

Therefore the PlumbPlumb Connector and the Boundary Boundary Connector are in Coincidence; they are not in NonCoincidence.

32o. Claimed: Modified Airstream Trailer
The PlumbPlumb Connector and the Boundary Boundary Connector are in NonCoincidence.
<32o-p1>: The first Node Plumb point.
<32o-p2 1>: The second Node Plumb point.
<320-b1>: The first Node Boundary point.
<32o-b2>: The second Node Boundary point.
<32o-ppc>: The PlumbPlumb Connector.
<32o-bbc>: The BoundaryBoundary Connector.

32p1. Claimed: unequal Node radii, or unequal Node radii-center-point vertical-axis-location.

32p2. Claimed: unequal Node radii, or unequal Node radii-center-point vertical-axis-location.
Straight bar defines the Plumb points by the rigorous definition standard; see definition of Plumb (Topic 32: “Node Independence”).

32p3. Claimed: unequal Node radii, or unequal Node radii-center-point vertical-axis-location.
Straight bar defines the Plumb points by the rigorous definition standard; see definition of Plumb (Topic 32: “Node Independence”).

The rigorous definition standard straight-bar Plumb points (rigorous) are:
<32p3-a> and <32p3-b>.

The more frequently-encountered uppermost-point Plumb points (common) (<32p3-c> and <32p3-d>) are also shown for comparison.

32p4. Claimed: unequal Node radii, or unequal Node radii-center-point vertical-axis-location.
Straight-bar Standard (rigorous):
   the PlumbPlumb Connector and the BoundaryBoundary Connector are in NonCoincidence;
   in fact, these line segments never even intersect;
   therefore claimed.
Uppermost-point standard (common):
   the PlumbPlumb Connector and the BoundaryBoundary Connector are in NonCoincidence;
   they intersect at one and only one point: <32p4-b1>;
   therefore claimed.

33a. Plurality: 3 Nodes.

33b. Plurality: 4 Nodes.

33c. Plurality: 5 Nodes.

33d. Plurality: 6 Nodes.

33e. Plurality: 7 Nodes.

33f. Plurality: 8 Nodes.

33g. Plurality: 9 Nodes.

33h. Plurality: 10 Nodes.

34. Conveying Person A from place P1 to place P2.

35a. <35a-PaA>: Accommodating Person a in Node 1;
<35a-PbA>: Accommodating Person b in Node 2.

35b. Accommodating Person on Node 1 and on Node 2.

36a1. BEA vehicle with plural BEA Nodes Amplifies the brand comprised by itself.

36a2. BEA vehicle with plural BEA Nodes Amplifies an Archftecturally-Associated brand.

36b1. BEA vehicle with plural BEA Nodes and integrally-formed seating surface Amplifies the brand comprised by itself.

36b2. BEA vehicle with plural BEA Nodes and integrally-formed seating surface Amplifies an Architecturally-Associated brand.

36c1. BEA vehicle with Diural BEA Nodes . . . but only 1 passenger compartment and integrally-formed seating surface, Amplifies the brand comprised by Itself.
The formation of an exterior integrally-formed seating surface itself attracts attention;
   and therefore transforms this ordinary sedan into a BEA vehicle;
   the BEA Nodes satisfy all six BEA Elements;
   the rear-windshield of the passenger-compartment becomes the Thoraxal portion of the exterior integrally-formed seating surface; the passenger-compartment thus becomes the first on-type Node;
   the trunk-compartment becomes the Rumpal portion of the exterior integrally-formed seating surface; the trunk-compartment thus becomes the second on-type Node;
   The two Nodes together satisfy the Plurality criteria;
   therefore this ordinary sedan becomes a BEA vehicle.

36c2. BEA vehicle with plural BEA Nodes . . . but only 1 passenger compartment, Amplifies an Architecturally-Associated brand.
The formation of
   an exterior integrally-formed seating surface Itself attracts attention; and therefore transforms this ordinary sedan into a BEA vehicle;
   the BEA Nodes satisfy all six BEA Elements;
   the rear-windshield of the passenger-compartment becomes the Thoraxal portion of the exterior integrally-formed seating surface; the passenger-compartment thus becomes the first on-type Node;
   the trunk-compartment becomes the Rumpal portion of the exterior integrally-formed seating surface; the trunk-compartment thus becomes the second on-type Node;
   The two Nodes together satisfy the Plurality criteria; therefore this ordinary sedan becomes a BEA vehicle.

401. A method for the amplification of the energy of brand;
established upon a paradigm of the plurality of node;
pertaining to motorized and towable automotive vehicles;
the nodes substantially satisfying a totality of the branding energy amplification doctrine for branding energy nodes;
wherein:
an amplification of selected parameters, is generally attained by multiplication through repeated addition; and is specifically attained by a recursive process of recursive node formation;
the selected parameters including at least a parameter of the attraction of attention; and preferably including at least a parameter of the evocation of memory accomplished through a formation of architecturally associated nodes which architecturally mirror an architectural memory of an architecturally associated brand;
the method comprising the steps of:
enforming a first branding energy node; and
enforming at least a second branding energy node;
at least the second node functioning to at least attract attention;
multiplied nodes
multiplied visibility
multiplied recognizability
multiplied remembrance
multiplied brand;
multiplied sales
multiplied brand;
multiplied profits multiplied brand.

402. A branding energy amplifier for the amplification of the energy of brand;
established upon a paradigm of the plurality of node;
pertaining to motorized and towable automotive vehicles;
the nodes substantially satisfying a totality of the branding energy amplification doctrine for branding energy nodes;
wherein:
an amplification of selected parameters,
is generally attained by multiplication through repeated addition; and
is specifically attained by a recursive process of recursive node formation;
the selected parameters including at least a parameter of the attraction of attention; and preferably including at least a parameter of the evocation of memory accomplished through a formation of architecturally associated nodes which architecturally mirror an architectural memory of an architecturally associated brand;
the amplifier comprising:
a first beetlelike curve
obtained biologically by an automotive biological cellular division of the basic concept of beetlelike curvature as uniquely expressed in the Volkswagen beetle;
the first beetlelike curve substantially forming a first beetlelike curved rooftop hump; and
a second beetlelike curve
obtained biologically by an automotive biological cellular division of the basic concept of beetlelike curvature as uniquely expressed in the Volkswagen beetle;
the second beetlelike curve substantially forming a second beetlelike curved rooftop hump;
at least the second rooftop hump functioning to at least attract attention;
whereby,
the very singular Volkswagen beetle engenders and gives birth to plurally curved automotive offspring;
which offspring implicitly retain at least permutations of basic beetle dna;
and which offspring faithfully mirror and courageously echo the bold rolled rounded rotundity of the Volkswagen beetle; that globular globalar spirit which is the very essence of beetleness;
multiplied nodes
multiplied visibility
multiplied recognizability
multiplied remembrance
multiplied brand;
multiplied sales
multiplied brand;
multiplied profits
multiplied brand.

403. A method for the amplification of the energy of brand;
established upon a paradigm of the plurality of node;
pertaining to motorized and towable automotive vehicles;
the nodes substantially satisfying a totality of the branding energy amplification doctrine for branding energy nodes;
wherein,
a selective amplification of selected parameters is generally attained by multiplication through repeated addition; and is specifically attained by a recursive process of recursive node formation;
the selected parameters including at least a parameter of the attraction of attention; and a parameter of the transmission of solar energy;
the method comprising the steps of:
enforming a first on type seatforming branding energy node; the exterior surface of the node implicitly forming a thoraxal support surface; the node forming a portion of the exterior surface of the automobile;
enforming at least a second on type seatforming branding energy node; the exterior surface of the node implicitly forming a rumpal support surface; the node forming a portion of the exterior surface of the automobile;
both the first node thoraxal surface and the second node rumpal surface implicitly and synergistically forming together at least one exterior resting surface for resting and for seating upon the exterior surface of the automotive vehicle;
the resting surface specifically designed and specifically engineered and specifically manufactured to be specifically a resting specific surface specifically for human beings specifically;
the resting surface preferably for resting use when the automotive vehicle itself is at rest;
whereby
the integrally formed and synergistic automotive vehicle exterior surface and exterior resting surface combination implicitly attracts attention; and therefore implicitly amplifies the energy of brand;
and whereby,
the nodes simultaneously and synergistically and integrally and implicitly form both the exterior surface of the vehicle; and
the exterior, outdoor, open air, resting surface for human beings;
providing for them a convenient place to soak up sunshine;
thereby directly impacting sunshine related metabolic functions such as the metabolism of vitamin d; and
the metabolism of serotonin; and
the metabolism of melatonin;
and whereby,
the resting surface provides a comfortable and convenient place for viewing outdoor events like baligames, and parades, and fourth of july fireworks; and for soaking up the sun, and the sand, and the surf; and for enjoying sunrises, and sunsets, and nighttime skies filled with twinkling starlight from stars which twinkle;
multiplied nodes
multiplied visibility
multiplied recognizability
multiplied remembrance
multiplied brand;
multiplied sales
multiplied brand;
multiplied profits
multiplied brand.

404. A limousine having a plurality of rooftop nodes which form at least a portion of the rooftop;
the rooftop nodes at least functioning for attracting attention; and for creating a brand which is comprised by a principle of node plurality.

405. A sports utility vehicle having at least two rooftop nodes which form at least a portion of the rooftop;
the rooftop nodes at least functioning for attracting attention; and for creating a brand which is comprised by a principle of node plurality.

406. An automobile having
at least one integrally formed exterior resting surface providing a surface of resting for at least one human being;
the resting surface specifically designed and specifically engineered and specifically manufactured to be specifically a resting specific surface specifically for human beings specifically;
the resting surface preferably for resting use when the automobile itself is at rest;
the resting surface integrally enformed by and integrally enformed upon an exterior surface of at least one node; the node forming a portion of the exterior surface of the automobile;
the resting surface at least functioning for attracting attention; and for creating a brand which is comprised by a principle of node plurality;
and for providing a surface of rest; and for creating a brand which is comprised by a principle of integrally formed exteriorly formed resting surface for human beings.

407. The method of claim number 401 further modified to create, in affect, a rolling automotive billboard for attracting attention; and for amplifying the energy of brand;
the method further comprising the steps of:
enmultiplying the number of nodes; and thereby
encreasing the net number of nodes per unit automotive length; and thereby
enhancing the node resolution;
the node resolution measured in nodes per unit automotive length;
much like a television set; and a times square lay board; both of which are rated in dots per unit length; that is, in nodes per unit length;
so as to effectively create, in affect, the rolling automotive billboard; and
enlarging the physical sizing of each node; so as to effectively create, in affect, the rolling automotive billboard; and thereby
enhancing the visibility of the rolling automotive billboard; and thereby
entensifying the visual impact of the rolling automotive billboard; and thereby
entensifying the emotive and cognitive impact of the rolling automotive billboard on the human brain; very much like the dazzling display boards at times square; which are rated both in nodes per unit length; and in overall physical size;
whereby,
the plurally noded rolling automotive billboard implicitly and continuously functions as an amplifier of the energy of brand;
and whereby,
the amplifier of the energy of brand implicitly and continuously functions as the rolling automotive billboard.

408. The method of claim number 401 further comprising the step of:
expressing within at least one of the nodes, an architectural shape which is architecturally associated architecturally with a branded shape of a shaped brand;
the architectural shape sufficiently architecturally similar, so as to architecturally mirror the shaped architectural resemblance of the branded shape of the shaped brand; and to echo a memory, however slight, of the branded shape comprising the shaped brand; and to evoke a memory, however slight, of the shaped brand which is comprised by the branded shape; and
enmirroring architecturally the shaped architectural resemblance of the branded shape; and
echoing the memory of the branded shape; however slight that memory may be; and
evoking the memory of the shaped brand; however slight that memory may be; and
enhancing the visibility of the automotive vehicle; by enpluralizing the total number of nodes enformed; and
encreasing the recognizability of the automotive vehicle; by appropriately enscaling the physical sizing of the nodes enformed; and
encatalyzing via the architecturally enmirrored shaped architectural resemblance; and via the echoed memory of the branded shape; and via the evoked memory of the shaped brand; and via the enhanced visibility; and via the encreased recognizability; the amplification of the sales of any of the species of the genus of the shaped brand, including the very vehicle itself; and
enchanneling the amplified profits, from the encatalyzed sales, to any company owning, however indirectly, any of the branding rights, to any of the species of the genus of the shaped brand, including the very vehicle itself.

409. The method of claim number 401
wherein: each node is implicitly acoustically modified to implicitly function acoustically to acoustically intensify the auditory acoustical enjoyment of the occupants of the vehicle;
the method further comprising the steps of:
enforming the branding energy nodes as at least first and second substantially curved rooftop nodes;
each node substantially curved to substantially function as an interior reflecting quasiparabolic acoustic lens;
each lens implicitly having
an exterior nonadjacent area; and
an exterior adjacent area; and
an interior quasifocalpoint; and
an interior inside area exclusive of the quasifocalpoint;
and each lens substantially
attenuating and substantially nullifying and substantially rejecting undesirable acoustic energy originating from the exterior nonadjacent area; and the exterior adjacent area; thereby functioning much like a bandstop filter; and each lens substantially
accentuating and substantially amplifying and substantially accepting desirable acoustic energy originating from the interior quasifocalpoint; and from the interior inside area exclusive of the quasifocalpoint; thereby functioning much like a bandpass filter and amplifier; and
entuning each node, as desired, to attain a predetermined acoustic parameter; and a predetermined frequency response; and
attaining implicitly an acoustic quality accumulation rating of c; per unit node; where c is shorthand for curved; and
observing a lower acoustic quality accumulation rating of f; per unit node; for the industry standard substantially flat topped roof; where f is shorthand for flat; and
surpassing the acoustic quality accumulation rating of the acoustically inferior flat roof, by a quantity c minus f; per unit node; and
accumulating a whole vehicle acoustic quality accumulation rating of the quantity c minus f, multiplied by the number of nodes n; and therefore
multiplying acoustic quality; and thereby substantially
isolating the occupants of the vehicle from undesirable noise; and thereby substantially
enveloping the occupants of the vehicle with pleasurable acoustic energy; much like that in a symphonic space for music; and in a bandshell; and thereby substantially
intensifying the auditory enjoyment experienced by the occupants of the vehicle.

410. The method of claim number 401
wherein
each node is implicitly photometrically modified to implicitly function photometrically to photometrically intensify the illuminational enjoyment of the occupants of the vehicle;
the method further comprising the steps of:
enforming the branding energy nodes as at least first and second substantially curved light transmitting sunroof lenses; and
transmitting light energy to the interior of the vehicle through each lens; and
gathering increased light energy for increased light transmission by virtue of the increased surface area of each substantially curved sunroof lens; relative to the industry standard substantially flat sunroof; and
gathering increased light energy for increased light transmission; by virtue of the prismlike lens affect of each substantially curved sunroof lens; relative to the industry standard substantially flat sunroof; and
attaining implicitly a light transmission quality accumulation rating of c; per unit node; where c is shorthand for curved; and
observing a lower light transmission quality accumulation rating of f; per unit node; for the industry standard substantially flat topped sunroof; where f is shorthand for flat; and
surpassing the light transmission quality accumulation rating of the transmissively inferior flat sunroof, by a quantity c minus f; per unit node; and
accumulating a whole vehicle light transmission quality accumulation rating of the quantity c minus f, multiplied by the number of nodes n; and therefore
multiplying transmitted light energy; and thereby substantially
enveloping the occupants of the vehicle with pleasurable energy from the sun; and thereby substantially intensifying the enjoyment of the human occupants of the vehicle;
human beings are, in many ways, solar powered;
human beings depend on sunlight for such vital processes as the metabolism of vitamin d; and the metabolism of serotonin; and the metabolism of melatonin;
the enjoyment of human beings therefore is directly linked to sunlight exposure;
sunlight exposure is multiplicatively intensified by multiplied sunroofs.

411. The branding energy amplifier of claim number 402 further comprising:
a modification of at least one of the at least two beetlelike curves,
the modification involving at least one hump shape paradigm alteration; and
the modification involving at least one hump shape parameter alteration;
the hump shape paradigm alteration selected from the group consisting of
node contour alterations and
node scaling alterations and
node spacing alterations and
node fragmentation alterations; and
the hump shape parameter alteration selected from the group consisting of
sideview median radii alterations and
sideview principle radii alterations and
sideview median radii included angle alterations and
sideview principle radii included angle alterations and
sideview median radii scaling coefficient alterations and
sideview principle radii scaling coefficient alterations and
sideview hump to hump spacing alterations and
frontview median radii alterations and
frontview principle radii alterations and
frontview median radii included angle alterations and
frontview principle radii included angle alterations and
frontview median radii scaling coefficient alterations and
frontview principle radii scaling coefficient alterations and
frontview hump to hump spacing alterations and
topview median radii alterations and
topview principle radii alterations and
topview median radii included angle alterations and
topview principle radii included angle alterations and
topview median radii scaling coefficient alterations and
topview principle radii scaling coefficient alterations and
topview hump to hump spacing alterations;
the alterations performed in order to accomplish a predetermined purpose;
potentially for example, to achieve a sizing increase accommodation by performing a node scaling alteration;
the alterations performed in a very skillful manner in order to substantially preserve the same look and feel and reminiscence of the Volkswagen beetle;
that same look and that same feel and and that same reminiscence which is a very important and beautiful characteristic; and which is implicitly present within the curvature of the Volkswagen beetle in its unaltered state;
the alterations also performed in a very skillful manner in order to faithfully mirror and courageously echo the bold rolled rounded rotundity of the Volkswagen beetle;
that globalar spirit;
that globular spirit;
that very same spirit which is the very essence of beetle beetleness.

412. The branding energy amplifier of claim number 402 further comprising:
a quantity, and
an enformation, and
an arrangement, and
an architectural sizing, of the curved beetlelike humps,
which is substantially sufficient to substantially enform substantially a limousine.

413. The branding energy amplifier of claim number 402 further comprising:
a quantity, and
an enformation, and
an arrangement, and
an architectural sizing, of the beetlelike curved rooftop humps,
which is substantially sufficient to substantially enform substantially a sports utility vehicle.

414. The sports utility vehicle of claim number 413 further comprising:
a sufficient enformation, and
a sufficient arrangement, and
a sufficient amplification of the architectural sizing, of the beetlelike curved rooftop humps, which is substantially sufficient to substantially engender substantially a
jacked up,
testosterone laced,
steroid saturated,
sinew snapping,
curvaturistically globular,
wide framed,
big and bad and ahnery and
almost animalistic
sports utility vehicle;
a bugabug on steroids;
for providing exceptional lateral stability;
and for providing physically amplified interior headroom space;
and for providing amplified energy of brand amplification; by amplifying attraction of attention; by the enformation of the curved beetlelike humps; and by the arrangement of the curved beetlelike humps; and by the amplification of the architectural sizing of the curved beetlelike humps.

415. The sports utility vehicle of claim number 413 further comprising:
a sufficient enformation, and
a sufficient arrangement, and
a sufficient attenuation of the architectural sizing, of the beetlelike curved rooftop humps, which is substantially sufficient to substantially engender substantially a petite, and delicate, and diminutive sports utility vehicle; a kind of kinder, gentler suv;
for navigating narrower roadways;
and for attaining increased fuel efficiency;
while still offering both the headroom increases implicitly provided by curved rooftop vehicles; and the branding energy amplification implicitly provided by plural rooftop vehicles.

416. The branding energy amplifier of claim number 402 further comprising:
a sufficient enformation, and
a sufficient arrangement, and
a sufficient highly amplified amplification of the architectural sizing, of the beetlelike curved rooftop humps, which is substantially sufficient to substantially engender substantially a beetlelike motorized mobile home;
for providing highly amplified interior headroom space;
and for providing highly amplified sunlight flux potential;
and for providing highly amplified visibility; and highly amplified recognizability;
and for providing highly amplified branding energy amplification; due to highly amplified attraction of attention; due to both highly amplified visibility; and highly amplified recognizability; due to the highly amplified amplification of the architectural sizing; and
a formation of the highly amplified beetlelike curved rooftop humps, which is substantially sufficient, to substantially provide a substantially sufficient reminiscence of the globular globalar spirit which is the very essence of Volkswagen beetle beetleness;
in order to evoke the memory of, and to catalyze the sale of, both the Volkswagen beetle; and the beetlelike motorized mobile home itself.

417. The branding energy amplifier of claim number 402 further comprising:
a sufficient enformation, and
a sufficient arrangement, and
a sufficient highly amplified amplification of the architectural sizing, of the beetlelike curved rooftop humps, which is substantially sufficient to substantially engender substantially a beetlelike towable mobile home;
for providing highly amplified interior headroom space;
and for providing highly amplified sunlight flux potential;
and for providing highly amplified visibility; and highly amplified recognizability; and for providing highly amplified branding energy amplification; due to highly amplified attraction of attention; due to both highly amplified visibility; and highly amplified recognizability; due to the highly amplified amplification of the architectural sizing; and
a formation of the highly amplified beetlelike curved rooftop humps, which is substantially sufficient, to substantially provide a substantially sufficient reminiscence of the globular globalar spirit which is the very essence of Volkswagen beetle beetleness;
in order to evoke the memory of, and to catalyze the sale of, both the Volkswagen beetle; and the beetlelike towable mobile home itself.

418. The method of claim number 403 further comprising the steps of:
enforming the on type seatforming branding energy nodes as beetlelike curved camellike, substantially adjacent, rooftop humps; and
enforming the beetlelike curved camellike substantially adjacent rooftop humps as the exterior resting surface for resting and for seating; the exterior resting surface positioned upon the rooftop; in very camel like fashion, between the substantially adjacent rooftop humps; and
enmodifying at least one resting surface parameter, in such a way as desired, to provide a comfortable resting surface; for potentially accommodating comfortably at least one resting human being; the resting surface parameter enmodification selected from the group consisting of:
sideview node shape modifications and
sideview node sizing modifications and
sideview node spacing modifications and
thoraxal curvature modifications and
thoraxal flatness modifications and
rumpal curvature modifications and
rumpal flatness modifications and
thoraxal reclining angle modifications and
rumpal slope modifications;
whereby the camellike curved beetlelike humps synergistically function together to integrally and implicitly provide a comfortable resting surface; for seating and for lounging and for resting;
and whereby the camellike curved beetlelike humps synergistically function together to integrally and implicitly provide a raised outdoor platform surface for viewing outdoor events such as ballgames, and parades, and fourth of july fireworks; and for soaking up the sun, and the sand, and the surf; and for enjoying twinkling starlight from stars which twinkle;
and whereby the beetlelike curved camellike humps synergistically function together to implicitly attract attention, and to implicitly amplify the energy of brand;
and whereby the beetlelike curved camellike humps synergistically function together to implicitly attract attention, and to implicitly amplify the energy of the brand comprised by buggus singularitus and buggus infinitus.

419. The method of claim number 403 further comprising the steps of:
enforming the thoraxal support surface, enformed by the first on type seatforming branding energy node, as a thoraxally supporting, Volkswagen beetle, hatchback node surface; and
enforming the rumpal support surface, enformed by the second on type seatforming branding energy node, as a rumpally supporting, Volkswagen beetle, combination node surface; comprising both a hatchback node extension surface, and a bumper node surface;
the thoraxal surface and the rumpal surface implicitly and synergistically forming together at least the exterior resting surface for resting and for seating upon the exterior surface of the vehicle; and upon both the hatchback node surface, and the combination node surface; and
enmodifying at least one resting surface parameter, in such a way as desired, to provide a comfortable resting surface; for potentially accommodating comfortably at least one resting human being; the resting surface parameter enmodification selected from the group consisting of:
sideview node shape modifications and
sideview node sizing modifications and
sideview node spacing modifications and
thoraxal curvature modifications and
thoraxal flatness modifications and
rumpal curvature modifications and
rumpal flatness modifications and
thoraxal reclining angle modifications and
rumpal slope modifications;
whereby both the Volkswagen beetle hatchback node surface, and the Volkswagen beetle combination node surface, synergistically function together to integrally and implicitly and comfortably provide the exterior resting surface for resting and for seating;
and whereby the Volkswagen beetle node surfaces synergistically function together to integrally and implicitly provide a raised outdoor platform surface for viewing outdoor events such as baligames, and parades, and fourth of july fireworks; and for soaking up the sun, and the sand, and the surf; and for enjoying twinkling starlight from stars which twinkle;
and whereby the Volkswagen beetle node surfaces synergistically function together to implicitly attract attention, and to implicitly amplify the energy of brand;
and whereby the Volkswagen beetle node surfaces synergistically function together to implicitly attract attention, and to implicitly amplify the energy of the brand comprised by buggus singularitus and buggus infinitus.

420. The method of claim number 403 further comprising the steps of:
enforming the thoraxal support surface, enformed by the first on type seatforming branding energy node, as a thoraxally supporting Volkswagen beetle hatchback node surface; and
enforming the rumpal support surface, enformed by the second on type seatforming branding energy node, as a rumpally supporting Volkswagen beetle bumper node surface;
the thoraxal surface and the rumpal surface implicitly and synergistically forming together at least the exterior resting surface for resting and for seating upon the exterior surface of the vehicle; and upon both the hatchback node surface, and the bumper node surface enmodifying at least one resting surface parameter in such a way as desired to provide a comfortable resting surface; for potentially accommodating comfortably at least one resting human being; the resting surface parameter enmodification selected from the group consisting of:
sideview node shape modifications and
sideview node sizing modifications and
sideview node spacing modifications and
thoraxal curvature modifications and
thoraxal flatness modifications and
rumpal curvature modifications and
rumpal flatness modifications and
thoraxal reclining angle modifications and
rumpal slope modifications;
whereby both the Volkswagen beetle hatchback node surface, and the Volkswagen beetle bumper node surface synergistically function together to integrally and implicitly and comfortably provide the exterior resting surface for resting and for seating;
and whereby the Volkswagen beetle node surfaces synergistically function together to integrally and implicitly provide a raised outdoor platform surface for viewing outdoor events such as ballgames, and parades, and fourth of july fireworks; and for soaking up the sun, and the sand, and the surf; and for enjoying twinkling starlight from stars which twinkle;
and whereby the Volkswagen beetle node surfaces synergistically function together to implicitly attract attention, and to implicitly amplify the energy of brand;
and whereby the Volkswagen beetle node surfaces synergistically function together to implicitly attract attention, and to implicitly amplify the energy of the brand comprised by buggus singularitus and buggus infinitus.

421. The sports utility vehicle of claim number 413 further comprising:
a substantially tubular configuration of the beetlelike curved rooftop humps; for providing substantially more interior headroom relative to a nontubelike hump; which nontubelike hump would otherwise taper downward along an axis which is defined by a reference axis of the tubelike hump; and would otherwise therefore nullify a portion of the interior headroom;
the tubular configuration useful for empowering already empowered sports utility vehicles with even more power; the power of attitude;
the tubular configuration also potentially useful for maximizing the interior volume of luxury limousines.

422. The method of claim number 408 the method further comprising the step of:
enforming within at least one of the nodes, preferably within a node which forms a portion of the rooftop, a shape which is substantially approximately similar to, but not necessarily precisely equal to, the shape of the Volkswagen beetle of any generation; and preferably, the most current generation.

423. The method of claim number 408 the method further comprising the step of:
enforming within at least one of the nodes, preferably within a node which forms a portion of the rooftop, a shape which is substantially approximately similar to, but not necessarily precisely equal to, the shape of the audi tt of any generation; and preferably, the most current generation.

424. The method of claim number 408 the method further comprising the step of:
enforming within at least one of the nodes, preferably within a node which forms a portion of the rooftop, a shape which is substantially approximately similar to, but not necessarily precisely equal to, the shape of the cooper mini of any generation; and preferably, the most current generation.

425. The method of claim number 408 the method further comprising the step of:
enforming within at least one of the nodes, preferably within a node which forms a portion of the rooftop, a shape which is substantially approximately similar to, but not necessarily precisely equal to, a shape of any plurally noded vehicle.

426. The limousine of claim number 404
wherein:
at least one of the rooftop nodes, is substantially curved; and is substantially enformed in a shape which is substantially approximately similar to, but not necessarily precisely equal to, the shape of the Volkswagen beetle of any generation; and preferably, the most current generation.

427. The limousine of claim number 404
wherein:
at least one of the rooftop nodes, is substantially enformed in a shape which is substantially approximately similar to, but not necessarily precisely equal to, the shape of the audi tt of any generation; and preferably, the most current generation.

428. The limousine of claim number 404
wherein:
at least one of the rooftop nodes, is substantially enformed in a shape which is substantially approximately similar to, but not necessarily precisely equal to, the shape of the cooper mini of any generation; and preferably, the most current generation.

429. The sports utility vehicle of claim number 405
wherein:
at least one of the rooftop nodes, is substantially curved; and is substantially enformed in a shape which is substantially approximately similar to, but not necessarily precisely equal to, the shape of the Volkswagen beetle of any generation; and preferably, the most current generation.

430. The sports utility vehicle of claim number 405
wherein:
at least one of the rooftop nodes, is substantially enformed in a shape which is substantially approximately similar to, but not necessarily precisely equal to, the shape of the audi tt of any generation; and preferably, the most current generation.

431. The sports utility vehicle of claim number 405 wherein:
at least one of the rooftop nodes, is substantially enformed in a shape which is substantially approximately similar to, but not necessarily precisely equal to, the shape of the cooper mini of any generation; and preferably, the most current generation.
